(19) United States
(12) Patent Application Publication
(10) Pub. No.: US 2022/0023829 A1
(43) Pub. Date: Jan. 27, 2022

(54) AMORPHOUS METAL ORGANIC FRAMEWORKS AND METHODS OF PREPARING THE SAME

(71) Applicants: Framergy, Inc., Wilmington, DE (US); Absorption Solutions LLC, La Porte, TX (US)

(72) Inventors: Osman K. Ozdemir, Cypress, TX (US); Jason Ornstein, London (GB); Anne Boehme, Tomball, TX (US); Jack Veal, Morgan, TX (US); Jeff St. Amant, Stonewall, LA (US); Carlos Ybanez, Roma, TX (US)

(21) Appl. No.: 17/299,529

(22) PCT Filed: Dec. 3, 2019
(86) PCT No.: PCT/US2019/064273

§ 371 Date: Jun. 3, 2021

Related U.S. Application Data
(60) Provisional application No. 62/774,404, filed on Dec. 3, 2018.

(51) Int. Cl. B01J 20/22; B01J 20/28; B01J 20/32; B01J 20/30; B01J 20/20; B01J 20/10; B01D 53/02

(52) U.S. Cl. CPC B01J 20/226; B01D 2257/102; B01J 20/28061; B01J 20/28064; B01J 20/28066; B01J 20/2808; B01J 20/28083; B01J 20/3204; B01J 20/3078; B01J 20/20; B01J 20/103; B01J 20/3265; B01D 53/02; B01J 2220/46; B01D 2253/204; B01D 2253/308; B01D 2253/306; B01J 20/28059

(57) ABSTRACT

The present disclosure relates to amorphous metal organic frameworks with high and/or selective molecular uptake, absorbent materials comprising the same, methods for preparing the same and the use of the same for uptaking/absorbing fluids.

### TECHNICAL FIELD

The present disclosure relates to amorphous metal organic frameworks with high and/or selective molecular uptake, and to methods of preparing the same.

### BACKGROUND

Metal organic frameworks are a relatively new class of materials in the area of nanomaterials, which demonstrate promise with absorption of various chemical compounds. One significant issue with the commercialization of these materials is the cost of manufacturing the crystal structures, as well as the difficulties in providing the metal organic frameworks in granular or pellet forms for application use.

### DESCRIPTION

In one aspect, the disclosure provides an amorphous iron or aluminium metal organic framework.

In one aspect, the disclosure provides an absorbent material comprising a porous substrate impregnated with a metal organic framework, wherein the metal organic framework is amorphous.

In one aspect, the disclosure provides a process of preparing an amorphous metal organic framework comprising the steps of contacting a reaction mixture solution comprising a metal source, a ligand precursor and a solvent with a porous substrate; and subsequently removing a liquid component from the substrate.

In one aspect, the disclosure provides an amorphous metal organic framework obtainable by a process of the disclosure.

In one aspect, the disclosure provides an amorphous metal organic framework 35 produced by a process disclosed herein.

In one aspect, the disclosure provides a process of preparing an absorbent material comprising a substrate and an amorphous metal organic framework comprising the steps of contacting a reaction mixture solution comprising a metal source, a ligand precursor and a solvent with a porous substrate; and subsequently removing a liquid component from the substrate.

In one aspect, the disclosure provides an absorbent material obtainable by a process of the disclosure.

In one aspect, the disclosure provides an absorbent material produced by a process of the disclosure.

In one aspect, the disclosure provides the use of an amorphous metal organic framework as defined herein for uptaking/absorbing a gas or liquid.

In one aspect, the disclosure provides a method of absorbing a fluid from a stream of fluids, the method comprising: (i) providing an amorphous metal organic framework or absorbent material as described herein; and (ii) contacting the amorphous metal organic framework or absorbent material with a stream of fluid(s) to selectively remove a fluid component from the stream of fluid(s).

The present disclosure provides metal organic frameworks in amorphous form. The provision of amorphous metal organic frameworks of the kind described herein has not previously been described due to the difficulty in obtaining metal organic frameworks in amorphous form. In particular, metal organic frameworks tend to crystalize readily and do not easily form amorphous materials. This is particularly so with the types of metal organic frameworks described herein.

Amorphous metal organic frameworks comprise a network of inorganic nodes (metal clusters/metal nodes) linked by organic ligands. Importantly, there is no long range order within the structure. This results in the absence of Bragg peaks in their X-Ray or neutron diffraction patterns. This differentiates amorphous metal organic frameworks from their crystalline counterparts. Amorphous metal organic frameworks do retain the basic building blocks and connectivity of their crystalline counterparts but due to the aperiodic arrangement of atoms, their X-Ray diffraction patterns show no Bragg peaks and more commonly show broad humps caused by diffuse scattering.

In addition, amorphous metal organic frameworks differ from their crystalline counterparts in that their properties do not vary depending on the type or size of the crystal structure. Therefore, amorphous metal organic frameworks are more resistant to the transport conditions used in industry. For example, a crystalline sample needs to be transported carefully (which increases costs) because incidental damage to the crystal will affect the properties of the sample and could lead to reduced effectiveness. In contrast, amorphous metal organic frameworks do not exhibit reduced effectiveness resulting from simple mechanical damage.

For the first time, the present disclosure provides an iron and aluminium metal organic framework that is amorphous. These amorphous metal organic frameworks exhibit surprisingly high absorption characteristics.

For the first time, the present disclosure provides an absorbent material comprising a porous substrate impregnated with amorphous metal organic framework. These absorbent materials exhibit surprisingly high absorption characteristics and BET surface area.

For the first time, the disclosure also provides a process producing an amorphous metal organic framework or an absorbent material comprising a porous substrate and an amorphous metal organic framework. This is surprising because of the strong driving forces during synthesis of metal organic frameworks that bias synthesis to form crystalline materials.

In particular, the interplay of thermodynamic and kinetic driving forces for metal organic frameworks leads to the production of crystalline materials in known bottom up synthesis processes. It has been shown that monocrystalline metal organic frameworks derived from these processes exhibit useful gas uptake and selective absorption characteristics. For the first time, the process of the present disclosure provides a process for producing amorphous metal organic frameworks by confining the metal coordination in the pores of a substrate. The impregnation of porous substrates with the reaction mixture has surprisingly resulted in amorphous metal organic frameworks.

In some embodiments it may be desirable to provide materials that have both crystalline or polycrystalline and amorphous metal organic frameworks. In these embodiments, it may be possible to define the proportion of the metal organic framework that is amorphous. For example, a metal organic framework may be said to be 75%, 85%, 95%, 99% or 100% amorphous. When a metal organic framework is 100% amorphous, there is no crystalline metal organic framework present in the metal organic framework. When a metal organic framework is 75% amorphous, the remaining 25% of metal organic framework may be considered polycrystalline or monocrystalline. Tailoring the amount of amorphous metal organic framework in a metal organic framework allows for the properties of the material to be altered.

Amorphous Metal Organic Frameworks

In one aspect, the present disclosure provides an iron metal organic framework that is amorphous. These amorphous metal organic frameworks exhibit surprisingly high gas/liquid uptake.

In one aspect, the present disclosure provides an aluminium metal organic framework that is amorphous. These amorphous metal organic frameworks exhibit surprisingly high gas/liquid uptake.

In one aspect, the present disclosure provides a chromium metal organic framework that is amorphous. These amorphous metal organic frameworks exhibit surprisingly high gas/liquid uptake.

Iron and aluminium metal organic frameworks are of particular interest because of the natural abundance of aluminium and iron in the Earth. As such, precursors for synthesising amorphous metal organic frameworks comprising aluminium and iron are also easy to procure. Not only are aluminium and iron abundant, they are also capable of forming strong bonds with many fluid molecules. The interaction of the aluminium and iron in the claimed amorphous metal organic frameworks with fluid molecules allows for stable complex formation and as such allows for the selective absorption of components in fluid streams. Furthermore, iron and aluminium are able capable of acting as catalyst centres within the amorphous metal organic framework. This additional capability is of significant importance in many industrial applications.

The present disclosure provides an iron or aluminium metal organic framework that is amorphous.

In one embodiment, the disclosure provides an amorphous metal organic framework comprising (i) a metal cluster; and (ii) one or more ligands having two or more carboxylate groups; wherein the metal cluster comprises a metal selected from iron or aluminium.

In one embodiment, is provided an amorphous metal organic framework comprising (i) so a metal node; and (ii) one or more ligands having two or more carboxylate groups; wherein the metal node comprises a metal selected from iron or aluminium.

In one embodiment, the metal cluster/metal node comprises the formula Fe₂XO, wherein X is a metal selected from Group 2 through Group 16, for example a transition metal. For example, X is selected from Al, Fe, Co, Mn, Zn, Ni, Mg, Cu, and Ca. For example, the metal cluster/metal node has the formula Fe₃O. For example, the metal cluster/metal node has the formula Fe₂CoO.

In one embodiment, the metal cluster/metal node comprises the formula Al₂XO, wherein X is a metal selected from Group 2 through Group 16, for example a transition metal. For example, X is selected from Al, Fe, Co, Mn, Zn, Ni, Mg, Cu, and Ca. For example, the metal cluster/metal node has the formula Al₃O.

In one embodiment, the chromium metal organic framework has a molar ratio of metal ions to organic linker of from about 1:0.30 to about 1:0.55, or from about 1:0.33 to about 1:0.5.

The one or more ligands may be selected from any of the ligands described herein. In one embodiment, the one or more ligands have two or more carboxylate groups. In one embodiment, the one or more ligands have three or more carboxylate groups. In one embodiment, the one or more ligands have four or more carboxylate groups.

For example, a ligand may be derived from a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino(diphenyl ether)diimidedicarboxylic acid, 4,4′-diaminodiphenylmethanediimidedicarboxylic acid, 4,4′-diamino(diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbomane-2,3-dicarboxylic acid, 5-ethyl-2,3-pyridinedicarboxylic acid or camphordicarboxylic acid.

For example, a ligand may be derived from a tricarboxylic acid, such as for instance 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

For example, a ligand may be derived from a tetracarboxylic acid, such as, for instance, 1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

The ligands may also be derived from a carboxylic acid selected from compounds of formula L1 to L30 and combinations thereof:

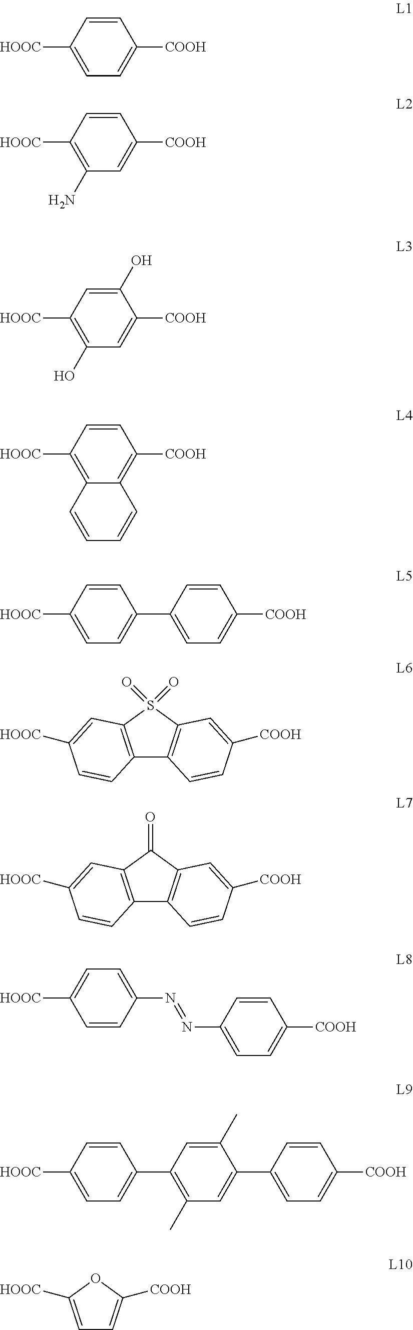

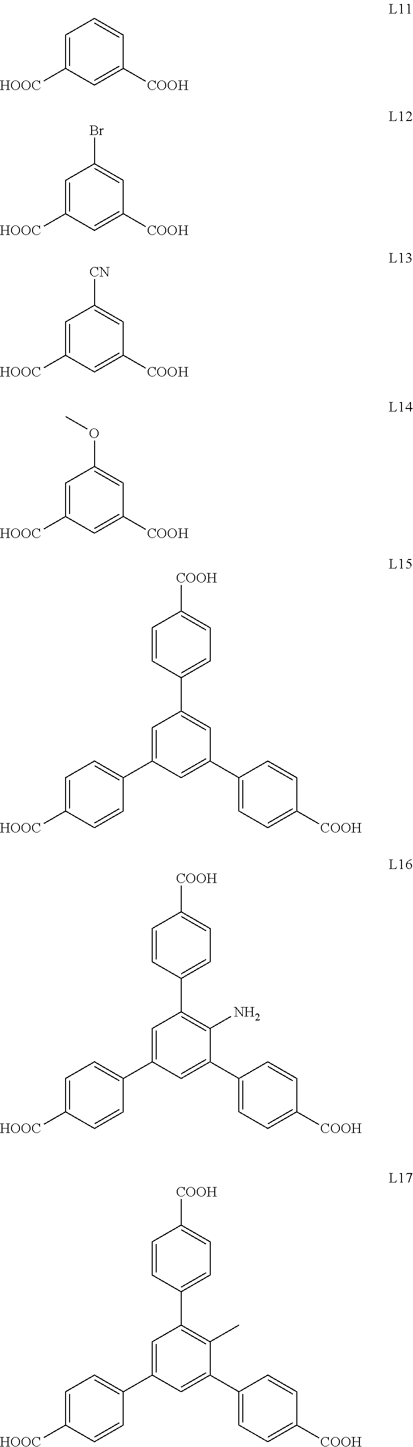

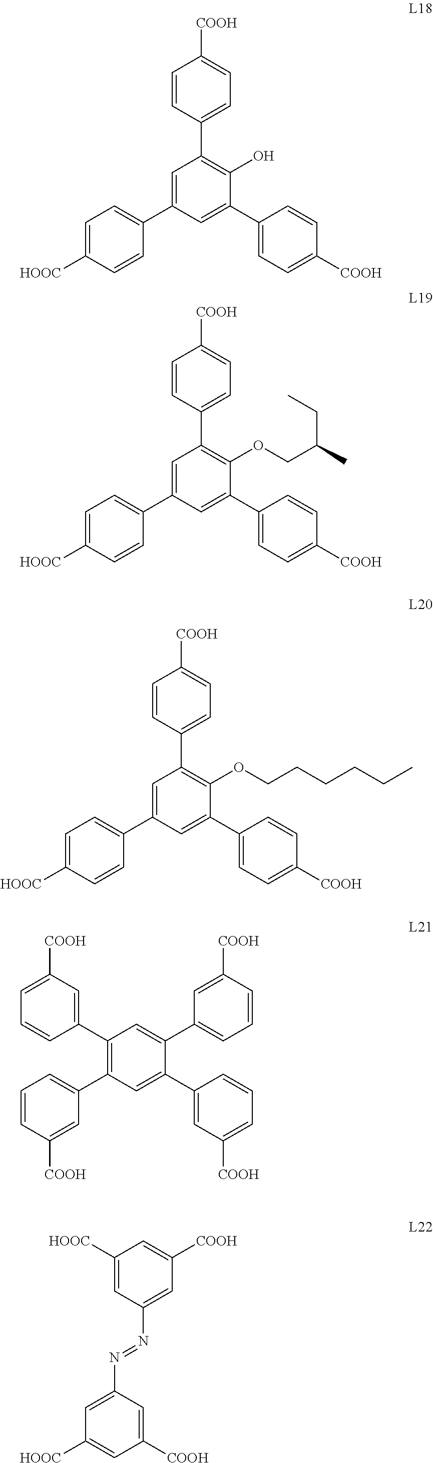 [SMILES: O=C(O)c1ccc(-c2cc(-c3ccc(C(=O)O)cc3)c(O)c(-c3ccc(C(=O)O)cc3)c2)cc1 ; CC[C@@H](C)COc1c(-c2ccc(C(=O)O)cc2)cc(-c2ccc(C(=O)O)cc2)cc1-c1ccc(C(=O)O)cc1 ; CCCCCCOc1c(-c2ccc(C(=O)O)cc2)cc(-c2ccc(C(=O)O)cc2)cc1-c1ccc(C(=O)O)cc1 ; O=C(O)c1cccc(-c2cc(-c3cccc(C(=O)O)c3)c(-c3cccc(C(=O)O)c3)cc2-c2cccc(C(=O)O)c2)c1 ; O=C(O)c1cc(/N=N/c2cc(C(=O)O)cc(C(=O)O)c2)cc(C(=O)O)c1]

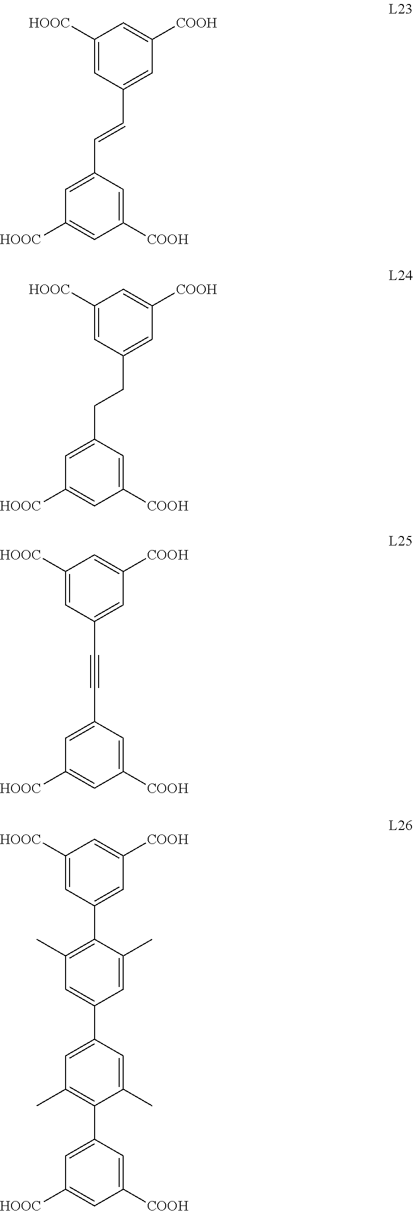 [SMILES: O=C(O)c1cc(/C=C/c2cc(C(=O)O)cc(C(=O)O)c2)cc(C(=O)O)c1 ; O=C(O)c1cc(CCc2cc(C(=O)O)cc(C(=O)O)c2)cc(C(=O)O)c1 ; O=C(O)c1cc(C#Cc2cc(C(=O)O)cc(C(=O)O)c2)cc(C(=O)O)c1 ; Cc1cc(-c2cc(C)c(-c3cc(C(=O)O)cc(C(=O)O)c3)c(C)c2)cc(C)c1-c1cc(C(=O)O)cc(C(=O)O)c1]

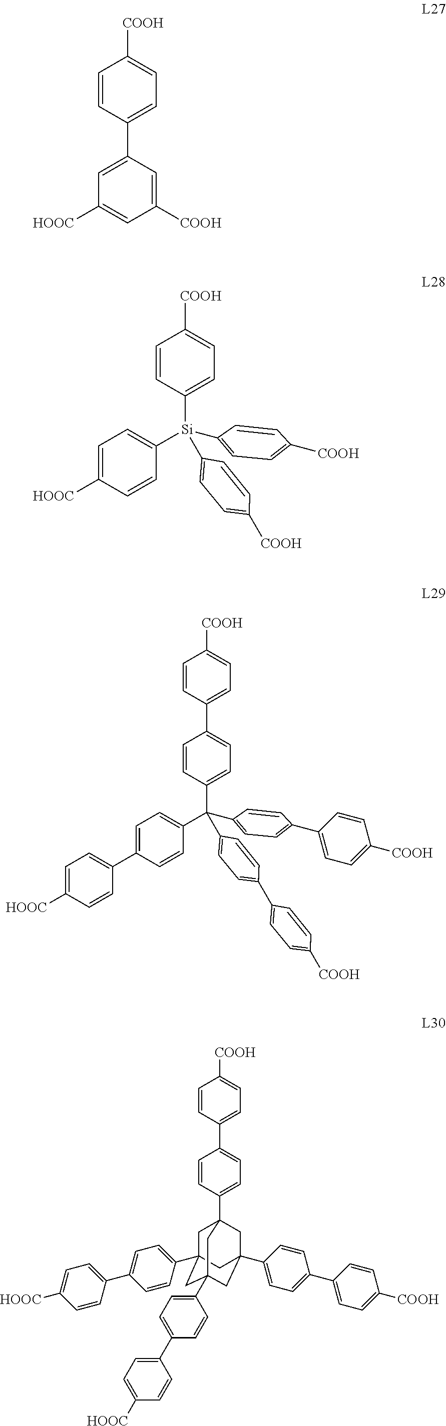 [SMILES: O=C(O)c1ccc(-c2cc(C(=O)O)cc(C(=O)O)c2)cc1 ; O=C(O)c1ccc([Si](c2ccc(C(=O)O)cc2)(c2ccc(C(=O)O)cc2)c2ccc(C(=O)O)cc2)cc1 ; O=C(O)c1ccc(-c2ccc(C(c3ccc(-c4ccc(C(=O)O)cc4)cc3)(c3ccc(-c4ccc(C(=O)O)cc4)cc3)c3ccc(-c4ccc(C(=O)O)cc4)cc3)cc2)cc1 ; O=C(O)c1ccc(-c2ccc(C34CC5(c6ccc(-c7ccc(C(=O)O)cc7)cc6)CC(c6ccc(-c7ccc(C(=O)O)cc7)cc6)(C3)CC(c3ccc(-c6ccc(C(=O)O)cc6)cc3)(C4)C5)cc2)cc1]

Specific combinations of ligands include ligands derived from L31 and L32:

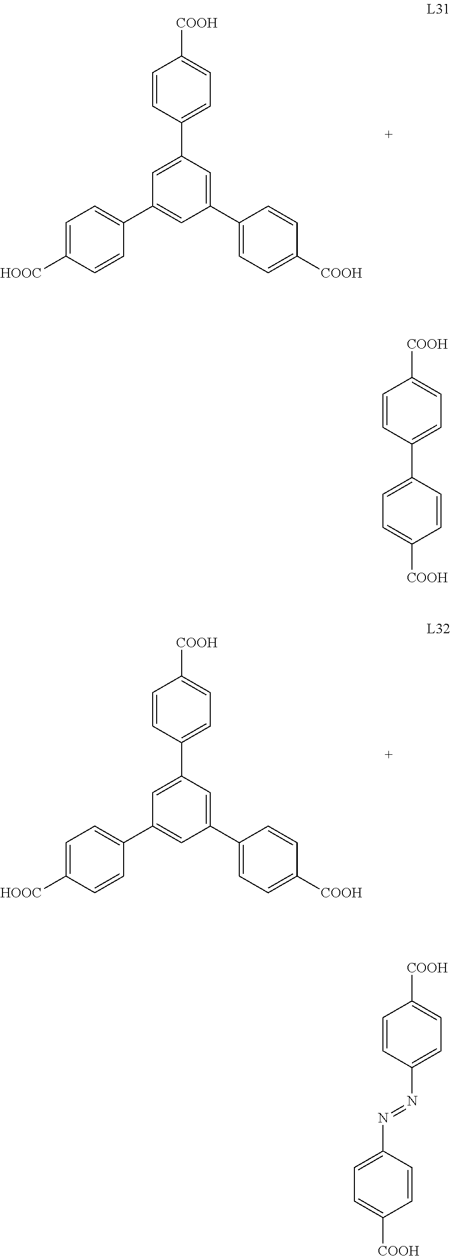 [SMILES: O=C(O)c1ccc(-c2cc(-c3ccc(C(=O)O)cc3)cc(-c3ccc(C(=O)O)cc3)c2)cc1 ; O=C(O)c1ccc(-c2ccc(C(=O)O)cc2)cc1 ; O=C(O)c1ccc(-c2cc(-c3ccc(C(=O)O)cc3)cc(-c3ccc(C(=O)O)cc3)c2)cc1 ; O=C(O)c1ccc(/N=N/c2ccc(C(=O)O)cc2)cc1]

Alternatively, the ligand may be derived from a carboxylic acid selected from the following compounds or combinations thereof:

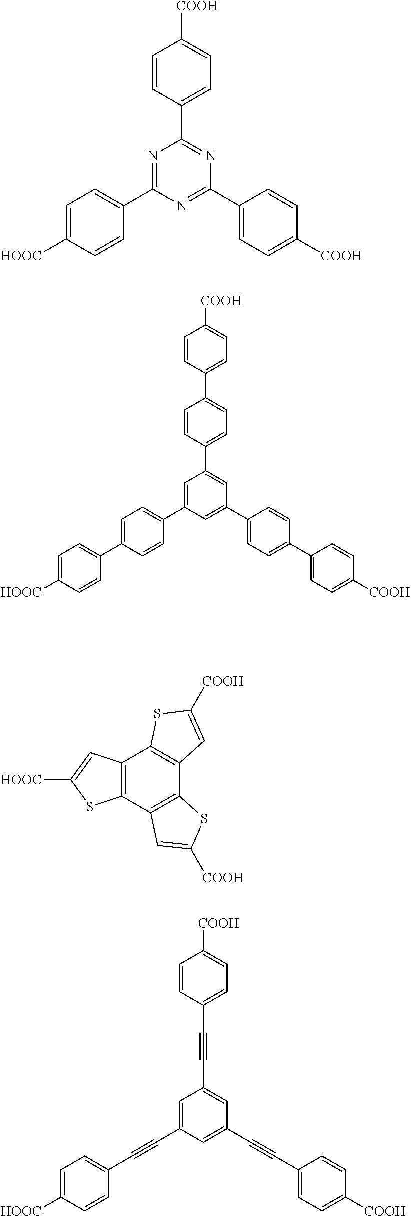 [SMILES: O=C(O)c1ccc(-c2nc(-c3ccc(C(=O)O)cc3)nc(-c3ccc(C(=O)O)cc3)n2)cc1 ; O=C(O)c1ccc(-c2ccc(-c3cc(-c4ccc(-c5ccc(C(=O)O)cc5)cc4)cc(-c4ccc(-c5ccc(C(=O)O)cc5)cc4)c3)cc2)cc1 ; O=C(O)c1cc2c(s1)c1cc(C(=O)O)sc1c1cc(C(=O)O)sc21 ; O=C(O)c1ccc(C#Cc2cc(C#Cc3ccc(C(=O)O)cc3)cc(C#Cc3ccc(C(=O)O)cc3)c2)cc1]

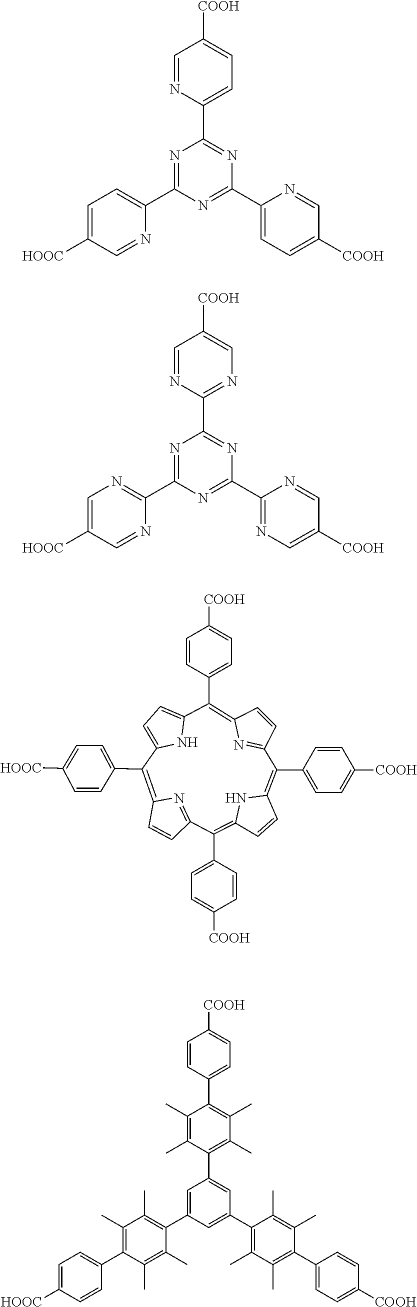 [SMILES: O=C(O)c1ccc(-c2nc(-c3ccc(C(=O)O)cn3)nc(-c3ccc(C(=O)O)cn3)n2)nc1 ; O=C(O)c1cnc(-c2nc(-c3ncc(C(=O)O)cn3)nc(-c3ncc(C(=O)O)cn3)n2)nc1 ; O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1 ; Cc1c(C)c(-c2cc(-c3c(C)c(C)c(-c4ccc(C(=O)O)cc4)c(C)c3C)cc(-c3c(C)c(C)c(-c4ccc(C(=O)O)cc4)c(C)c3C)c2)c(C)c(C)c1-c1ccc(C(=O)O)cc1]

In one embodiment, the ligand is selected from a ligand derived from a tetracarboxylic acid. In one embodiment, the ligand is a ligand derived from ABTC (3,3′,5,5′ azobenzene tetracarboxylic acid (L22)). In one embodiment, the ligand is ABTC.

In one embodiment, the amorphous metal organic framework comprises an Fe₃O or Fe₂XO metal cluster/metal node. In one embodiment, the disclosure provides an amorphous metal organic framework comprising a metal cluster/metal node comprising the formula Fe₃O and one or more ligands derived from ABTC.

In one embodiment, the amorphous metal organic framework comprises a metal cluster/metal node comprising the formula Al₃O and one or more ligands derived from ABTC.

In one embodiment, the amorphous metal organic framework comprises a metal cluster/metal node comprising the formula Cr₃O and one or more ligands selected from but not limited to di-, tri-, and tetra-carboxylate ligands. For example, the carboxylate ligands may be 2′,3″, 5″,6′-tetramethyl-[1,1′: 4′,1″: 4″,1′″-quaterphenyl]3,3′″,5,5′″-tetracarboxylate, 1,3,5-benzenetribenzoate, and 4,4′,4″-s-triazine-2,4,6-triyltribenzoate.

Additionally and/or alternatively, these amorphous metal organic frameworks exhibit high fluid uptake. Additionally and/or alternatively, these amorphous metal organic so frameworks exhibit high gas uptake. Additionally and/or alternatively, these amorphous metal organic frameworks exhibit high liquid uptake.

In one embodiment, the fluid is a gas, for example nitrogen.

In one embodiment, the fluid is a hydrocarbon, for example methane.

In one embodiment, the fluid is an acid gas, for example hydrogen sulfide.

In one embodiment, the fluid is a sulfur containing liquid or gas, e.g. hydrogen sulfide.

In one embodiment, the fluid is a condensable liquid, for example water.

In one embodiment the fluid may be selected from:
(a) H₂, N₂, Ar, O₂, CO₂, NO, NO₂ or CO; or
(b) an alkane (C1-6), alkene (C2-4), alkyne (C2-6), alcohol (C1-6), arene (C6-8) or a substituted version of any of these;

wherein the alkane may be selected from CH₄, C₂H₆, C₃H₈, C₄H₁₀, C₅H₁₂ or C₆H₁₄;

or a cycloalkane (C3-6) selected from the group consisting of C₃H₆, C₄H₈, C₅H₁₀ and C₆H₁₄;

wherein the alkene may be C₂H₄, C₃H₆, C₄H₈, C₅H₁₀ or C₆H₁₂;

wherein the alkyne may be C₂H₂;

wherein the alcohol may be methanol, ethanol, n-propanol, isopropanol, n-butanol or isobutanol; or

wherein the arene may be a substituted arene (C6-8) such as is nitrobenzene, 1,2-dinitrobenzene, 1,3-dinitrobenzene, 1,4-dinitrobenzene, 1,2,4-trinitrobenzene or 1,3,5-trinitrobenzene.

In one embodiment, the gas may be selected from hydrogen, methane, carbon dioxide or nitrogen. For example, the gas may be nitrogen.

In one embodiment, the liquid may be water. In other embodiments, the liquid may be an aqueous solution. In at least some instances, the aqueous solution may include one or more contaminants.

In one embodiment, the amorphous metal organic framework is greater than 75% amorphous. In one embodiment, the amorphous metal organic framework is greater than 85% amorphous. In one embodiment, the amorphous metal organic framework is greater than 95% amorphous. In one embodiment, the amorphous metal organic framework is greater than 99% amorphous. In one embodiment, the amorphous metal organic framework is 100% amorphous.

Absorbent Material

The present disclosure provides an absorbent material comprising a porous substrate impregnated with a metal organic framework; wherein the metal organic framework is amorphous.

In one embodiment, the amorphous metal organic framework comprises (i) a metal cluster; and (ii) one or more ligands.

In one embodiment, the amorphous metal organic framework comprises (i) a metal node; and (ii) one or more ligands having two or more carboxylate groups.

In one embodiment, the metal of the metal organic framework has a valence of 3. In one embodiment, the metal of the metal organic framework has an oxidation state of 3.

In one embodiment, the metal organic framework is an iron, aluminium, chromium, titanium, cobalt, nickel, manganese, zinc, magnesium, vanadium, scandium, calcium, barium, indium or zirconium metal organic framework.

In one embodiment, the metal of the metal organic framework has a valence of 4. In one embodiment, the metal of the metal organic framework has an oxidation state of 4.

In one embodiment, the metal organic framework is a germanium, tin, titanium, zirconium, hafnium and thorium.

In one embodiment, the metal organic framework is an iron, aluminium, chromium, titanium or zirconium metal organic framework.

In one embodiment, the metal organic framework is an iron, aluminium, titanium or zirconium metal organic framework.

In one embodiment, the metal organic framework is an iron, aluminium or titanium metal organic framework.

In one embodiment, the metal organic framework is an iron metal organic framework.

In one embodiment, the metal organic framework is an aluminium metal organic framework.

In one embodiment, the metal organic framework is a chromium metal organic framework.

In one embodiment, the metal of the metal organic framework is selected from Al(III), Fe(II), Fe(III), Ti(IV) Cr(III), Zr(III) or Zr(IV), Co(II), Ni(II), Mn(II), Zn(II), Mg(II), V(III), Sc(III), Ca(II), Ba(II) or In(III). In one embodiment, the metal of the metal organic framework is selected from Al(III), Fe(II), Fe(III), Ti(IV), Cr(III), Zr(III) or Zr(IV). In one embodiment, the metal of the metal organic framework is selected from Al(III), Fe(II), Fe(III) or Ti(IV).

The present disclosure provides an absorbent material comprising a porous substrate impregnated with an iron, aluminium, titanium, chromium or zirconium metal organic framework, wherein the metal organic framework is amorphous.

The present disclosure also provides an absorbent material comprising: a porous substrate; and an amorphous metal organic framework, wherein at least a portion of the amorphous metal organic framework is impregnated in the porous substrate.

In one embodiment, the absorbent material further comprises crystalline or polycrystalline metal organic framework, the metal organic framework being at least 75% amorphous.

In one embodiment, the absorbent material does not contain crystalline metal organic framework.

In one embodiment, the amorphous metal organic framework comprises (i) a metal cluster; and (ii) one or more ligands; wherein the metal cluster comprises a metal selected from iron, aluminium, titanium, chromium and zirconium.

In one embodiment, the amorphous metal organic framework comprises (i) a metal node; and (ii) one or more ligands having two or more carboxylate groups; wherein the metal node comprises a metal selected from iron, aluminium, and chromium.

In one embodiment, the porous substrate may be any substrate described herein. In one embodiment, the substrate is mesoporous. In one embodiment, the substrate is microporous. In one embodiment, the substrate has an average pore diameter of between about 0.1 nm to about 20 nm. In one embodiment, the substrate has an average pore diameter of between about 1 and about 20 nm. In one embodiment, the substrate has an average pore diameter of between about 1 and about 15 nm. In one embodiment, the substrate has an average pore diameter of between about 2.5 nm and about 10 nm. In one embodiment, the substrate has an average pore diameter of about 0.8 nm, 2.7 nm, 3.8 nm, 6.0 nm or 7.0 nm.

In one embodiment, the porous substrate has a maximum average pore diameter of about 20 nm. In one embodiment, the porous substrate has a maximum average pore diameter of about 15 nm. In one embodiment, the porous substrate has a maximum average pore diameter of about 10 nm. In one embodiment, the porous substrate has a maximum average pore diameter of about 5 nm.

In one embodiment, the porous substrate is an organic porous substrate or inorganic porous substrate. For example, the porous substrate may be a metal/inorganic oxide, zeolite, zeotype, molecular sieve, aluminosilicate, aluminophosphate, foam, or carbon/metal based framework.

In one embodiment, the porous substrate is selected from the group consisting of activated carbons, zeolites, aluminium oxide, and silica and silica gel.

The one or more ligands may be selected from any of the ligands described herein. In one embodiment, the one or more ligands have two or more carboxylate groups. In one embodiment, the one or more ligands have three or more carboxylate groups. In one so embodiment, the one or more ligands have four or more carboxylate groups.

For example, a ligand may be derived from a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino(diphenyl ether)diimidedicarboxylic acid, 4,4′-diaminodiphenylmethanediimidedicarboxylic acid, 4,4′-diamino(diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbomane-2,3-dicarboxylic acid, 5-ethyl-2,3-pyridinedicarboxylic acid or camphordicarboxylic acid.

For example, a ligand may be derived from a tricarboxylic acid, such as for instance 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

For example, a ligand may be derived from a tetracarboxylic acid, such as, for instance, 1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, 3,3′,5,5′-tetracarboxydiphenylmethane or cyclopentanetetracarboxylic acids such as cyclopentane-1,2,3,4-tetracarboxylic acid.

The ligands may also be derived from a carboxylic acid selected from compounds of formula L1 to L30 and combinations thereof:

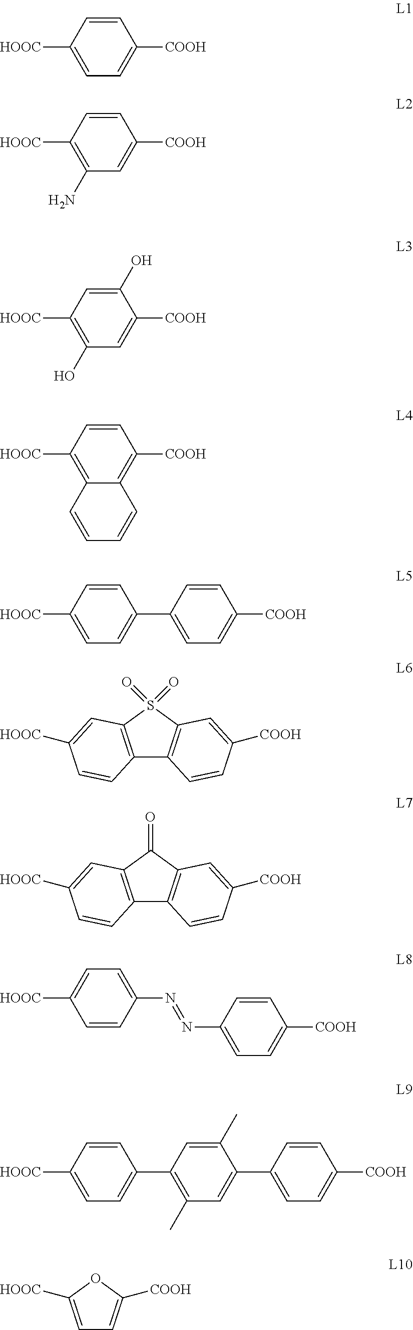

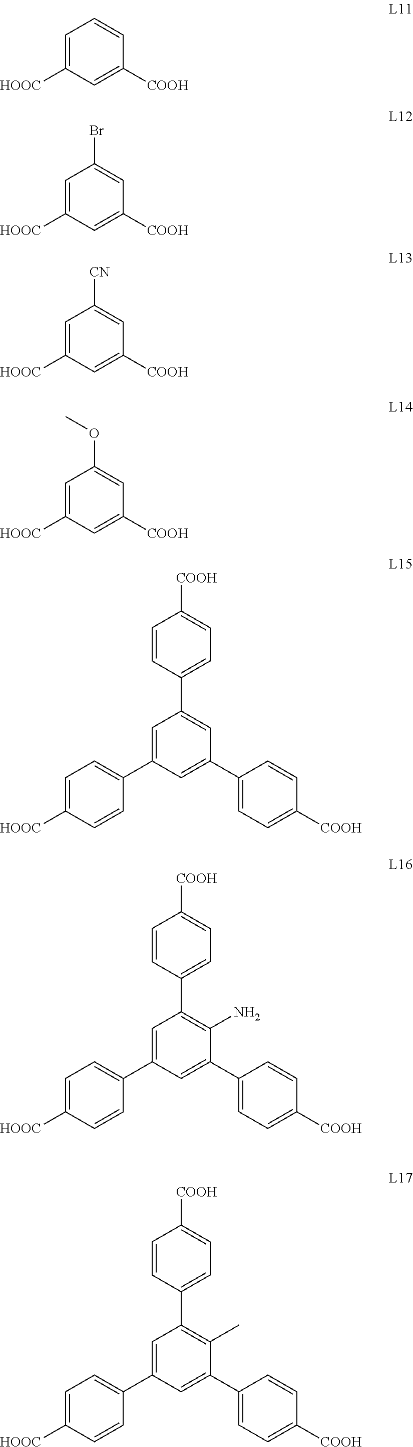

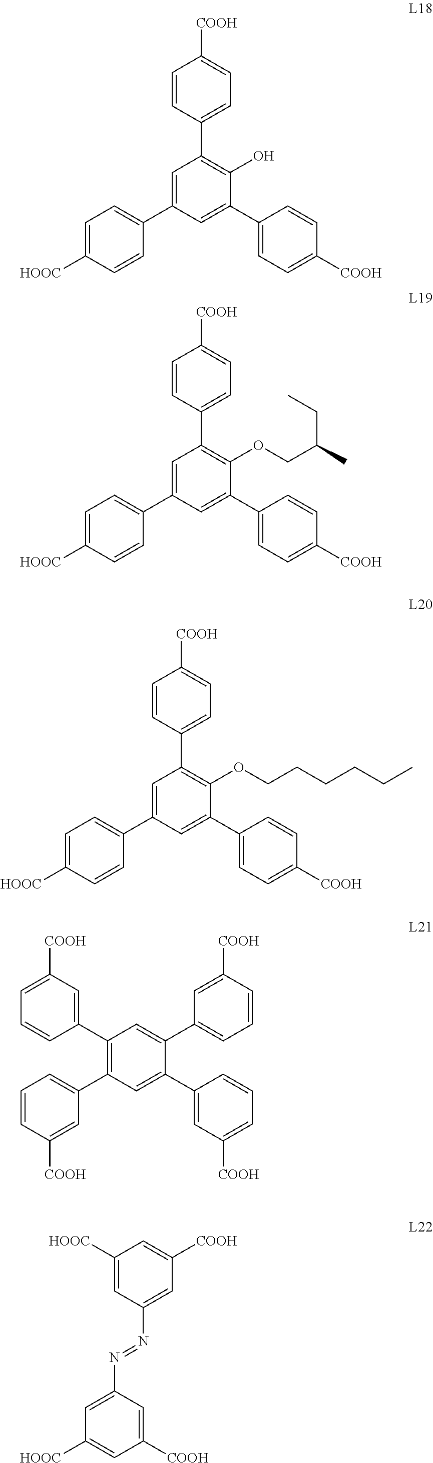 [SMILES: O=C(O)c1ccc(-c2cc(-c3ccc(C(=O)O)cc3)c(O)c(-c3ccc(C(=O)O)cc3)c2)cc1 ; CC[C@@H](C)COc1c(-c2ccc(C(=O)O)cc2)cc(-c2ccc(C(=O)O)cc2)cc1-c1ccc(C(=O)O)cc1 ; CCCCCCOc1c(-c2ccc(C(=O)O)cc2)cc(-c2ccc(C(=O)O)cc2)cc1-c1ccc(C(=O)O)cc1 ; O=C(O)c1cccc(-c2cc(-c3cccc(C(=O)O)c3)c(-c3cccc(C(=O)O)c3)cc2-c2cccc(C(=O)O)c2)c1 ; O=C(O)c1cc(/N=N/c2cc(C(=O)O)cc(C(=O)O)c2)cc(C(=O)O)c1]

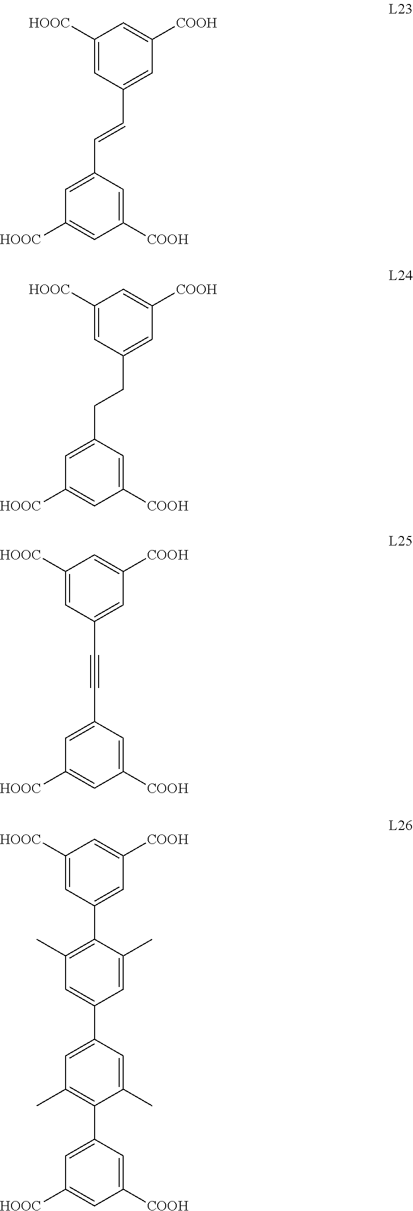 [SMILES: O=C(O)c1cc(/C=C/c2cc(C(=O)O)cc(C(=O)O)c2)cc(C(=O)O)c1 ; O=C(O)c1cc(CCc2cc(C(=O)O)cc(C(=O)O)c2)cc(C(=O)O)c1 ; O=C(O)c1cc(C#Cc2cc(C(=O)O)cc(C(=O)O)c2)cc(C(=O)O)c1 ; Cc1cc(-c2cc(C)c(-c3cc(C(=O)O)cc(C(=O)O)c3)c(C)c2)cc(C)c1-c1cc(C(=O)O)cc(C(=O)O)c1]

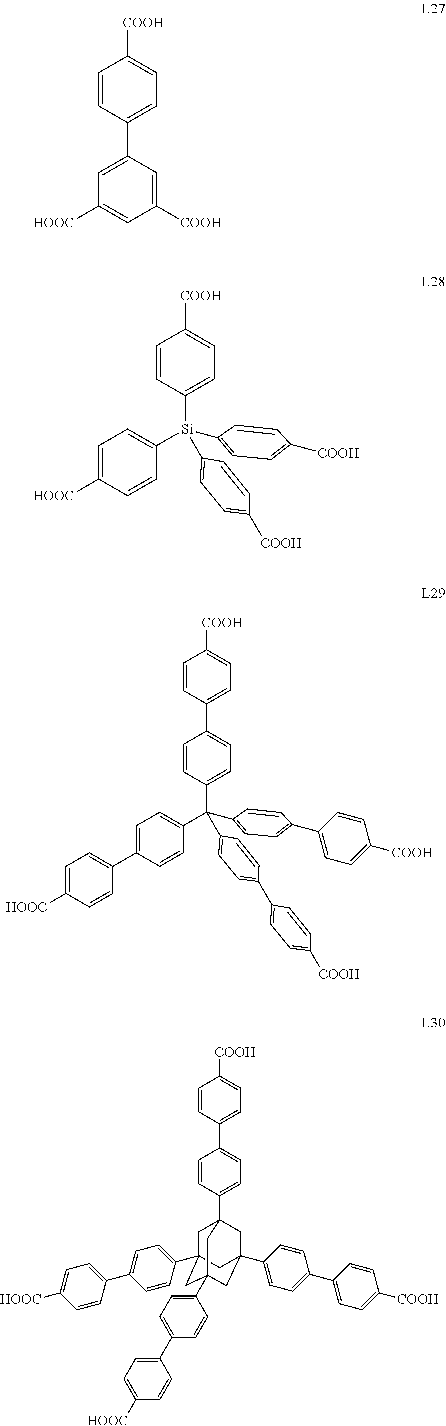 [SMILES: O=C(O)c1ccc(-c2cc(C(=O)O)cc(C(=O)O)c2)cc1 ; O=C(O)c1ccc([Si](c2ccc(C(=O)O)cc2)(c2ccc(C(=O)O)cc2)c2ccc(C(=O)O)cc2)cc1 ; O=C(O)c1ccc(-c2ccc(C(c3ccc(-c4ccc(C(=O)O)cc4)cc3)(c3ccc(-c4ccc(C(=O)O)cc4)cc3)c3ccc(-c4ccc(C(=O)O)cc4)cc3)cc2)cc1 ; O=C(O)c1ccc(-c2ccc(C34CC5(c6ccc(-c7ccc(C(=O)O)cc7)cc6)CC(c6ccc(-c7ccc(C(=O)O)cc7)cc6)(C3)CC(c3ccc(-c6ccc(C(=O)O)cc6)cc3)(C4)C5)cc2)cc1]

Specific combinations of ligands include ligands derived from L31 and L32:

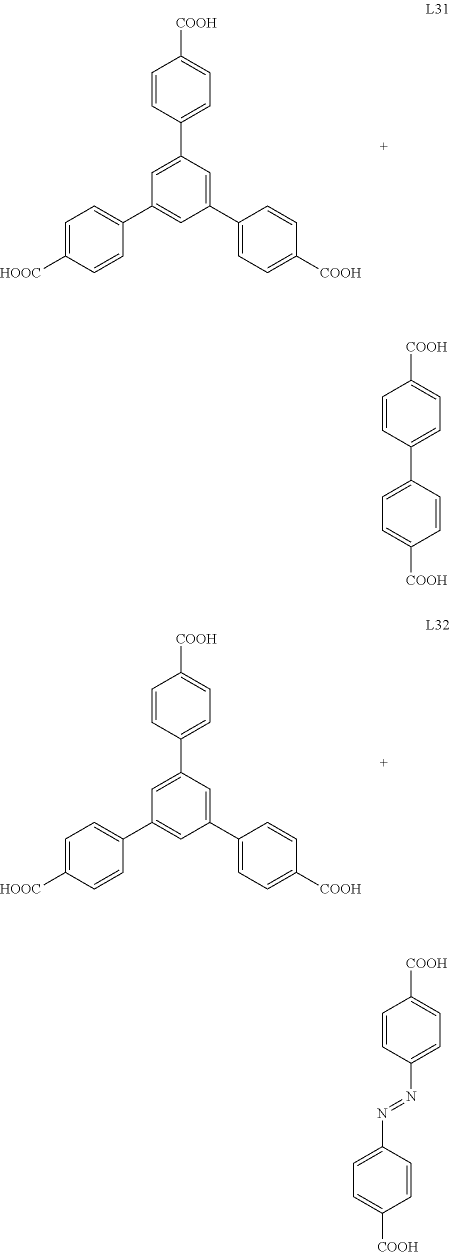 [SMILES: O=C(O)c1ccc(-c2cc(-c3ccc(C(=O)O)cc3)cc(-c3ccc(C(=O)O)cc3)c2)cc1 ; O=C(O)c1ccc(-c2ccc(C(=O)O)cc2)cc1 ; O=C(O)c1ccc(-c2cc(-c3ccc(C(=O)O)cc3)cc(-c3ccc(C(=O)O)cc3)c2)cc1 ; O=C(O)c1ccc(/N=N/c2ccc(C(=O)O)cc2)cc1]

Alternatively, the ligand may be derived from a carboxylic acid selected from the following compounds or combinations thereof:

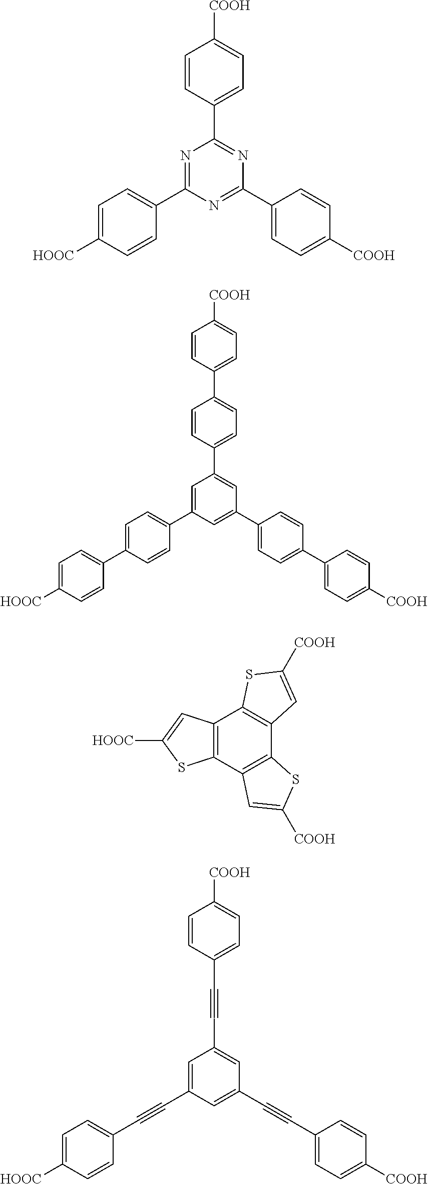 [SMILES: O=C(O)c1ccc(-c2nc(-c3ccc(C(=O)O)cc3)nc(-c3ccc(C(=O)O)cc3)n2)cc1 ; O=C(O)c1ccc(-c2ccc(-c3cc(-c4ccc(-c5ccc(C(=O)O)cc5)cc4)cc(-c4ccc(-c5ccc(C(=O)O)cc5)cc4)c3)cc2)cc1 ; O=C(O)c1cc2c(s1)c1cc(C(=O)O)sc1c1cc(C(=O)O)sc21 ; O=C(O)c1ccc(C#Cc2cc(C#Cc3ccc(C(=O)O)cc3)cc(C#Cc3ccc(C(=O)O)cc3)c2)cc1]

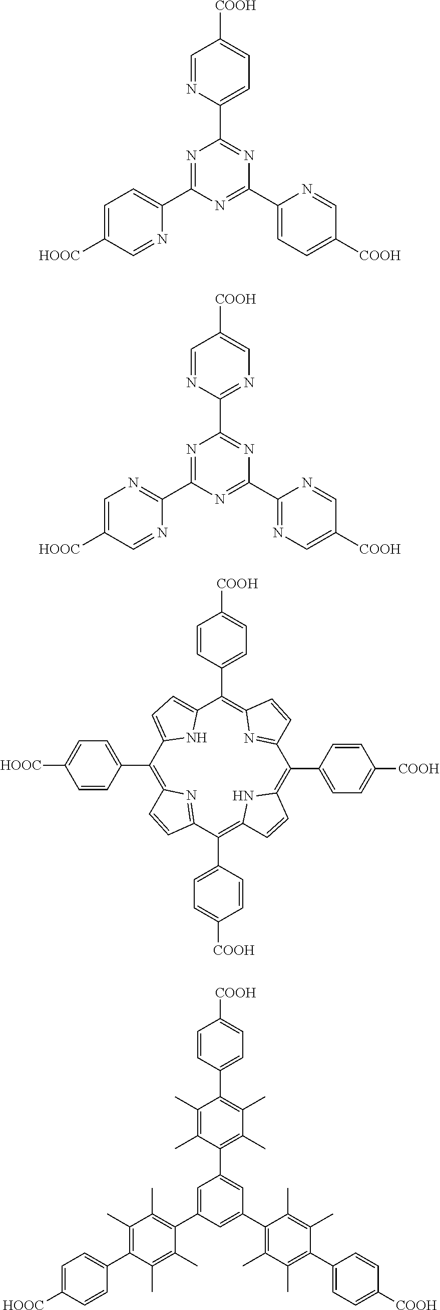 [SMILES: O=C(O)c1ccc(-c2nc(-c3ccc(C(=O)O)cn3)nc(-c3ccc(C(=O)O)cn3)n2)nc1 ; O=C(O)c1cnc(-c2nc(-c3ncc(C(=O)O)cn3)nc(-c3ncc(C(=O)O)cn3)n2)nc1 ; O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1 ; Cc1c(C)c(-c2cc(-c3c(C)c(C)c(-c4ccc(C(=O)O)cc4)c(C)c3C)cc(-c3c(C)c(C)c(-c4ccc(C(=O)O)cc4)c(C)c3C)c2)c(C)c(C)c1-c1ccc(C(=O)O)cc1]

In one embodiment, the ligand is selected from a ligand derived from a tetracarboxylic acid. In one embodiment, the ligand is a ligand derived from ABTC (3,3′,5,5′ azobenzene tetracarboxylic acid (L22)). In one embodiment, the ligand is ABTC.

The above mentioned ligands are particularly suitable for use in amorphous iron, aluminium, or chromium metal organic frameworks described herein.

Amorphous Iron Metal Organic Frameworks

In one embodiment, the metal cluster/metal node comprises the formula Fe₂XO, wherein X is a metal selected from Group 2 through Group 16, for example a transition metal. For example, X is selected from Al, Fe, Co, Mn, Zn, Ni, Mg, Cu, and Ca. For example, the metal cluster/metal node has the formula Fe₃O.

In one embodiment, the amorphous iron metal organic frameworks comprise a ligand derived from any of the ligands described above having two or more carboxylate groups.

In one embodiment, the amorphous metal organic framework comprises an Fe₃O metal cluster/metal node. Specifically, the amorphous metal organic framework comprises a metal cluster/metal node comprising the formula Fe₃O and one or more ligands derived from ABTC.

Amorphous Aluminium Metal Organic Frameworks

In one embodiment, the metal cluster/metal node comprises the formula Al₂XO, wherein X is a metal selected from Group 2 through Group 16, for example a transition metal. For example, X is selected from Al, Fe, Co, Mn, Zn, Ni, Mg, Cu, and Ca. For example, the metal cluster/metal node has the formula Al₃O.

In one embodiment, the amorphous aluminium metal organic frameworks comprise a ligand derived from any of the ligands described above having two or more carboxylate groups.

Specifically, the amorphous metal organic framework comprises a metal cluster/metal node comprising the formula Al₃O and one or more ligands derived from ABTC.

Amorphous Titanium Metal Organic Frameworks

In one embodiment, the metal cluster/metal node comprises the formula TiₐX_{b}O_{c}, wherein X is a metal selected from Group 2 through Group 16, for example a transition metal, and wherein a+b=c. For example, X is selected from Al, Fe, Ti, Co, Mn, Zn, Ni, Mg, Cu, and Ca. For example, the metal cluster/metal node has the formula TiO, Ti₈O₈ or Ti₁₆O₁₆.

Specifically, the amorphous metal organic framework comprises a metal cluster/metal node comprising the formula TiO, Ti₈O₈ or Ti₁₆O₁₆ and one or more ligands derived from 1,4-benzene-dicarboxylic acid.

In one embodiment, the amorphous metal organic framework comprises a metal cluster/metal node comprising the formula Ti, Ti₂, Ti₂O₂, TiO, TiO_{0.5}, Ti₃O₂, Ti₃O₃, Ti₃O, Ti₇O₆, Ti₆O₆, Ti₈O₈, or Ti₁₆O₁₆ and one or more ligands derived from methylenediphosphonate, elthlyenediphosphonate, propylenediphosphonate, N,N′-piperazinebismehtylenephosphonate, terephthalate, 1,4-cyclohexanedicarboxylate, 1,4-benzenedicarboxylate, tetrakis(4-carboxyphenyl)porphyrin, 1,4-phenylenebis(methanylylidene)bis(azanylylidene)dibenzoate, bisphenyl-4,4′diylbis-(methanylylidene)bis(azanylylidene)dibenzoate, 2,5-dihydroxyterephthalate, hydroquinone, 2,7-dihydroxy-naphthalene, resourcinol, 4,4′dihydroxy-biphenyl, 2,3,6,7,9,11-hexahydroxytriphenylene, 3,3′,5,5′-tetracarboxydiphenylmethane and 4-picoline.

In one embodiment the amorphous titanium metal organic framework comprises formula (I).

TiₐO_{b}(OH)_{c}[(⁻OOC)—X-#]_{d} (I)

In formula (I):

X is an organic spacer and represents a saturated or unsaturated, linear or branched, aliphatic chain having 2 to 12 carbon atoms; a monocyclic, bicyclic or tricyclic so hydrocarbon-based aromatic group that is unsubstituted or that is substituted by one or more substituents R independently chosen from a halogen atom and amino, nitro, hydroxyl, C1-C4 trifluoroalkyl and C1-C4 alkyl groups: a benzophenone group; a monocyclic or bicyclic heteroaromatic group in which the ring(s) is(are) 5- or 6-membered ring(s), said group containing at least one heteroatom chosen from nitrogen and sulfur and being unsubstituted or substituted by one or more substituents R independently chosen from a halogen atom and amino, nitro, hydroxyl, C1-C4 trifluoroalkyl and C1-C4 alkyl groups;

a and b, which are identical or different, are integers varying from 1 to 16 inclusively; c and d, which are identical or different, are integers varying from 1 to 32 inclusively; the indices a, b, c and d adhere to the relation 4a=2b+c+d;

the titanium atoms form a purely inorganic elementary building block constituted of titanium oxo complexes;

# is the point through which two units of formula (I) are joined together; # represents a covalent bond between a carbon atom belonging to the spacer X and the carbon atom of a carboxylate group COO⁻of another unit of formula (I) and in which the two oxygen atoms of the carboxylate group belong respectively to two adjacent octahedral titanium oxo complexes of an elementary building block of said other unit of formula (I);

In some embodiments, a single X may be shared between two or more units of formula (I).

In one embodiment, X may be made of linear alkyl chains such as ethyl, propyl, butyl, pentyl, hexyl, heptyl, octyl, nonyl, decyl, undecyl and dodecyl chains; linear alkene chains such as ethylene, propylene, butylene, pentylene, hexylene, heptylene, octylene, nonylene, decylene, undecylene and dodecylene; alkyne chains such as ethyne, propyne, butyne, pentyne, hexyne, heptyne, octyne, nonyne, decyne, undecyne and dodecyne. Among such chains, C1-C4 alkyl chains and C2-C4 alkene or alkyne chains are preferred.

In one embodiment, X may be made of phenylene; chlorophenylene; bromophenylene; aminophenylene; nitrophenylene; mono-, di- or tetramethylphenylene; mono- or diethenylphenylene; mono- or dihydroxyphenylene; biphenylene; diphenyldiazene; so naphthalene and anthracene groups.

In one embodiment, X may be made of thiophene, bithiophene, pyridine, bipyridine and pyrazine rings.

In one embodiment, the subunit [⁻OOC—X-#] is chosen from the groups of formulae (II-1) to (II-13) below:

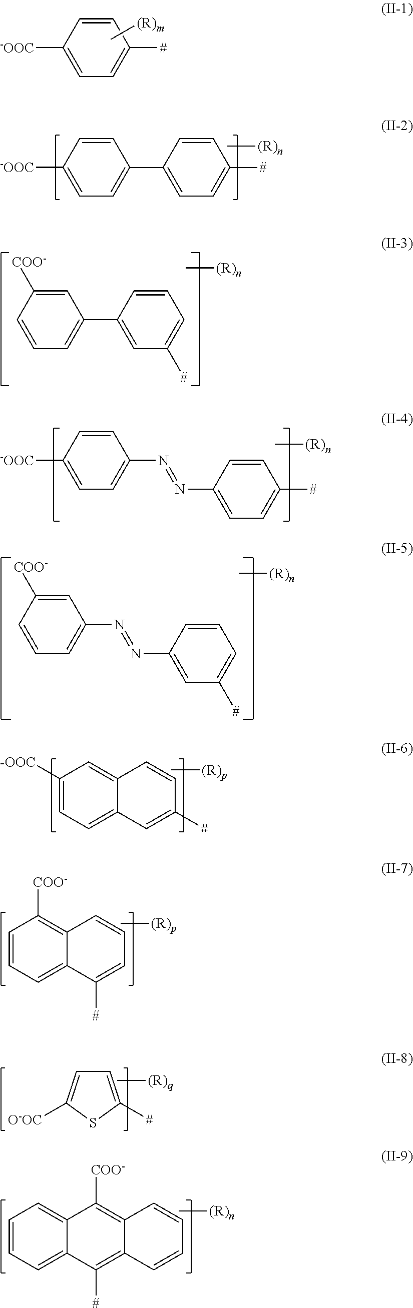

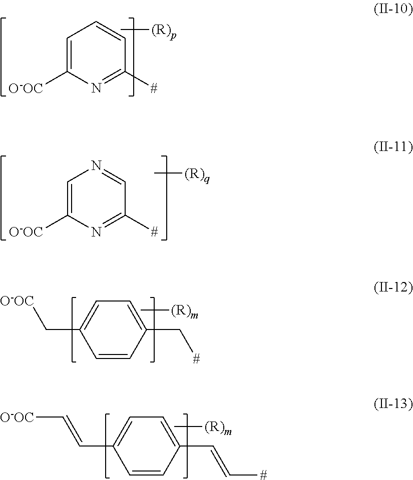

in which:

R is a halogen atom, an amino, nitro, hydroxyl, C1-C4 trifluoroalkyl or C1-C4 alkyl group;

m is an integer ranging from 0 to 4;

n is an integer ranging from 0 to 8;

p is an integer ranging from 0 to 6;

q is an integer ranging from 0 to 2; and

r is an integer ranging from 0 to 3.

In one embodiment, formula (II-1) is selected from, phenyl-1-carboxylate, phenyl-2-amino-1-carboxylate, phenyl-2,5-dihydroxy-1-carboxylate and phenyl-2-chloro-1-carboxylate.

In one embodiment, formula (II-4) is selected from azobenzene-4-carboxylate, azobenzene-3,3′-dichloro-4-carboxylate and azobenzene-3,3′-dihydroxy-4-carboxylate.

In one embodiment, formula (II-8) is selected from thiophene-2-carboxylate and 3,4-dihydroxythiophene-2-carboxylate.

In one embodiment, the subunit [⁻OOC—X-#] is selected from phenyl-1-carboxylate, phenyl-2-amino-1-carboxylate, and thiophene-2-carboxylate.

In one embodiment, the subunits of formula (I) as defined previously, is selected from the subunits of formula (I-1) below:

Ti₈O₈(OH)₄[(⁻OOC)—X-#]₁₂ (I-1)

In formula (I-1):

X and # are as defined previously;

the titanium atoms form a purely inorganic elementary building block constituted of 8 octahedral titanium oxo complexes each comprising a central titanium atom surrounded by 6 oxygen atoms, said octahedral titanium oxo complexes being joined together either by a common edge, or by a common apex, in both cases by means of oxo-O— or hydroxo-OH— bridges; said building blocks being connected together in the three dimensions of space by organic spacers X; it being understood that each of the building blocks is connected to 12 organic spacers by means of carboxylate groups COO⁻in which each of the two oxygen atoms is an integral part of two adjacent titanium oxo complexes.

In the subunits of formula (I-1), an elementary building block (or wheel of octahedral titanium oxo complexes) therefore contains 36 oxygen atoms connected to eight titanium atoms alternately either via a common edge involving two oxo or hydroxo bridges or by a common apex involving a single oxo or hydroxo bridge, or by means of carboxylate groups.

In one embodiment, the metal cluster/metal node comprises the formula Ti₁₂O₁₅ or Ti₁₂O₁₈ and the ligand is derived from the following groups:

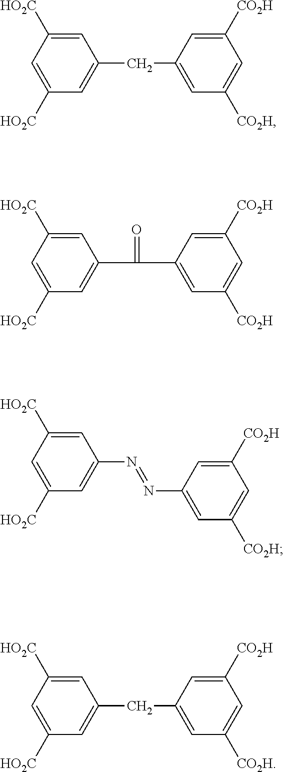 [SMILES: O=C(O)c1cc(Cc2cc(C(=O)O)cc(C(=O)O)c2)cc(C(=O)O)c1 ; O=C(O)c1cc(C(=O)O)cc(C(=O)c2cc(C(=O)O)cc(C(=O)O)c2)c1 ; O=C(O)c1cc(/N=N/c2cc(C(=O)O)cc(C(=O)O)c2)cc(C(=O)O)c1 ; O=C(O)c1cc(Cc2cc(C(=O)O)cc(C(=O)O)c2)cc(C(=O)O)c1]

In one embodiment, the metal organic framework comprises a metal cluster/metal node of formula Ti₁₂O₁₅, a ligand derived from the above group, and formate (as an additional ligand).

Amorphous Chromium Metal Organic Frameworks

In one embodiment, the metal organic framework comprises at least one metal cluster/metal node, each metal cluster/metal node comprising at least one chromium metal ion. For example, the at least one metal cluster/metal node comprises at least two chromium metal ions, or the at least one metal cluster/metal node comprises three chromium metal ions.

In one embodiment, the metal cluster/metal node may have a formula of Cr₃O.

In one embodiment, the metal organic framework may have a Cr₃O cornerstone.

In one embodiment, the chromium metal organic framework comprises metal clusters/metal nodes coordinated with 4, 5, or 6 ligands.

In one embodiment, the chromium metal organic framework comprises inorganic cornerstones having at least 8 coordination sites, at least 10 coordination sites, or having 12 coordination sites.

In one embodiment, the chromium metal organic framework has a molar ratio of metal ions to organic linker of from about 1:0.30 to about 1:0.55, or from about 1:0.33 to about 1:0.5.

The carboxylate ligands may be selected from any suitable carboxylate ligands. A range of suitable carboxylate ligands are provided above.

In particular, the carboxylate ligands may be selected from but not limited to di-, tri-, and tetra-carboxylate ligands. For example, the carboxylate ligands may be 2′,3″, 5″,6′-tetramethyl-[1,1′1′: 14″,1′″-quaterphenyl] 3,3′″,5,5′″-tetracarboxylate, 1,3,5-benzenetribenzoate, and 4,4′,4″-s-triazine-2,4,6-triyltribenzoate.

The metal organic frameworks may comprise Cr³⁺ ions metal ions which may be octahedrally coordinated, wherein three Cr³⁺ ions share a common oxygen to form a [Cr₃(μ-O)] cluster. For example, each [Cr₃(μ-O)] cluster may be connected with four carboxylate ligands and four aqua ligands.

The carboxylate ligands may be selected from any suitable carboxylate ligands. A range of suitable carboxylate ligands are provided herein.

In particular, the carboxylate ligands may be selected from but not limited to di-, tri-, and tetra-carboxylate ligands. For example, the carboxylate ligands may be 2′,3″, 5″,6′-tetramethyl-[1,1′: 4′,1″: 4″,1′″-quaterphenyl] 3,3′″,5,5′″-tetracarboxylate, 1,3,5-benzenetribenzoate, and 4,4′,4″-s-triazine-2,4,6-triyltribenzoate.

Amorphous Zirconium Metal Organic Frameworks

In one embodiment, the metal cluster/metal node comprises the formula Zr₆Oₓ, wherein x is an integer from 4 to 32. In one embodiment, the amorphous metal organic framework comprises a metal cluster/metal node comprising the formula Zr₆(OH)s, Zr(O)₄(OH)₄, Zr₆O₈, Zr₈O₆, Zr₆(O)₄(OH)s, Zr₆(O)₆(OH)₂, Zr₆(O)₄(OH)₄, Zr₆O₃(O)₄, Zr₆O₄(OH)₄ or Zr₆(OH)₈ (OH)₈.

When the metal cluster/metal node comprises zirconium, the ligand may selected from any ligand described herein and/or may be derived from a benzenedicarboxylate (BDC) ligand independently selected from the group consisting of BDC, BDC-Cl, BDC-Br, BDC-NH2, BDC-CH3, BDC—(OH)2, BDC—(CO2H)2 and BDC—(CF3)2, where BDC is 1,4-benzenedicarboxylate. Where the ring is disubstituted, for example disubstituted with —CF3, the substituents are provided in a para-arrangement (1,4-arrangement). Alternatively, each ligand is selected from a ligand shown below:

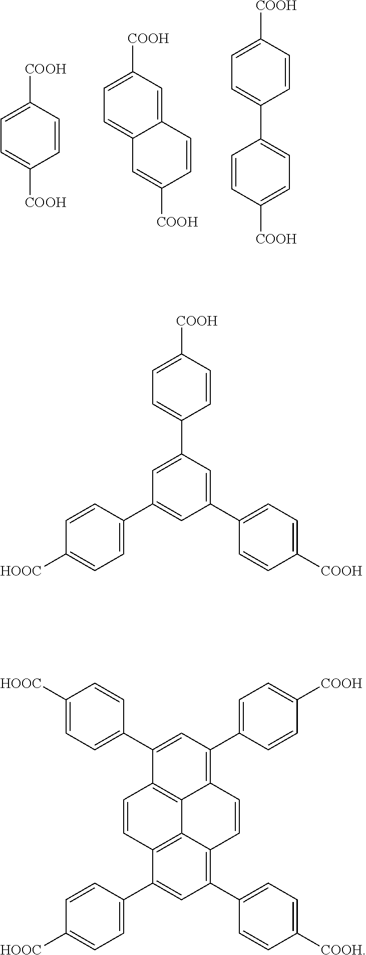

where an aryl group may be optionally further substituted with NH2, —NO2, —Cl, —Br, —COOH (or —COO<—>) or —CH3, or is optionally further disubstituted with —CF3, —CH3 or —OH, and the salt forms thereof.

In one embodiment, when the metal cluster/metal node comprises zirconium each ligand is selected from a ligand shown below:

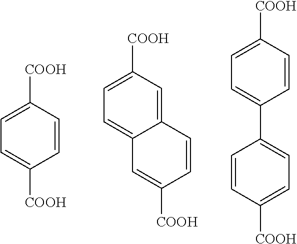

where an aryl group may be optionally further substituted with NH2, —NO2, —Cl, —Br. —COOH (or —COO<—>) or —CH3, or is optionally further disubstituted with —CF3, —CH3 or —OH, and the salt forms thereof.

In one embodiment, when the metal cluster/metal node comprises zirconium each ligand is selected from a ligand shown below:

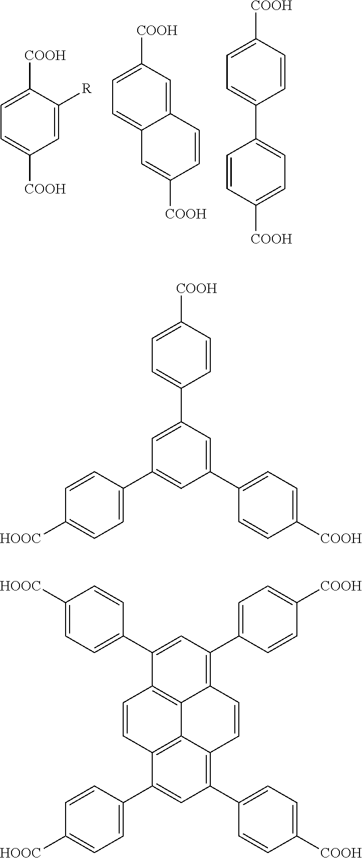

where R is selected from —H, —Br, —NO2, and —NH2, and the salt forms thereof.

In one embodiment, when the metal cluster/metal node comprises zirconium each ligand is selected from a ligand shown below:

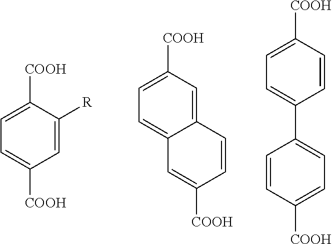

where R is selected from —H and —NH2, and the salt forms thereof.

In one embodiment, when the metal cluster/metal node comprises zirconium each ligand is selected from BDC, BPDC, TPDC, TBABy, PTBA, Py-XP, Por-PP, Py-PTP, Por-PTP, FUM, PZDC, BDC-20H, NDC-20H, BPDC-20H, BTC, MTB, TCPP. XF, TCPP, BPYDC, TPDC-2CH3, TPDC-4CH3, TPDC-2CH2-N3, TPDC-4CH2-N3, ETTC, TCP-1, TCP-2, TCP-3, MTBC, Me2BPDC, TATB, DTTDC, 2,6, NDC, TDC, FDCA, DTDAO, EDDB, Cl2ABDC, pgal, Hgal, Hdal, TzGal, TCBPP, BTB, TTMC, BTB, ABDC, PEDC, BPV, BPHV, PT, TPHN, H3BTBP, H3TTBMP, AN,1,4 NDC, ADC, DTDC, TCPS, or BTDC. These ligand acronyms are defined by the below structures:

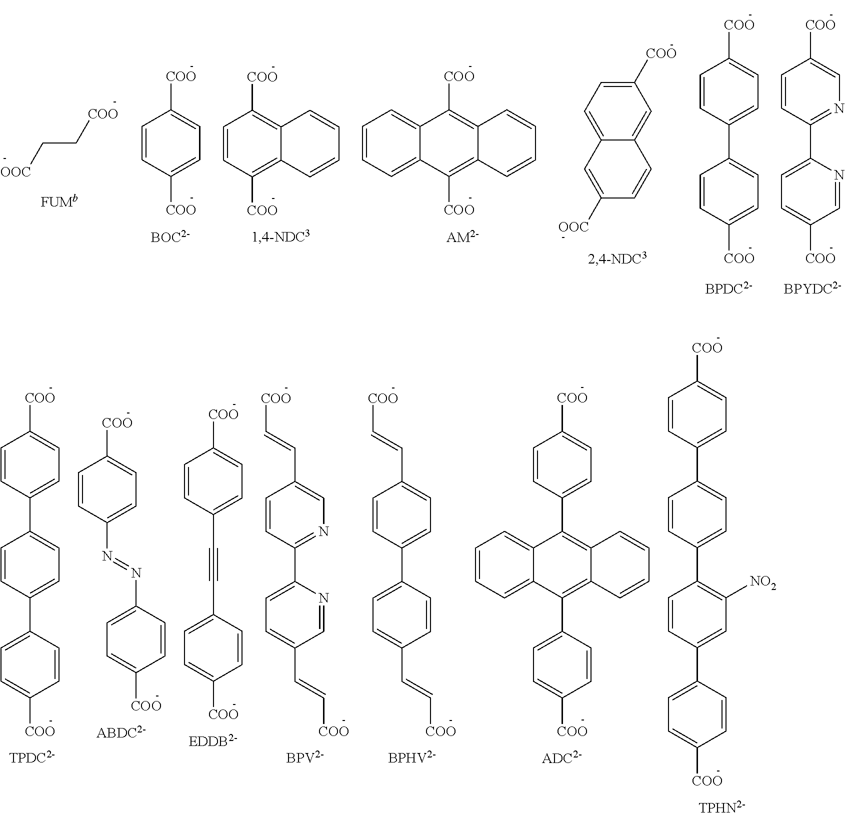

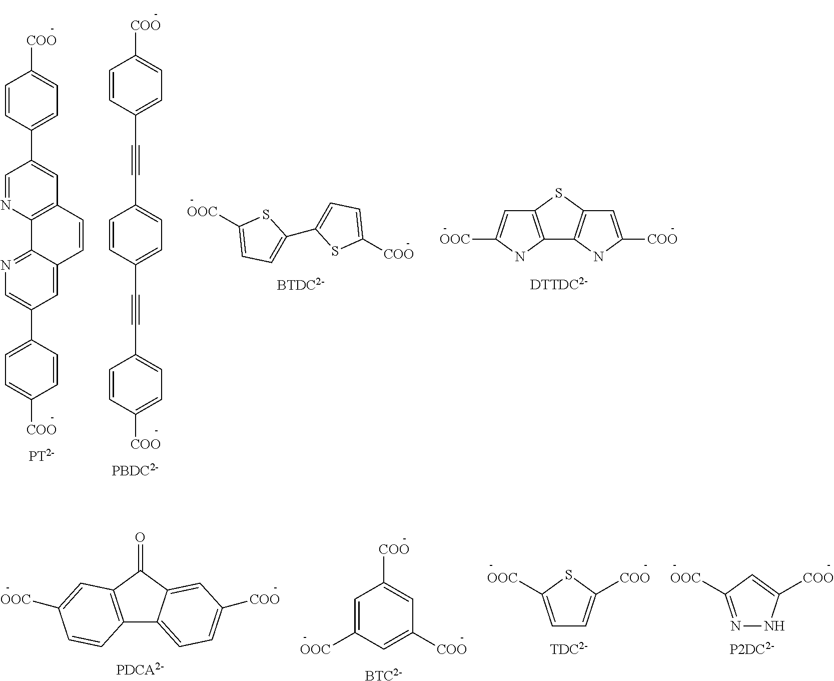

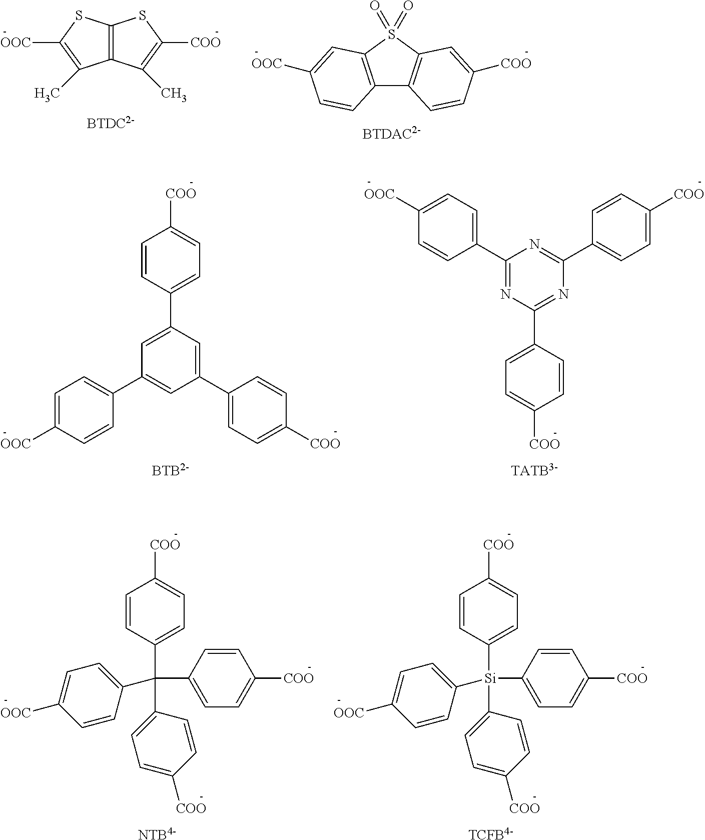

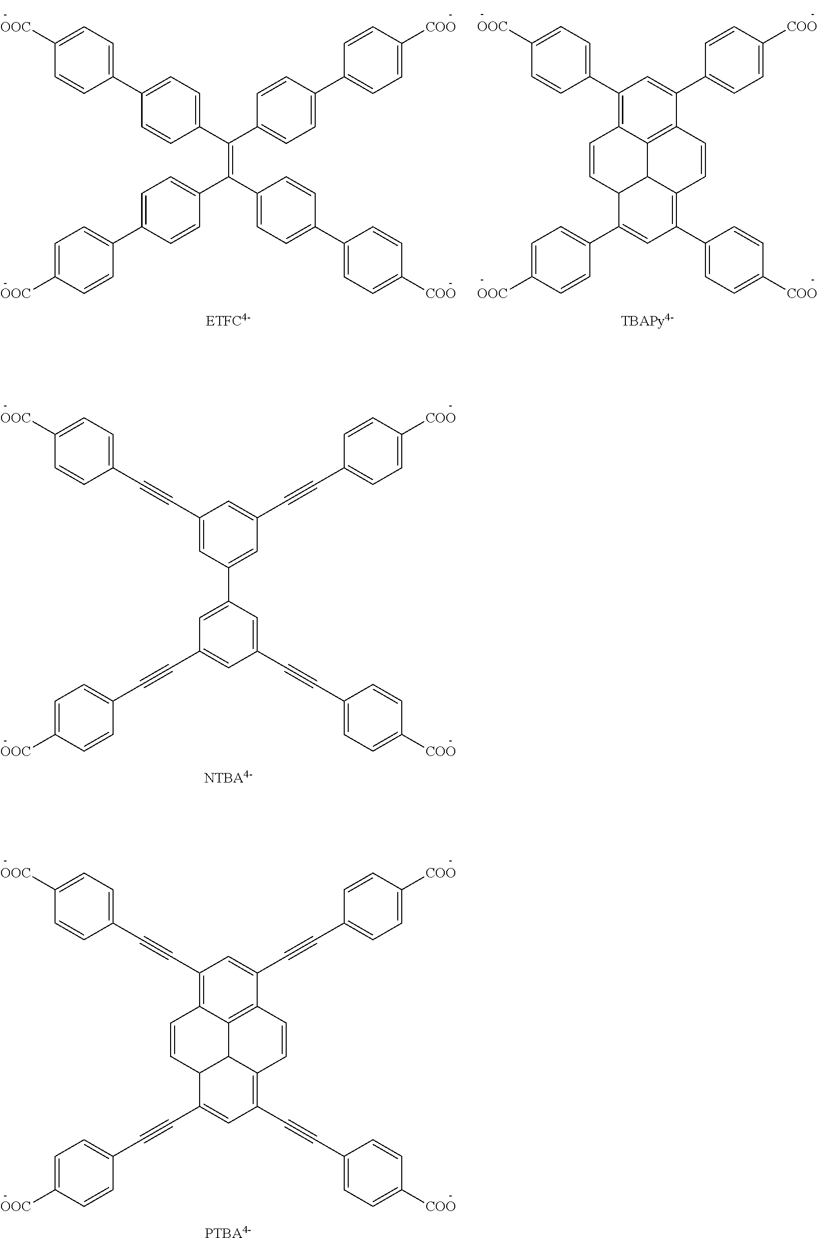

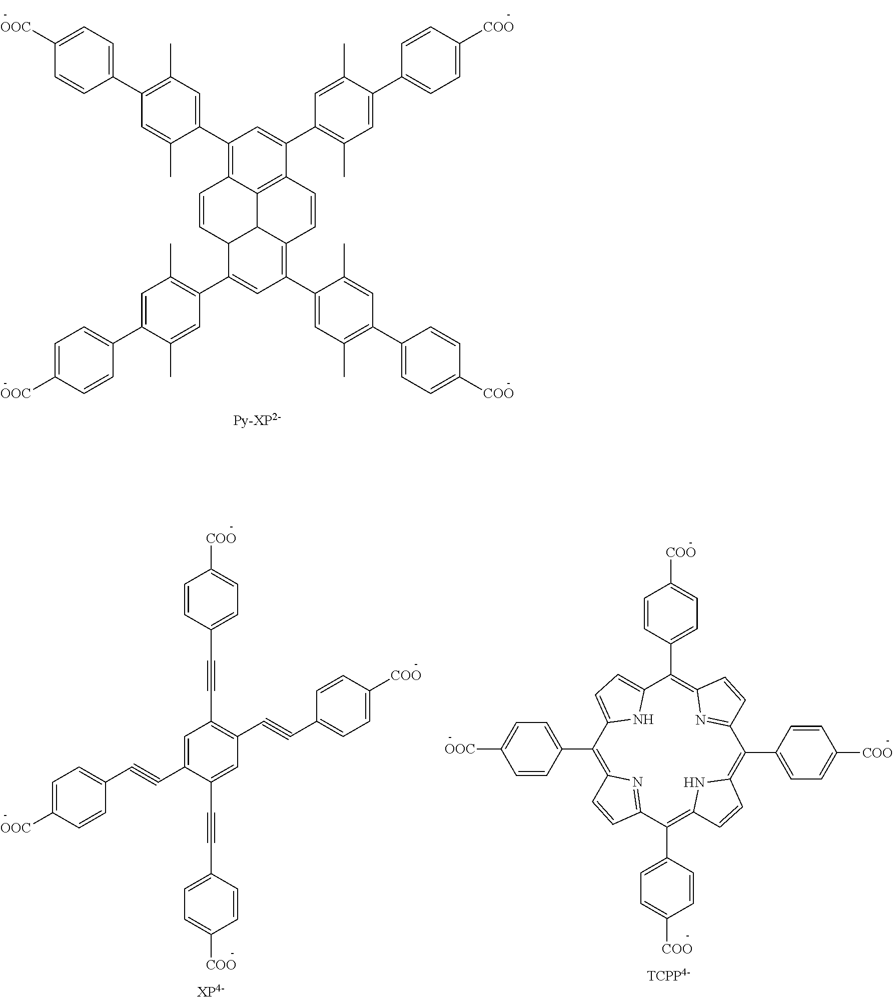

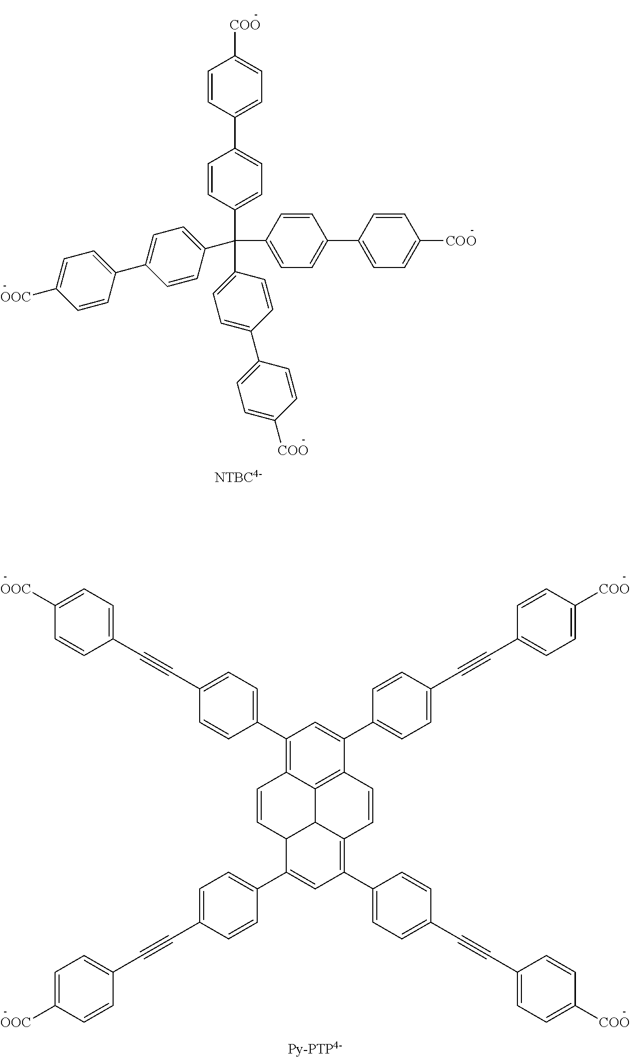

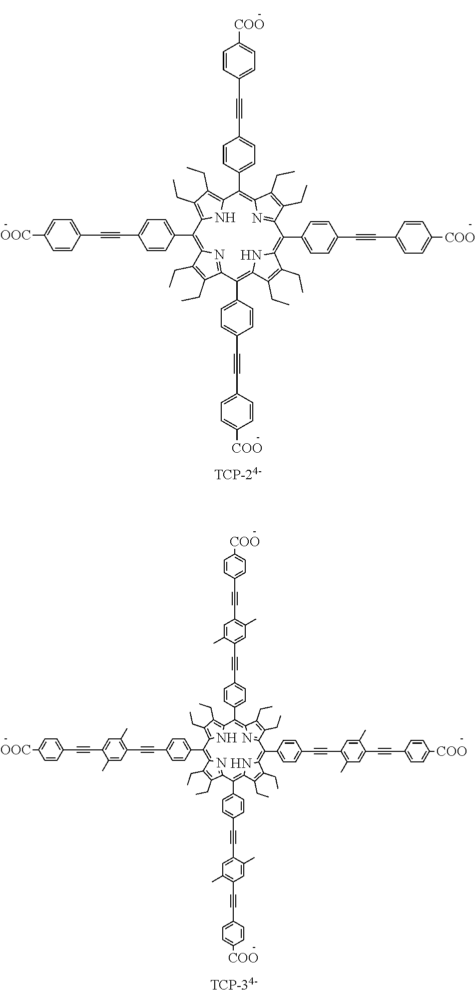

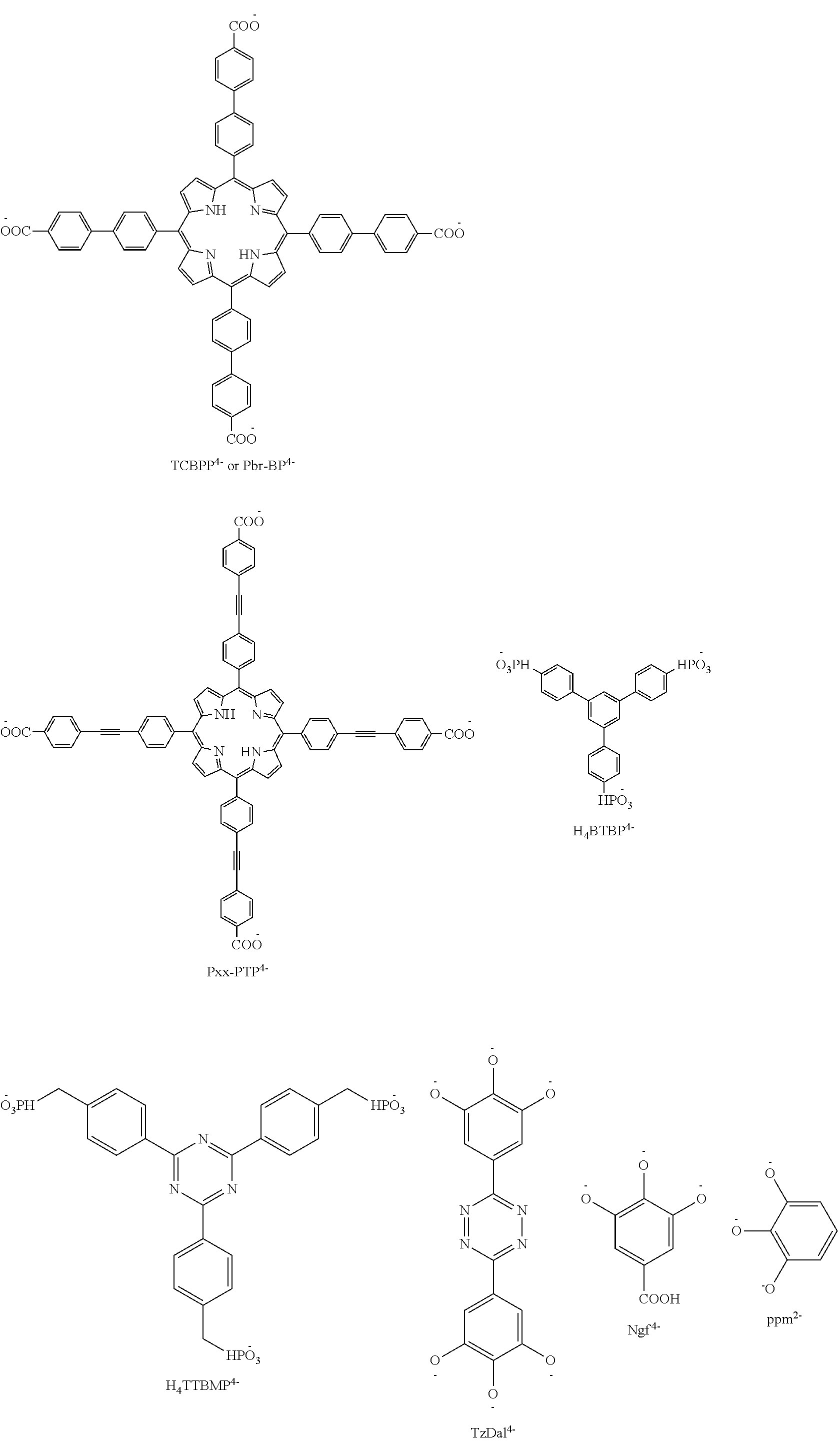

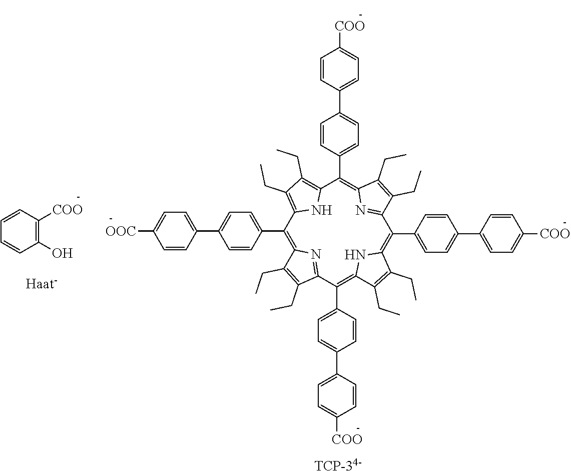

In one embodiment, the absorbent material contains amorphous metal organic framework that is greater than 75% amorphous. In one embodiment, the amorphous metal organic framework is greater than 85% amorphous. In one embodiment, the amorphous metal organic framework is greater than 95% amorphous. In one embodiment, the amorphous metal organic framework is greater than 99% amorphous. In one embodiment, the amorphous metal organic framework is 100% amorphous.

The absorbent material of the present disclosure exhibits high surface area. For example, the absorbent material has BET surface area greater than or equal to about 100 m²g⁻, 200 m²g⁻, 300 m²g⁻, 400 m²g⁻, 500 m²g⁻, 600 m²g⁻, 700 m²g⁻, 800 m²g⁻, 900 m²g⁻, 1000 m²g⁻, 1100 m²g⁻, or 1200 m²g⁻.

For example, the absorbent materials have BET surface area between about 100 and about 1200 m²g⁻, about 200 and about 1100 m²g⁻, about 200 and about 900 m²g⁻, about 200 and about 800 m²g⁻, about 300 and about 800 m²g⁻, or about 400 and about 800 m²g⁻.

For example, the absorbent materials have BET surface area greater than or equal to about 100 m²g⁻¹, 200 m²g⁻¹, 300 m²g⁻¹, 400 m²g⁻, or 500 m²g⁻.

For example, the absorbent materials have BET surface area between about 100 and about 600 m²g⁻, about 200 and about 600 m²g⁻, about 300 and about 600 m²g⁻, or about 200 and about 500 m²g⁻.

For example, the absorbent materials have BET surface area greater than or equal to about 200 m²g⁻¹, 300 m²g⁻¹, 400 m²g⁻¹, 500 m²g⁻¹, 600 m²g⁻¹, 700 m²g⁻¹, 800 m²g⁻¹, 900 m²g⁻¹, 1000 m²g⁻¹, 1100 m²g⁻, or 1200 m²g⁻.

For example, the absorbent materials have BET surface area between about 100 and about 1200 m²g⁻, about 200 and about 1200 m²g⁻, about 300 and about 1200 m²g⁻, about 400 and about 1200 m²g⁻, about 400 and about 1100 m²g⁻, or about 400 and about 1000 m²g⁻.

Additionally and/or alternatively, these absorbent materials exhibit high fluid uptake.

Additionally and/or alternatively, the absorbent materials exhibit high gas uptake.

Additionally and/or alternatively, the absorbent materials exhibit high liquid uptake.

In one embodiment, the fluid is a gas, for example nitrogen.

In one embodiment, the fluid is a hydrocarbon, for example methane.

In one embodiment, the fluid is an acid gas, for example hydrogen sulfide.

In one embodiment, the fluid is a sulfur containing liquid or gas, e.g. hydrogen sulfide.

In one embodiment, the fluid is a condensable liquid, for example water.

In one embodiment the fluid may be selected from:
(a) H₂, N₂, Ar, O₂, CO₂, NO, NO₂ or CO; or
(b) an alkane (C1-6), alkene (C2-4), alkyne (C2-6), alcohol (C1-6), arene (C6-8) or a substituted version of any of these;

wherein the alkane may be selected from CH₄, C₂H6, C₃H8, C₄H10, C₅H₁₂ or C₆H₁₄; or a cycloalkane (C3-6) selected from the group consisting of C₃H6, C₄H8, C₅H₁₀ and C₆H₁₄;

wherein the alkene may be C₂H4, C₃H6, C₄H8, C₅H₁₀ or C₆H₁₂;

wherein the alkyne may be C₂H2;

wherein the alcohol may be methanol, ethanol, n-propanol, isopropanol, n-butanol or isobutanol; or

wherein the arene may be a substituted arene (C6-8) such as is nitrobenzene, 1,2-dinitrobenzene, 1,3-dinitrobenzene, 1,4-dinitrobenzene, 1,2,4-trinitrobenzene or 1,3,5-trinitrobenzene.

In one embodiment, the gas may be selected from hydrogen, methane, carbon dioxide or nitrogen. For example, the gas may be nitrogen.

In one embodiment, the liquid may be water. In other embodiments, the liquid may be an aqueous solution. In at least some instances, the aqueous solution may include one or more contaminants. In such cases, the absorbent materials may absorb the aqueous solution and the one or more contaminants.

For example, the disclosure provides absorbent materials with gas uptake of greater than or equal to about 25 cm³g⁻¹, 50 cm³g⁻¹, 75 cm³g⁻¹, 100 cm³g⁻¹, 150 cm³g⁻¹, 200 cm³g⁻¹, 250 cm³g⁻, or 300 cm³g⁻¹ at standard temperature and pressure.

In one embodiment, the absorbent material comprises no metal organic framework on the surface of the substrate. In one embodiment, the absorbent material comprises no crystalline metal organic framework on the surface of the substrate. In one embodiment the metal organic framework is contained in the pores of the substrate.

Uses of Materials

In one aspect, the disclosure provides the use of an amorphous metal organic framework as defined herein for uptaking/absorbing a fluid, for example a gas or a liquid. In another aspect, the disclosure provides the use of an absorbent material as defined herein for uptaking/absorbing a fluid, for example a gas or a liquid.

In one embodiment, the fluid comprises molecules having a kinetic diameter between about 1.0 \acute{Å} and about 5.0 \acute{Å}, for example between about 1.5 \acute{Å} and about 4.5 \acute{Å}, for example between about 2.5 \acute{Å} and about 4.3 \acute{Å}, for example between about 2.6 \acute{Å} and about 3.8 \acute{Å}, for example between about 3.1 \acute{Å} and about 3.8 \acute{Å}.

In one embodiment, the fluid has a kinetic diameter greater than or equal to about 1.5 \acute{Å}, 2.0 \acute{Å}, 2.5 \acute{Å}, 3.0 \acute{Å}, 3.5 \acute{Å}, 4.0 \acute{Å}, 4.5 \acute{Å} or 5.0 \acute{Å}. In one embodiment, the fluid has a kinetic diameter greater than or equal to about 1.5 \acute{Å}, 2.6 \acute{Å}, 2.9 3.14 \acute{Å}, 3.3 \acute{Å}, 3.6 \acute{Å}, 3.7 \acute{Å}, 3.8 \acute{Å}, 3.9 \acute{Å} or 4.2 \acute{Å}.

In one embodiment, the fluid comprises molecules having a kinetic diameter between about 0.10 nm and about 0.50 nm, for example between about 0.15 nm and about 0.45 nm, for example between about 0.25 nm and about 0.43 nm, for example between about 0.26 nm and about 0.38 nm, for example between about 0.31 nm and about 0.38 nm.

In one embodiment, the fluid has a kinetic diameter greater than or equal to about 0.15 nm, 0.20 nm, 0.25 nm, 0.30 nm, 0.35 nm, 0.40 nm, 0.45 nm or 0.50 nm. In one embodiment, the fluid has a kinetic diameter greater than or equal to about 0.15 nm, 0.26 nm, 0.29 nm, 0.314 nm, 0.33 nm, 0.36 nm, 0.37 nm, 0.38 nm, 0.39 nm or 0.42 nm.

In one embodiment, the fluid is a gas. In one embodiment, the gas is nitrogen. In one embodiment, the gas is hydrogen, helium, methane, ammonia, neon, hydrogen cyanide, carbon monoxide, nitrogen oxide, ethane, oxygen, phosphine, hydrogen sulfide, hydrogen chloride, fluorine, argon, carbon dioxide, dinitrogen so oxide, propane, nitrogen dioxide, ozone, butane, sulfur dioxide, boron trifluoride, chlorine, krypton, dichlorodifluoromethane, sulfur hexafluoride, or xenon. In one embodiment, the gas is a condensable C1 to C30 hydrocarbon or polar organic compound.

In one embodiment, the fluid is a sulfur containing liquid or gas. For example, the sulfur containing fluid may be hydrogen sulphide or a sulfur oxide gas such as sulfur monoxide, sulfur dioxide, sulfur trioxide, disulfur monoxide or disulfur dioxide.

In one embodiment, the fluid is an acidic gas. For example, the acidic gas may be nitric oxide, nitrogen dioxide or hydrochloric acid.

In one embodiment, the fluid is a liquid. 25 In one embodiment, the liquid is a condensed gas. In one embodiment, the condensed gas is a diatomic condensed gas, for example nitrogen. In one embodiment, the condensed gas is hydrogen, helium, methane, ammonia, neon, hydrogen cyanide, carbon monoxide, nitrogen oxide, ethane, oxygen, phosphine, hydrogen sulfide, hydrogen chloride, fluorine, argon, carbon dioxide, dinitrogen oxide, propane, nitrogen dioxide, ozone, butane, sulfur dioxide, boron trifluoride, chlorine, krypton, dichlorodifluoromethane, sulfur hexafluoride, or xenon. In one embodiment, the condensed gas is a condensable C1 to C30 hydrocarbon or polar organic compound. In one embodiment, the condensed gas is a sulfur containing condensed gas, for example hydrogen sulfide.

In one embodiment, the liquid is water. In other embodiments, the liquid may be an aqueous solution. In at least some instances, the aqueous solution may include one or more contaminants. In such cases, the absorbent material may absorb the aqueous solution and the one or more contaminants.

In one embodiment, the fluid is a hydrocarbon. The hydrocarbon may be a gas or a liquid. In one embodiment, the hydrocarbon is a C1 to C30 hydrocarbon, for example methane.

In one embodiment, the disclosure provides the use of an amorphous metal organic framework as defined herein or an absorbent material as defined hereinfor removing compounds from fluids. In one embodiment, the compound is a hydrocarbon fluid. In one embodiment, the hydrocarbon fluid is an alkane, alkene, alkyne, diene, cycloalkane, cycloalkene, arene, terpene, ketone, furan, alcohol, amine, or thiol. In one embodiment, the compound is a sulfur-containing compound. In one embodiment, the sulfur-containing compound is hydrogen sulfide, sulfur dioxide, carbonyl sulfide, a thiophene, a thiol, a thiazole, a thiane, a thiazine, a thiopyran, a thiocane, a thiophenol, or a thiocarboxylic acid.

In one embodiment, the amorphous metal organic framework or absorbent material is subsequently purged of absorbed molecules, for example by washing with an acidic solution, allowing the substrate comprising metal coordination polymer to be regenerated and reused more than once, e.g. multiple times.

A method of absorbing a fluid from a stream of fluids, the method comprising: (i) providing an amorphous metal organic framework or absorbent material as described herein; and (ii) contacting the amorphous metal organic framework or absorbent material with a stream of fluid(s) to selectively remove a fluid component from the stream of fluid(s).

In one embodiment, the fluid is nitrogen. In one embodiment, the fluid is water. In other embodiments, the liquid may be an aqueous solution. In at least some instances, the aqueous solution may include one or more contaminants.

The metal-organic frameworks and absorbent materials according to the disclosure have a wide range of applications.

According to one aspect, the disclosure provides a method comprising uptaking at least one substance by a metal-organic framework or an absorbent material of the present disclosure.

For example, the substance may be nitrogen or water.

According to one aspect, the disclosure provides a method of storing a gas in a metal-organic framework or an absorbent material according to the present disclosure. Alternatively, the disclosure provides the use of a metal-organic framework or an absorbent material according to any embodiment of the present disclosure for storing a gas. This may be achieved by binding the gas in a plurality of linker channel sites present in the metal-organic framework, for example using van der Waals forces.

The use/method of storing gases in this way may optimise gas storage density and volumetric gas storage.

In a further aspect, the present disclosure provides the use of any metal-organic framework or absorbent material according to the disclosure for adsorbing a guest molecule, for example a gas molecule such as nitrogen. In this respect, the disclosure also provides a method of adsorbing a guest molecule, for example a gas molecule such as nitrogen, comprising contacting a metal-organic framework or absorbent material of the disclosure with a guest molecule source.

Accordingly, the disclosure also provides a metal-organic framework or an absorbent material according to any embodiment of the present disclosure, further comprising one or more than one type of guest molecule.

The guest molecule may be a fluid, e.g. a gas or a liquid.

The guest molecule may be selected from:
(a) H₂, N₂, Ar, O₂, CO₂, NO, NO₂ or CO; or
(b) an alkane (C1-6), alkene (C2-4), alkyne (C2-6), alcohol (C1-6), arene (C6-8) or a substituted version of any of these;

wherein the alkane may be selected from CH₄, C₂H6, C₃H8, C₄H₁₀, C₅H₁₂ or C₆H₁₄; or a cycloalkane (C3-6) selected from the group consisting of C₃H6, C₄H8, C₅H₁₀ and C₆H₁₄;

wherein the alkene may be C₂H4, C₃H₆, C₄H₈, C₅H₁₀ or C₆H₁₂;

wherein the alkyne may be C₂H2;

wherein the alcohol may be methanol, ethanol, n-propanol, isopropanol, n-butanol or isobutanol; or so wherein the arene may be a substituted arene (C6-8) such as is nitrobenzene, 1,2-dinitrobenzene, 1,3-dinitrobenzene, 1,4-dinitrobenzene, 1,2,4-trinitrobenzene or 1,3,5-trinitrobenzene.

In one embodiment, the guest molecule is selected from hydrogen, methane, carbon dioxide or nitrogen. For example, the guest molecule may be nitrogen.

In one embodiment, the guest molecule is water. In other embodiments, the guest molecule may be an aqueous solution.

In aspect, the disclosure provides the use of an amorphous metal organic framework as defined herein or an absorbent material as defined herein as a catalyst or catalyst support.

In one aspect, the disclosure provides a system for removing sulfur-containing compounds from hydrocarbon fluids, the system comprising an amorphous metal organic framework as defined herein or an absorbent material as defined herein. In one embodiment, the sulfur-containing compound comprises hydrogen sulfide. In one embodiment, the system comprises an inlet that is fluidly-coupled to a source of the hydrocarbon fluid.

Synthesis Process

It has been found that the processes described herein allow the preparation of amorphous metal organic frameworks and absorbent materials comprising a porous substrate and an amorphous metal organic framework that have not previously been possible. That is, the processes allow the preparation of new and useful metal organic framework materials.

However, alternative methods of synthesis and optimized synthesis processes can be used within the method defined herein. This present disclosure details the general synthesis process for the metal organic framework known as PCN-250. Iron and aluminium metal organic frameworks are identified, but the same inventive concept and process can be used for other metal organic framework materials, including optimized and alternative methods of synthesizing the PCN-250, PCN-250 using alternative metals, as well as other nano-structures of different metals and ligands such as MIL-125 and MIL-100.

In one aspect, the disclosure provides a process producing an amorphous metal organic framework comprising the steps of contacting a reaction mixture comprising a metal source, a ligand precursor, a solvent and optionally an acid with a porous substrate; and subsequently removing a liquid component from the substrate.

In one aspect, the disclosure provides a process producing an absorbent material comprising a substrate and an amorphous metal organic framework comprising the steps of contacting a reaction mixture comprising a metal source, a ligand precursor, a solvent and optionally an acid with a porous substrate; and subsequently removing a liquid component from the substrate.

In one embodiment, the reaction mixture comprises or consists of a liquid component and solid component. The solid component may be partially or fully dissolved/suspended/dispersed in the liquid component. The liquid component may comprise partially or fully unreacted components of the reaction mixture. The partially or fully unreacted components may be selected from the metal source, the ligand precursor, the solvent, the optional acid and any other components of the reaction mixture described herein.

In one embodiment, the metal source is a metal salt. In one embodiment, the metal source is a metal alkoxide, for example a metal C₁-C₂₀ alkoxide.

Preparation of Reaction Mixture

The reaction mixture may be prepared by mixing a ligand precursor with a metal source in the presence of a solvent and optionally an acid.

In one embodiment, the ligand precursor is any compound that provides a ligand. In one embodiment, the ligand precursor is a compound that during synthesis of the metal organic framework provides the ligand. In one embodiment, the ligand precursor is one or more ligand precursors. Each of the one or more ligand precursors may be the same or different.

In one embodiment, the one or more ligand precursors have two or more carboxylate groups. In one embodiment, the one or more ligand precursors have three or more carboxylate groups. In one embodiment, the one or more ligand precursors have four or more carboxylate groups.

For example, a ligand precursor may be a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino(diphenyl ether)diimidedicarboxylic acid, 4,4′-diaminodiphenylmethanediimidedicarboxylic acid, 4,4′-diamino(diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbomane-2,3-dicarboxylic acid, 5-ethyl-2,3-pyridinedicarboxylic acid or camphordicarboxylic acid.

For example, a ligand precursor may be a tricarboxylic acid, such as for instance 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

For example, a ligand precursor may be a tetracarboxylic acid, such as, for instance, 1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, 3,3′,5,5′-tetracarboxydiphenylmethane or cyclopentanetetracarboxylic acids such as cyclopentane-1,2,3,4-tetracarboxylic acid.

The ligand precursor may also be a carboxylic acid selected from compounds of formula L1 to L30 and combinations thereof:

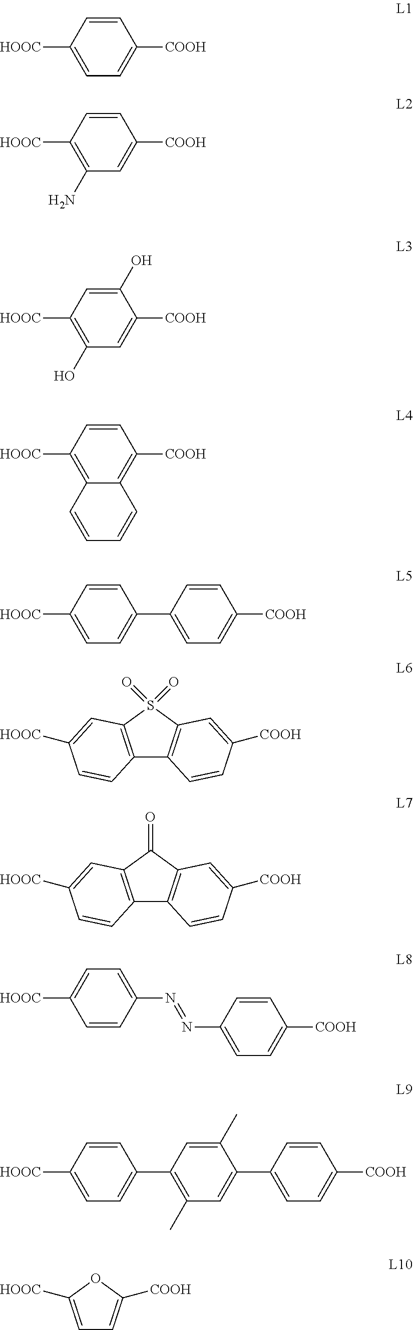

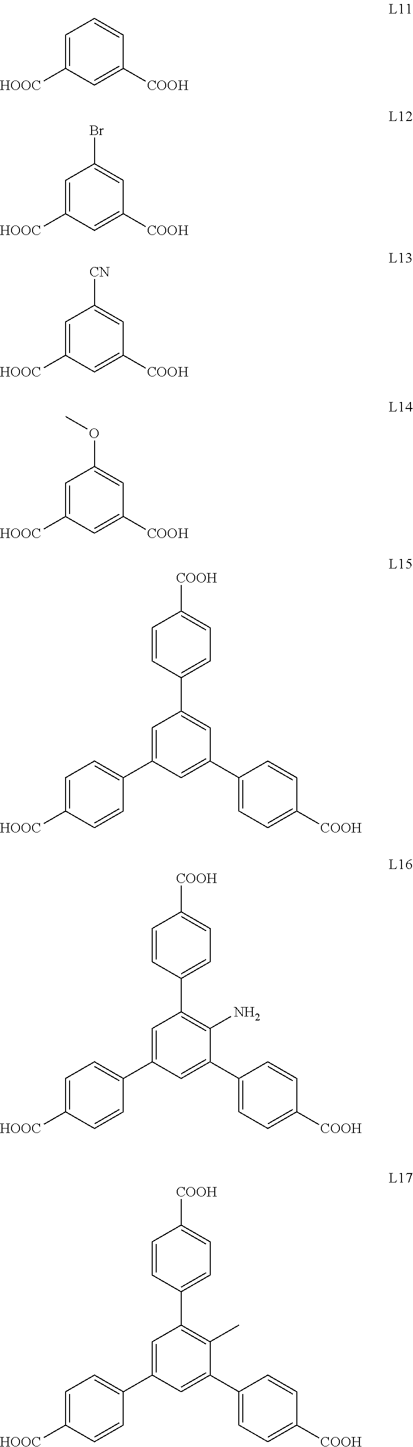

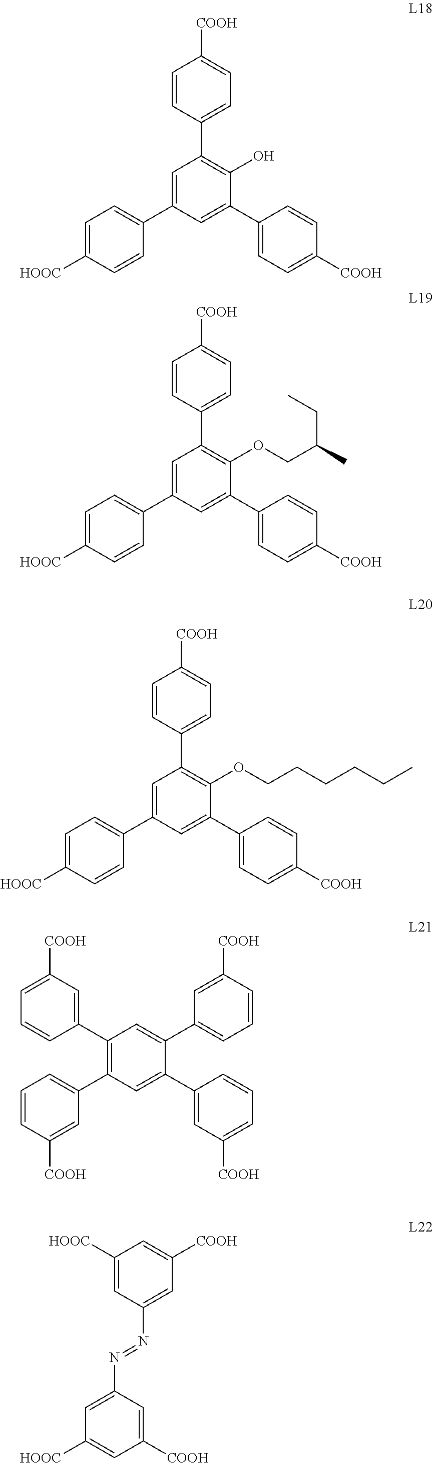 [SMILES: O=C(O)c1ccc(-c2cc(-c3ccc(C(=O)O)cc3)c(O)c(-c3ccc(C(=O)O)cc3)c2)cc1 ; CC[C@@H](C)COc1c(-c2ccc(C(=O)O)cc2)cc(-c2ccc(C(=O)O)cc2)cc1-c1ccc(C(=O)O)cc1 ; CCCCCCOc1c(-c2ccc(C(=O)O)cc2)cc(-c2ccc(C(=O)O)cc2)cc1-c1ccc(C(=O)O)cc1 ; O=C(O)c1cccc(-c2cc(-c3cccc(C(=O)O)c3)c(-c3cccc(C(=O)O)c3)cc2-c2cccc(C(=O)O)c2)c1 ; O=C(O)c1cc(/N=N/c2cc(C(=O)O)cc(C(=O)O)c2)cc(C(=O)O)c1]

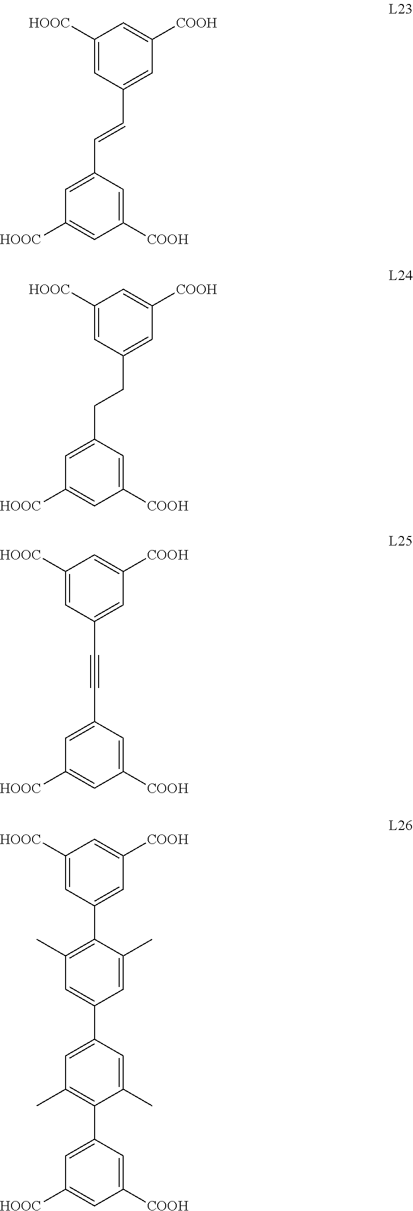 [SMILES: O=C(O)c1cc(/C=C/c2cc(C(=O)O)cc(C(=O)O)c2)cc(C(=O)O)c1 ; O=C(O)c1cc(CCc2cc(C(=O)O)cc(C(=O)O)c2)cc(C(=O)O)c1 ; O=C(O)c1cc(C#Cc2cc(C(=O)O)cc(C(=O)O)c2)cc(C(=O)O)c1 ; Cc1cc(-c2cc(C)c(-c3cc(C(=O)O)cc(C(=O)O)c3)c(C)c2)cc(C)c1-c1cc(C(=O)O)cc(C(=O)O)c1]

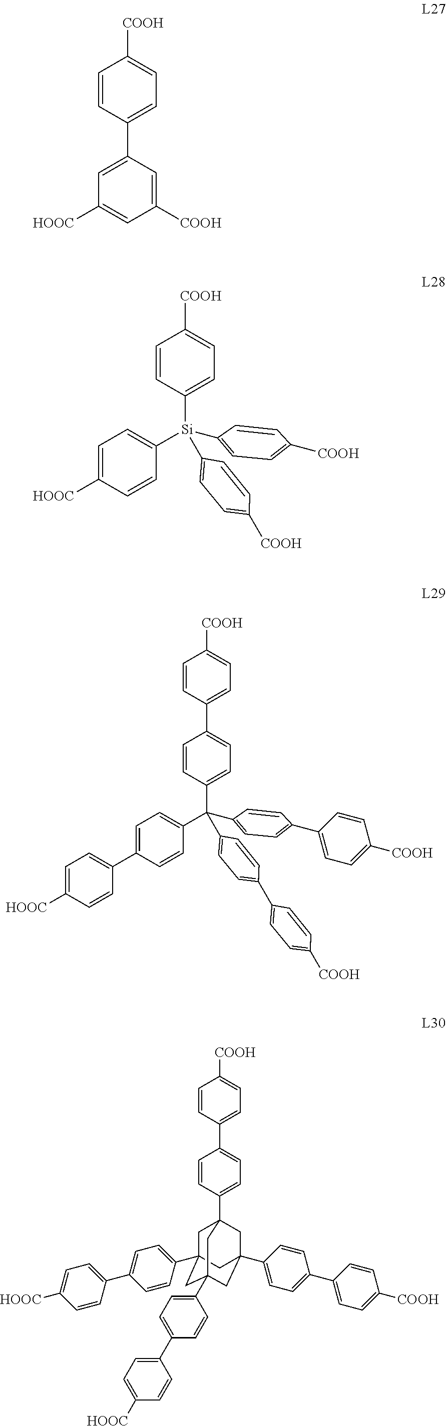 [SMILES: O=C(O)c1ccc(-c2cc(C(=O)O)cc(C(=O)O)c2)cc1 ; O=C(O)c1ccc([Si](c2ccc(C(=O)O)cc2)(c2ccc(C(=O)O)cc2)c2ccc(C(=O)O)cc2)cc1 ; O=C(O)c1ccc(-c2ccc(C(c3ccc(-c4ccc(C(=O)O)cc4)cc3)(c3ccc(-c4ccc(C(=O)O)cc4)cc3)c3ccc(-c4ccc(C(=O)O)cc4)cc3)cc2)cc1 ; O=C(O)c1ccc(-c2ccc(C34CC5(c6ccc(-c7ccc(C(=O)O)cc7)cc6)CC(c6ccc(-c7ccc(C(=O)O)cc7)cc6)(C3)CC(c3ccc(-c6ccc(C(=O)O)cc6)cc3)(C4)C5)cc2)cc1]

Specific combinations of ligand precursors include ligands derived from L31 and L32:

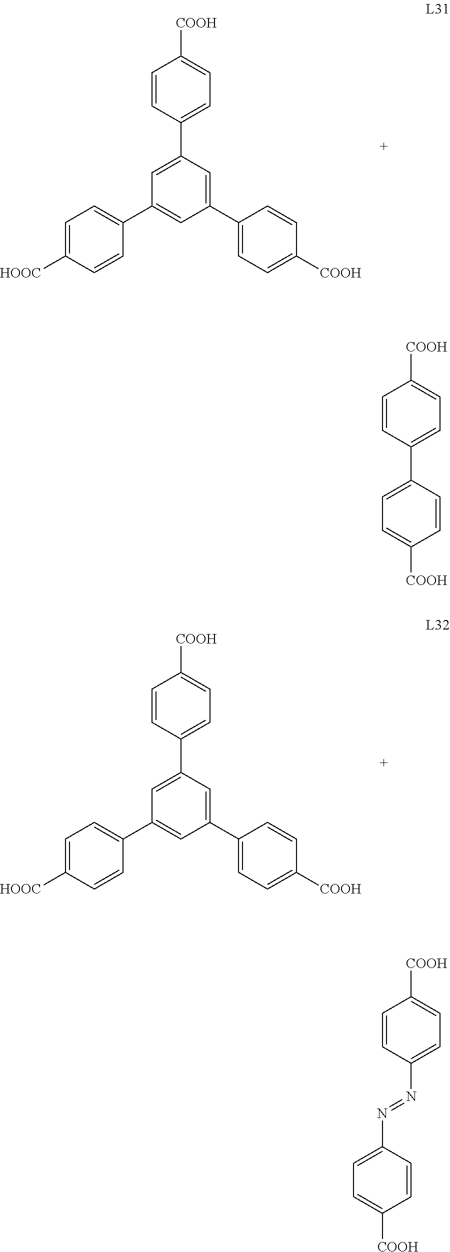 [SMILES: O=C(O)c1ccc(-c2cc(-c3ccc(C(=O)O)cc3)cc(-c3ccc(C(=O)O)cc3)c2)cc1 ; O=C(O)c1ccc(-c2ccc(C(=O)O)cc2)cc1 ; O=C(O)c1ccc(-c2cc(-c3ccc(C(=O)O)cc3)cc(-c3ccc(C(=O)O)cc3)c2)cc1 ; O=C(O)c1ccc(/N=N/c2ccc(C(=O)O)cc2)cc1]

Alternatively, the ligand precursor may be a carboxylic acid selected from the following compounds or combinations thereof:

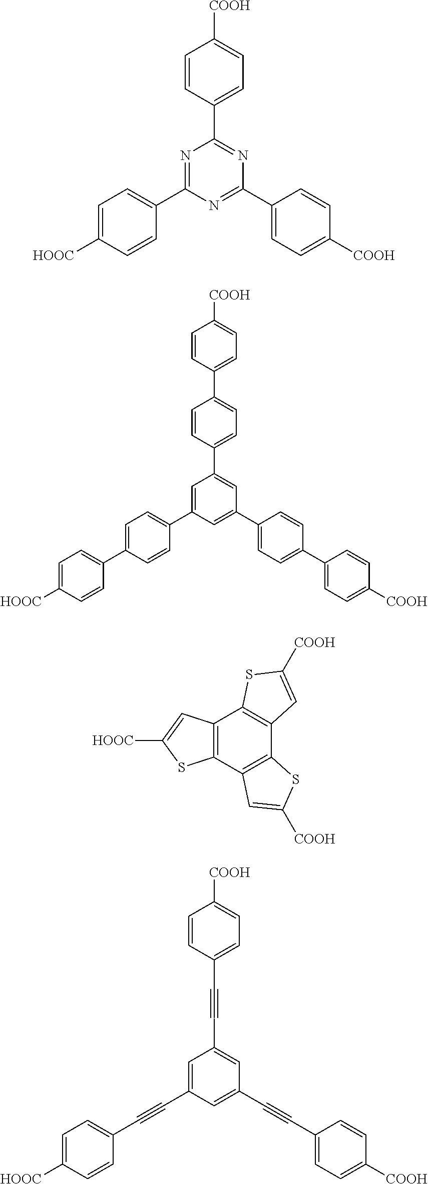 [SMILES: O=C(O)c1ccc(-c2nc(-c3ccc(C(=O)O)cc3)nc(-c3ccc(C(=O)O)cc3)n2)cc1 ; O=C(O)c1ccc(-c2ccc(-c3cc(-c4ccc(-c5ccc(C(=O)O)cc5)cc4)cc(-c4ccc(-c5ccc(C(=O)O)cc5)cc4)c3)cc2)cc1 ; O=C(O)c1cc2c(s1)c1cc(C(=O)O)sc1c1cc(C(=O)O)sc21 ; O=C(O)c1ccc(C#Cc2cc(C#Cc3ccc(C(=O)O)cc3)cc(C#Cc3ccc(C(=O)O)cc3)c2)cc1]

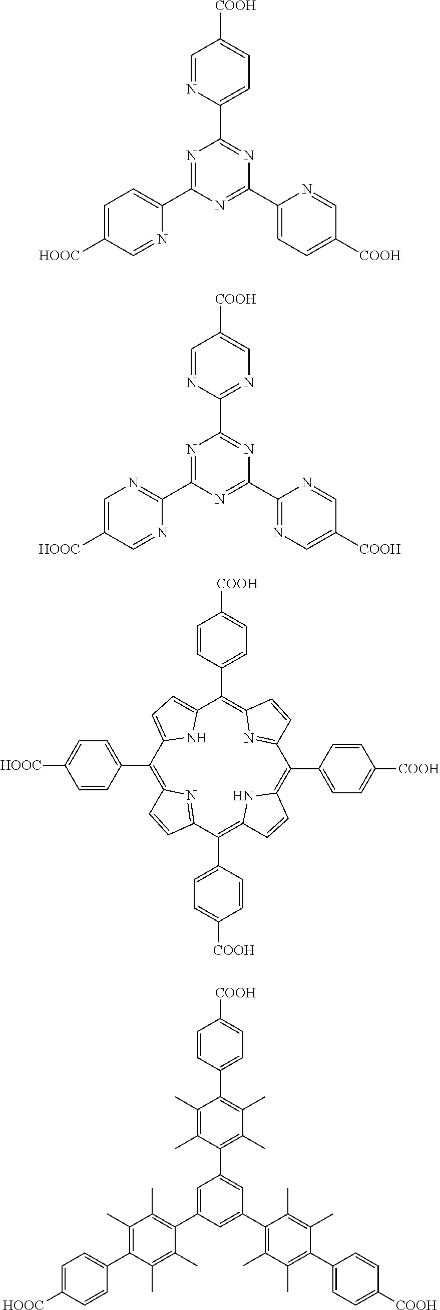 [SMILES: O=C(O)c1ccc(-c2nc(-c3ccc(C(=O)O)cn3)nc(-c3ccc(C(=O)O)cn3)n2)nc1 ; O=C(O)c1cnc(-c2nc(-c3ncc(C(=O)O)cn3)nc(-c3ncc(C(=O)O)cn3)n2)nc1 ; O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1 ; Cc1c(C)c(-c2cc(-c3c(C)c(C)c(-c4ccc(C(=O)O)cc4)c(C)c3C)cc(-c3c(C)c(C)c(-c4ccc(C(=O)O)cc4)c(C)c3C)c2)c(C)c(C)c1-c1ccc(C(=O)O)cc1]

In one embodiment, the ligand precursor is selected from a tetracarboxylic acid. In one embodiment, the ligand precursor is ABTC (3,3′,5,5′ azobenzene tetracarboxylic acid (L22)).

The metal source employed in the process corresponds to the metal ion contained in the metal cluster/metal node of the resulting metal organic framework. For example, in a process for preparing an amorphous iron metal organic framework, an iron metal source is employed in the process. Likewise, in a process for preparing an amorphous aluminium metal organic framework, an aluminium metal source is employed in the process. Likewise, in a process for preparing an amorphous titanium metal organic framework, a titanium metal source is employed in the process. Likewise, in a process for preparing an amorphous zirconium metal organic framework, a zirconium metal source is employed in the process; and so on.

In one embodiment, the metal source is a source comprising Al, Fe, Cr, Ti, or Zr.

In one embodiment, the metal source is a metal salt. Suitable metal salts include but are not limited to a metal chloride, metal sulphate, metal nitrate, metal carbonate, metal acetate, metal phosphate. In one embodiment, the metal salt is a metal chloride, metal sulphate, metal nitrate, metal carbonate, metal acetate, metal phosphate, wherein the metal is selected from Al, Fe, Cr, Ti, or Zr. In one embodiment, the metal salt is aluminium chloride, iron nitrate, titanium chloride, or zirconium chloride.

In one embodiment, the metal source is a metal alkoxide, for example a metal C₁-C₂₀ alkoxide. In one embodiment, the metal alkoxide is a metal C₁-C₂₀ alkoxide wherein the metal is selected from Al, Fe, Cr, Ti, or Zr. In one embodiment, the metal alkoxide is titanium ethoxide, titanium butoxide, titanium n-propoxide or titanium (IV) isopropoxide.

A metal alkoxide may be a metal ion coordinated with one or more alkoxide moieties. For example, a metal C₁-C₂₀ alkoxide may be a metal ion coordinated with one or more C₁-C₂₀ alkoxide moieties. A metal alkoxide may also be two or more metal ions coordinated with two or more alkoxide moieties. For example, a metal alkoxide may be two, three or four metal ions coordinated with two or more alkoxide moieties. For example, a metal alkoxide may be a complex, ring structure, cage, polymer or aggregate of two or more metal ions with two or more alkoxide moieties. Each metal in the metal alkoxide may be the same or different. An alkoxide may comprise other moieties in addition to the metal ion(s) and one or more alkoxide moieties.

An alkoxide moiety may be a conjugate base of an alcohol, for example a C₁-C₂₀ alcohol. An alkoxide moiety may have the formula RO⁻, wherein R is a primary, secondary or tertiary alkyl group. R may be a C₁-C₂₀ alkyl group, for example a C₁-C₂₀ alkyl group, a C₁-C₁₀ alkyl group, a C₁-C₈ alkyl group, a C₁-C₅ alkyl group, or a C₁-C₃ alkyl group. In one embodiment, employed to prepare an amorphous iron metal organic framework, the metal (iron) source is an iron salt, for example iron nitrate.

In one embodiment, employed to prepare an amorphous aluminium metal organic framework, the metal (aluminium) source is an aluminium salt, for example aluminium chloride.

In one embodiment, employed to prepare a titanium amorphous metal organic framework, the metal (titanium) source is a titanium alkoxide, for example titanium (IV) isopropoxide. Other suitable metal (titanium) sources include but are not limited to TiCl₄, TiO(acac)₂, TiOSO₄ (titanyl sulfate), and Ti(SO₄)₂.

In one embodiment, employed to prepare a zirconium amorphous metal organic framework, the metal (zirconium) source is a zirconium salt, for example zirconium chloride (ZrCl₄).

A metal alkoxide may have more than one alkoxide moiety, for example one, two, three, four, or five alkoxide moieties. The combined charge of the alkoxide moieties may equal the charge on the metal ion. For example, when the metal ion has a 4+ charge, the metal alkoxide may comprise four 1-charged alkoxide moieties. For example, titanium (IV) isopropoxide comprises one titanium 4+ ion and four isopropoxide 1-moieties.

In one embodiment the ratio of ligand to metal source in the metal coordination precursor solution is 1:1 to 1:5. In one embodiment the ratio of ligand to metal source in the metal coordination precursor solution is 1:2 to 1:4. In one embodiment the ratio of ligand to metal source in the metal coordination precursor solution is 1:2 or 1:3.

In one embodiment, the solvent is a single solvent. In one embodiment, the solvent is a combination of two or more solvents. In one embodiment the solvent is a mixture of solvents. In one embodiment, each solvent may be individually selected from polar solvents, non-polar solvents, protic solvents, aprotic solvents. In one embodiment, each solvent may be an organic solvent or an inorganic solvent. In one embodiment, each solvent may be selected from acetic acid, water, DMF, DEF, NMP, DMSO, DMA isopropanol, acetone, 1,2,-dichloroethane, methylene chloride, carbon tetrachloride, tetrahydrofuran, dimethylformamide, dimethylsulfoxide, ethanolamine, triethylamine, ethylenediamine, and n-alcohols such as methanol, ethanol, and n-propanol. In one embodiment, each solvent may be selected from acetic acid and/or DMF.

In one embodiment, the metal source and ligand precursor are added to the solvent. In one embodiment, the solvent is added to the metal source and ligand precursor. In one embodiment, the solvent is added to the metal source and the ligand precursor is then added to the resulting mixture. In one embodiment, the solvent is added to the ligand precursor and the metal source is then added to the resulting mixture.

In one embodiment, the reaction mixture optionally comprises an acid. In one embodiment, the reaction mixture comprises an acid.

In one embodiment, the acid is selected from is trifluoroacetic acid, benzoic acid, formic acid, propionic acid, sodium acetate, and acetic acid. In one embodiment, the acid is acetic acid.

In one embodiment, the reaction mixture does not comprise an acid selected from trifluoroacetic acid, benzoic acid, formic acid, propionic acid, sodium acetate, and acetic acid.

In one embodiment, when the metal source is a titanium metal source the reaction mixture does not comprise an acid selected from trifluoroacetic acid, benzoic acid, formic acid, propionic acid, sodium acetate, and acetic acid.

In one embodiment, the reaction mixture further comprises dissolved metal organic framework.

In one embodiment, the reaction mixture is virgin synthesis fluid or is recovered synthesis fluid. In one embodiment, the virgin synthesis fluid is a reaction mixture that so has not undergone increased temperature or pressure treatment. In one embodiment, the recovered synthesis fluid is a fluid that is recovered from a process of preparing crystalline metal organic framework. In one embodiment, the recovered synthesis fluid comprises a ligand precursor, a metal source, and a solvent. In one embodiment, the recovered synthesis fluid comprises a ligand precursor, a metal source, a solvent, a metal organic framework and optionally an acid. In one embodiment, the metal organic framework is crystalline or amorphous.

Once the reaction mixture is prepared, the process comprises the step of contacting the reaction mixture comprising a metal source, a ligand precursor a solvent and optionally an acid with a porous substrate.

In one embodiment, contacting the reaction mixture with a porous substrate comprises impregnating the substrate with the reaction mixture. In one embodiment the porous substrate is impregnated by adding the porous substrate to the reaction mixture. In one embodiment the porous substrate is impregnated by adding the reaction mixture to the substrate.

In one embodiment, the porous substrate is contacted with the reaction mixture immediately after the reaction mixture is prepared. In one embodiment, the porous substrate is contacted with the reaction mixture between 1 and 60 minutes after the reaction mixture is prepared. In one embodiment, the porous substrate is contacted with the reaction mixture over 60 minutes after the reaction mixture is prepared.

In one embodiment, the porous substrate is soaked in the reaction mixture. In one embodiment, the porous substrate is soaked for a sufficient time to allow for the reaction mixture to permeate the porous substrate. In one embodiment, the porous substrate is soaked for at least about 1 minute. In one embodiment, the porous substrate is soaked for at least about 2 minutes. In one embodiment, the porous substrate is soaked for at least about 5 minutes.

In one embodiment, the porous substrate is soaked in the reaction mixture for up to 60 minutes. In one embodiment, the porous substrate is soaked in the reaction mixture for up to 120 minutes. In one embodiment, the porous substrate is soaked in the reaction mixture for up to 180 minutes. In one embodiment, the porous substrate is soaked in the reaction mixture for up to 240 minutes. In one embodiment, the porous substrate is so soaked in the reaction mixture for up to 300 minutes. In one embodiment, the porous substrate is soaked in the reaction mixture for up to 360 minutes.

In one embodiment, contacting the reaction mixture with a porous substrate is carried out between about 1 bar and about 150 bar. In one embodiment, contacting the reaction mixture with a porous substrate is carried out between about 1 bar and about 100 bar. In one embodiment, contacting the reaction mixture with a porous substrate is carried out between about 1 bar and about 50 bar. In one embodiment, contacting the reaction mixture with a porous substrate is carried out between about 1 bar and about 25 bar. In one embodiment, contacting the reaction mixture with a porous substrate is carried out between about 1 bar and about 10 bar. In one embodiment, contacting the reaction mixture with a porous substrate is carried out between about 1 bar and about 5 bar. In one embodiment, contacting the reaction mixture with a porous substrate is carried out at about 1 bar.

In one embodiment, the amorphous metal organic framework is formed whilst the porous substrate is soaked in the reaction mixture.

In one embodiment, the reaction mixture is not heated or subjected to increased pressure prior to the impregnation/permeation of the porous substrate. In one embodiment, the reaction mixture is heated or subjected to increased pressure prior to the impregnation of the porous substrate. In one embodiment, the reaction mixture is stirred prior to the impregnation of the porous substrate.

In one embodiment, the porous substrate may be any substrate described herein. In one embodiment the substrate is porous. In one embodiment, the porous substrate is mesoporous. In one embodiment, the porous substrate is microporous. In one embodiment, the porous substrate has an average pore diameter of between about 0.1 nm to about 20 nm. In one embodiment, the porous substrate has an average pore diameter of between about 1 and about 15 nm. In one embodiment, the porous substrate has an average pore diameter of between about 2.5 nm and about 10 nm. In one embodiment, the porous substrate has an average pore diameter of approximately about 0.8 nm, 2.7 nm, 3.8 nm, 6.0 nm or 7.0 nm.

In one embodiment, the porous substrate has a maximum average pore diameter of about 20 nm. In one embodiment, the porous substrate has a maximum average pore diameter of about 15 nm. In one embodiment, the porous substrate has a maximum average pore diameter of about 10 nm. In one embodiment, the substrate has a maximum average pore diameter of about 5 nm.

In one embodiment, the porous substrate is selected from the group consisting of activated carbons, zeolites, aluminium oxide, and silica and silica gel.

Once the reaction mixture is contacted with the porous substrate, the process comprises the step of subsequently removing the liquid component from the porous substrate.

In one embodiment, the liquid component is removed from the substrate such that amorphous metal organic framework is formed during the soaking process and/or through the removal process.

In one embodiment, the liquid component is any liquid component of the reaction mixture that is unreacted or has not formed an amorphous metal organic framework. In one embodiment, the liquid component is the combination of liquid components of the reaction mixture that are unreacted and/or have not formed an amorphous metal organic framework.

In one embodiment, removing the liquid component is carried out by extracting the solid component from the reaction mixture. For example, removing the liquid component is carried out by filtration or centrifugation.

In one embodiment, removing the liquid component is carried out by extracting the fluid component using heat, pressure/vacuum or a combination of heat and pressure/vacuum. In one embodiment, the extraction of the liquid component is controlled by regulating the heat and/or pressure/vacuum to deliberately remove the individual components of the liquid component, to deliberately remove the liquid component in bulk, or to deliberately remove groups of components together.

In one embodiment, removing the liquid component is carried out by heating the resulting mixture of the porous substrate and reaction mixture.

The porous substrate and reaction mixture is heated in any way know to the skilled so person. In one embodiment, the porous substrate and reaction mixture is heated in an oven. In one embodiment, the porous substrate and reaction mixture is heated to between about 50° C. and about 250° C. In one embodiment, the porous substrate and reaction mixture is heated to between about 100° C. and about 200° C. In one embodiment, the porous substrate and reaction mixture is heated to between about 125° C. and about 175° C. In one embodiment, the porous substrate and reaction mixture is heated to about 150° C. In one embodiment, the porous substrate and reaction mixture is heated to about 110° C.

The porous substrate and reaction mixture may be heated for between about 30 20 minutes and about 48 hours. The porous substrate and reaction mixture may be heated for between about 30 minutes and about 36 hours. The porous substrate and reaction mixture may be heated for between about 30 minutes and about 24 hours. The porous substrate and reaction mixture may be heated for between about 30 minutes and about 12 hours. The porous substrate and reaction mixture may be heated for between about 30 minutes and about 4 hours, preferably between about 1 and about 2 hours. The porous substrate and reaction mixture may be heated for about 2 hours.

When the reaction mixture comprises a titanium salt, the porous substrate may be heated for between about 24 hours to about 48 hours. In one embodiment, when the reaction mixture comprises a titanium salt and the only acid in the reaction mixture is an alcohol, the porous substrate may be heated for about 48 hours. In one embodiment, when the reaction mixture comprises a titanium salt and an acid selected from trifluoroacetic acid, benzoic acid, formic acid, propionic acid, sodium acetate, and acetic acid, the porous substrate may be heated for about 24 hours.

In some embodiments, the resulting mixture of the porous substrate and reaction mixture is agitated during heating. The agitation may be achieved by any method known to the skilled person. In one embodiment, the mixture may be stirred, shaken or vibrated. In one embodiment, the mixture is shaken.

Once the porous substrate and reaction mixture has been heated, the process may comprise the step of washing the porous substrate comprising the amorphous metal organic framework. The porous substrate comprising the amorphous metal organic framework may be washed by any process known to the skilled person. In one so embodiment, the porous substrate comprising the amorphous metal organic framework is washed using a solvent. The solvent may be selected from any solvent described herein. In one embodiment, the solvent is methanol or ethanol.

Once the porous substrate and reaction mixture has been washed, the process may comprise the step of drying the porous substrate comprising the amorphous metal organic framework. In one embodiment, the substrate comprising the amorphous metal organic framework is dried under vacuum, for example in a vacuum oven.

In one aspect, the disclosure provides an amorphous metal organic framework obtainable by a process of the disclosure. In one aspect, the disclosure provides an amorphous metal organic framework produced by a process of the disclosure.

In one aspect, the disclosure provides an absorbent material obtainable by a process of the disclosure. In one aspect, the disclosure provides an absorbent material produced by a process of the disclosure.

The impregnation of the substrate by the reaction mixture allows for the synthesis of the amorphous metal organic framework to be carried out in a spatially restricted volume, i.e. in the pores of the substrate. Heating of the resulting mixture facilitates enhanced growth of the amorphous metal organic framework solution from the precursor solution but is not required for the process to produce amorphous metal organic frameworks.

Under normal solvothermal synthesis conditions a crystalline metal organic framework will form from the reaction mixture. However, as the reaction mixture is impregnated in the substrate it has surprisingly been found that the resulting metal organic framework is amorphous. This is especially surprising because the kinetic and thermodynamic driving forces for the synthesis of metal organic frameworks are so strongly biased towards crystalline structures. It is hypothesized that because the reaction mixture is spatially restricted within the pores of the substrate that the driving forces are changed such that amorphous metal organic framework is produced.

It is envisioned and known that alternative chemicals can be used in this synthesis process, and there are alternative chemicals used in the development of other nanostructures.

### Definitions

As used herein, the term “hydrocarbon fluid” refers to one or more hydrocarbon species in any combination of solid, liquid, or gas that is capable of flowing. Non-limiting examples of such hydrocarbon species include alkanes, alkenes, alkynes, dienes, cycloalkanes, cycloalkenes, arenes, terpenes, ketones, furans, alcohols, amines, and thiols. The hydrocarbon fluid may correspond to one or more hydrocarbon species extracted from a natural source (e.g., a crude oil), a processed product of one or more hydrocarbon species so-extracted (e.g., a product of a refinery), or any processed intermediate inbetween (e.g., a petroleum distillate).

As used herein, the term “sulfur-containing compound” refers to any sulfur-bearing species found in a hydrocarbon fluid as disclosed above. The hydrocarbon fluid may correspond to a sour crude extracted from a natural source, a product processed by a refinery or chemical plant, or any intermediate inbetween. Non-limiting examples of sulfur-containing compounds include hydrogen sulfide (H₂S), sulfur dioxide (SO₂), carbonyl sulfide (CS₂), thiophenes, thiols, thiazoles, thianes, thiazines, thiopyrans, thiocanes, thiophenols, and thiocarboxylic acids.

Metal organic frameworks containing metal clusters/metal nodes and ligands are described herein.

Metal Cluster/Metal Node

A metal cluster/metal node as used herein may be a combination of two or more metal atoms joined by one or more bridging/central atoms. The one or more bridging/central atoms can be a metal atom or a non-metal atom. In some embodiments, the one or more bridging/central atom is selected from I, S or O. Preferably, the bridging/central atom is O.

Alternatively, the metal cluster/metal node can be a single metal atom.

In some embodiments, the metal cluster/metal node comprises additional atoms or groups, such as terminal groups, capping groups or bridging groups. In some embodiments the metal cluster/metal node comprises a group selected from H₂O, DMF, DEF, DMA DEAH methoxy, ethoxy, phenyl, hydroxyl, isopropoxy, diethylamine, piperidine, pyridine, and picoline.

The metal cluster/metal node may comprise the formula M₂XO, wherein each M is independently a metal ion selected from the group consisting of Group 2 through Group 16 metals and X is a metal ion selected from the group consisting of Group 2 through Group 16 metals.

In some embodiments the metal may be in a high oxidation state/have a high valence number. For example, each M or X may individually be a metal ion selected from Al(II,III), Fe(II,III), Ti (II, II,IV), Co(II), Ni(II), Mn(II), Zn(II), Mg(II), Cr(III), V(III), Sc(III), Ca(II), Ba(II) or In(III), preferably X is a metal ion selected from Al(II,III), Fe(II,III), Ti(II, II,IV), Co(II), Ni(II), Mn(II), Zn(II), and Mg(II).

Each M can be the same metal or a different metal. Preferably each M is the same metal. Each M may be the same metal as or different metal to X. Preferably both M and X are the same metal.

In embodiments in which it is necessary to balance the charge of the metal cluster/metal node, additional substituents/ligands may be included. For example, additional hydroxyl groups may be present in the metal cluster/metal node. In particular, in an Fe₃ based cluster/node where all three Fe ions are Fe(III) ions, the metal cluster/metal node may have a formula of Fe₃O(OH).

Ligands

A ligand as used herein is linker between metal clusters/metal nodes. In all aspects and embodiments, these ligands may be derived from a dicarboxylic acid, a tricarboxylic acid, a tetracarboxylic acid, a hexacarboxylic acid or an octacarboxylic acid.

For the purposes of the present disclosure, the term “derived” means that the carboxylic acid compounds are present in partly deprotonated or fully deprotonated form. For completeness, when a ligand is said to be a specific compound it may the so compound itself or it can be the partly deprotonated or fully deprotonated form thereof.

For example, a ligand may be derived from a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino(diphenyl ether)diimidedicarboxylic acid, 4,4′-diaminodiphenylmethanediimidedicarboxylic acid, 4,4′-diamino(diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbomane-2,3-dicarboxylic acid, 5-ethyl-2,3-pyridinedicarboxylic acid or camphordicarboxylic acid.

For example, a ligand may be derived from a tricarboxylic acid, such as for instance 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

For example, a ligand may be derived from a tetracarboxylic acid, such as, for instance, 1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

The ligands may also be derived from a carboxylic acid selected from compounds of formula L1 to L30 and combinations thereof:

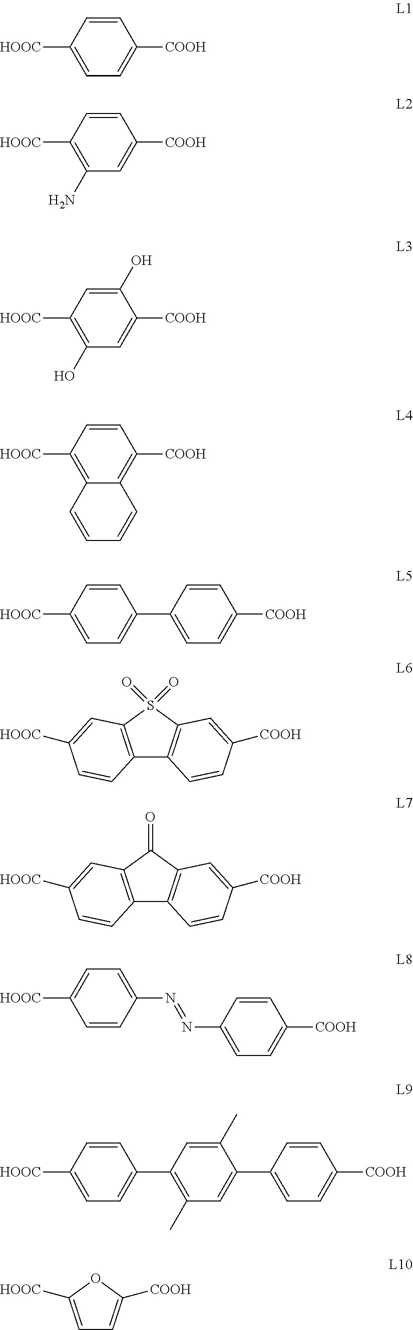

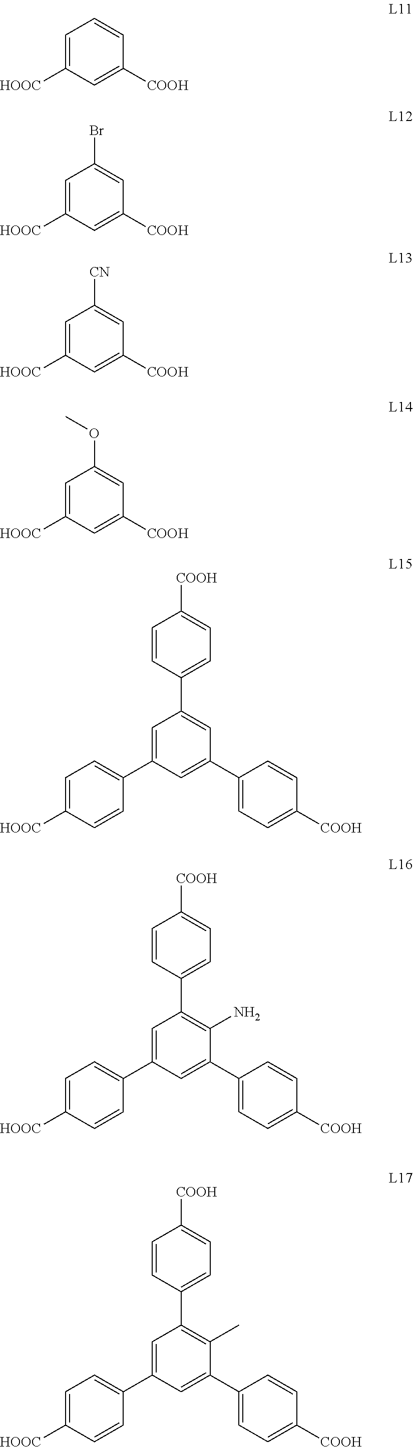

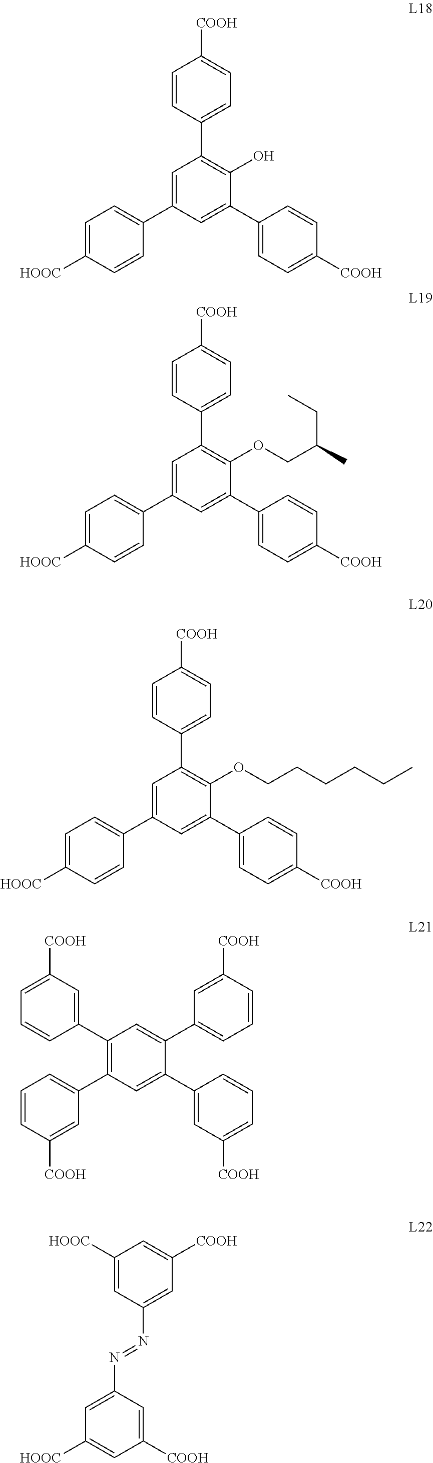 [SMILES: O=C(O)c1ccc(-c2cc(-c3ccc(C(=O)O)cc3)c(O)c(-c3ccc(C(=O)O)cc3)c2)cc1 ; CC[C@@H](C)COc1c(-c2ccc(C(=O)O)cc2)cc(-c2ccc(C(=O)O)cc2)cc1-c1ccc(C(=O)O)cc1 ; CCCCCCOc1c(-c2ccc(C(=O)O)cc2)cc(-c2ccc(C(=O)O)cc2)cc1-c1ccc(C(=O)O)cc1 ; O=C(O)c1cccc(-c2cc(-c3cccc(C(=O)O)c3)c(-c3cccc(C(=O)O)c3)cc2-c2cccc(C(=O)O)c2)c1 ; O=C(O)c1cc(/N=N/c2cc(C(=O)O)cc(C(=O)O)c2)cc(C(=O)O)c1]

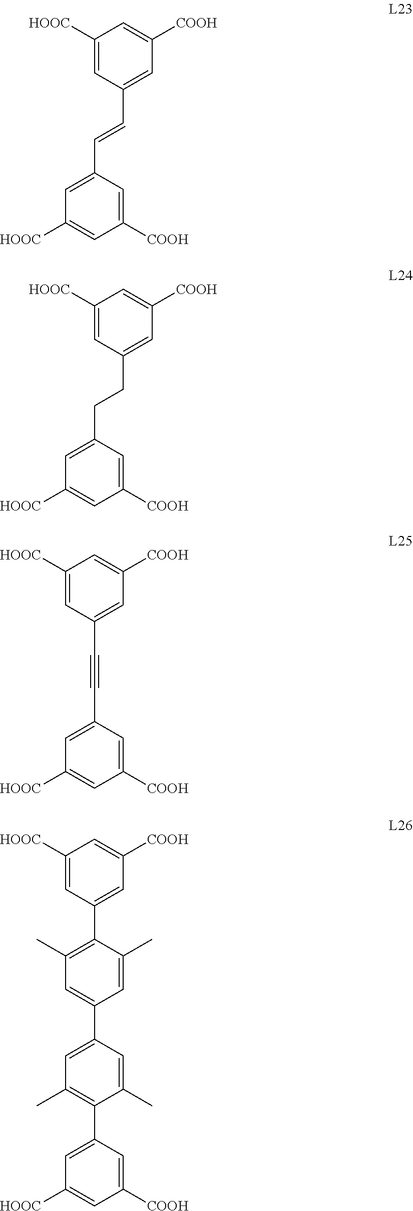 [SMILES: O=C(O)c1cc(/C=C/c2cc(C(=O)O)cc(C(=O)O)c2)cc(C(=O)O)c1 ; O=C(O)c1cc(CCc2cc(C(=O)O)cc(C(=O)O)c2)cc(C(=O)O)c1 ; O=C(O)c1cc(C#Cc2cc(C(=O)O)cc(C(=O)O)c2)cc(C(=O)O)c1 ; Cc1cc(-c2cc(C)c(-c3cc(C(=O)O)cc(C(=O)O)c3)c(C)c2)cc(C)c1-c1cc(C(=O)O)cc(C(=O)O)c1]

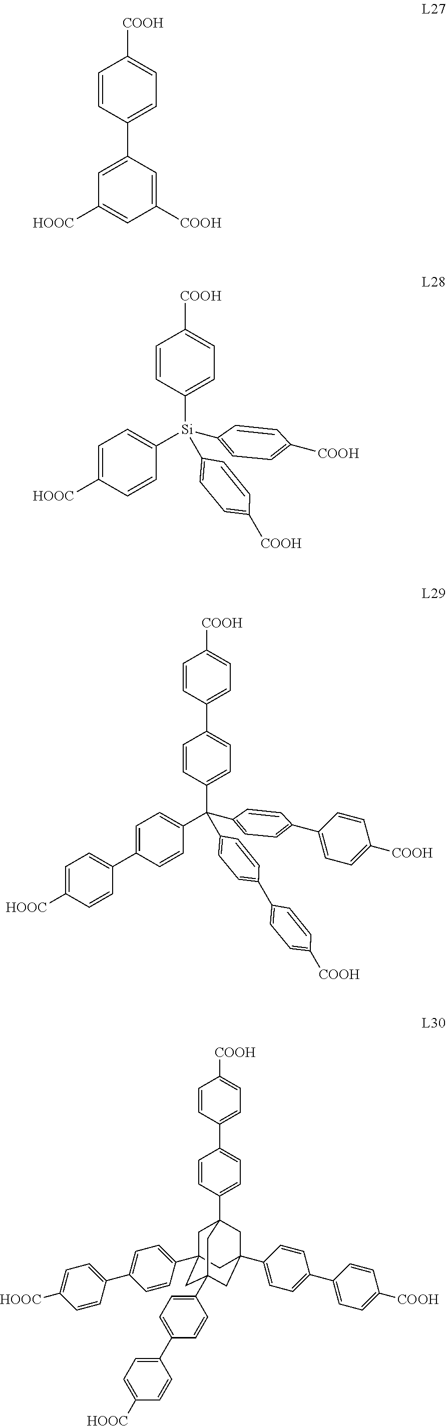 [SMILES: O=C(O)c1ccc(-c2cc(C(=O)O)cc(C(=O)O)c2)cc1 ; O=C(O)c1ccc([Si](c2ccc(C(=O)O)cc2)(c2ccc(C(=O)O)cc2)c2ccc(C(=O)O)cc2)cc1 ; O=C(O)c1ccc(-c2ccc(C(c3ccc(-c4ccc(C(=O)O)cc4)cc3)(c3ccc(-c4ccc(C(=O)O)cc4)cc3)c3ccc(-c4ccc(C(=O)O)cc4)cc3)cc2)cc1 ; O=C(O)c1ccc(-c2ccc(C34CC5(c6ccc(-c7ccc(C(=O)O)cc7)cc6)CC(c6ccc(-c7ccc(C(=O)O)cc7)cc6)(C3)CC(c3ccc(-c6ccc(C(=O)O)cc6)cc3)(C4)C5)cc2)cc1]

Specific combinations of ligands include ligands derived from L31 and L32:

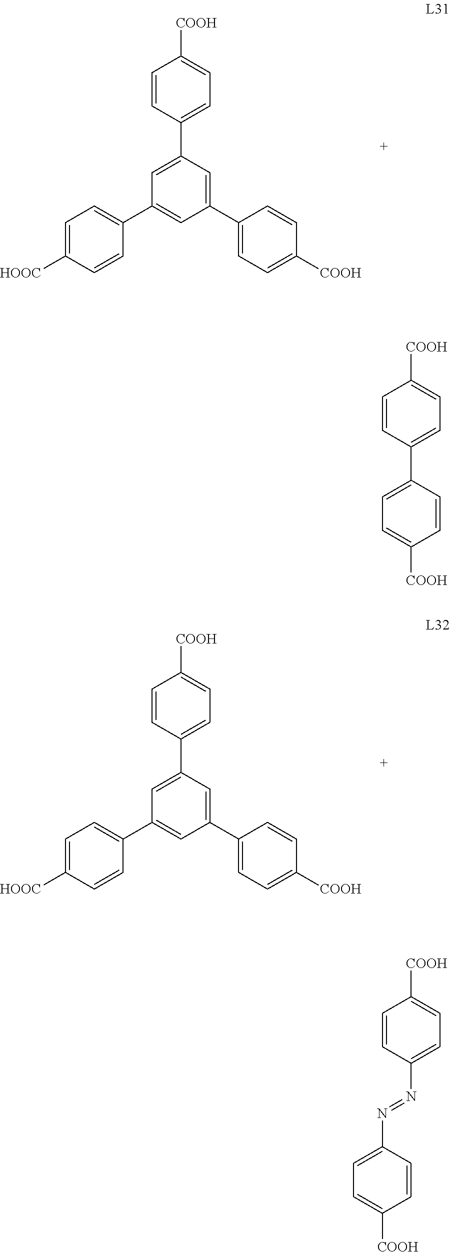 [SMILES: O=C(O)c1ccc(-c2cc(-c3ccc(C(=O)O)cc3)cc(-c3ccc(C(=O)O)cc3)c2)cc1 ; O=C(O)c1ccc(-c2ccc(C(=O)O)cc2)cc1 ; O=C(O)c1ccc(-c2cc(-c3ccc(C(=O)O)cc3)cc(-c3ccc(C(=O)O)cc3)c2)cc1 ; O=C(O)c1ccc(/N=N/c2ccc(C(=O)O)cc2)cc1]

Alternatively, the ligand may be derived from a carboxylic acid selected from the following compounds or combinations thereof:

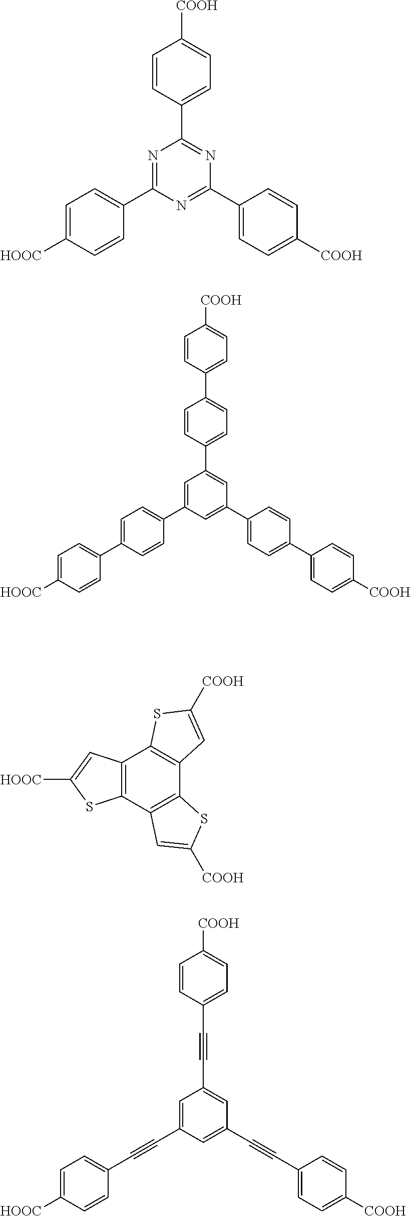 [SMILES: O=C(O)c1ccc(-c2nc(-c3ccc(C(=O)O)cc3)nc(-c3ccc(C(=O)O)cc3)n2)cc1 ; O=C(O)c1ccc(-c2ccc(-c3cc(-c4ccc(-c5ccc(C(=O)O)cc5)cc4)cc(-c4ccc(-c5ccc(C(=O)O)cc5)cc4)c3)cc2)cc1 ; O=C(O)c1cc2c(s1)c1cc(C(=O)O)sc1c1cc(C(=O)O)sc21 ; O=C(O)c1ccc(C#Cc2cc(C#Cc3ccc(C(=O)O)cc3)cc(C#Cc3ccc(C(=O)O)cc3)c2)cc1]

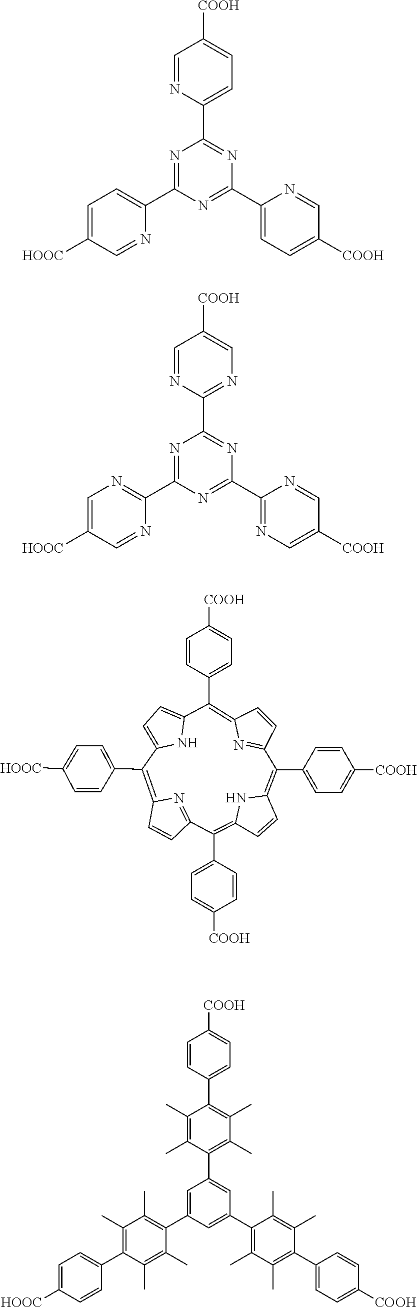 [SMILES: O=C(O)c1ccc(-c2nc(-c3ccc(C(=O)O)cn3)nc(-c3ccc(C(=O)O)cn3)n2)nc1 ; O=C(O)c1cnc(-c2nc(-c3ncc(C(=O)O)cn3)nc(-c3ncc(C(=O)O)cn3)n2)nc1 ; O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1 ; Cc1c(C)c(-c2cc(-c3c(C)c(C)c(-c4ccc(C(=O)O)cc4)c(C)c3C)cc(-c3c(C)c(C)c(-c4ccc(C(=O)O)cc4)c(C)c3C)c2)c(C)c(C)c1-c1ccc(C(=O)O)cc1]

For example, a ligand may be derived from fumaric acid, succinic acid, glutaric acid, muconic acid, adipic acid, azelaic acid, 2,5-thiophene-dicarboxylic acid, terephthalic acid, 2,5-pyrazinedicarboxylic acid, naphthalene-2,6-dicarboxylic acid, biphenyl-4,4′-dicarboxylic acid, azo-benzenedicarboxylic acid, benzene-1,2,4-tricarboxylic acid, benzene-1,3,5-tricarboxylate acid, benzene-1,3,5-tribenzoic acid, benzene-1,2,4,5-tetracarboxylic acid, naphthalene-2,3,6,7-tetracarboxylic acid, naphthalene-1,4,5,8-tetracarboxylic acid, biphenyl-3,5,3′,5′-tetracarboxylic acid, and modified analogs chosen from the group comprising 2-aminoterephthalic acid, 2-nitro-terephthalic acid, 2-methylterephthalic acid, 2-chloro-terephthalic acid, 2-bromoterephthalic acid, 2,5-dihydroxoterephthalic acid, tetrafluoroterephthalic acid, tetramethylterephthalic acid, dimethyl-4,4′-biphenyldicarboxylic acid, tetramethyl-4,4′-biphenyldicarboxylic acid, dicarboxy-4,4′-biphenyldicarboxylic acid, 2,5-pyrazinedicarboxylic acid. The ligand L′ used may also be chosen from the group comprising: 2,5-diperfluoroterephthalic acid, azobenzene-4,4′-dicarboxylic acid, 3,3′-dichloroazobenzene-4,4′-dicarboxylic acid, 3,3′-dihydroxoazobenzene-4,4′-dicarboxylic acid, 3,3′-diperfluoroazobenzene-4,4′-dicarboxylic acid, 3,5,3′,5′-azobenzenetetracarboxylic acid, 2,5-dimethylterephthalic acid, perfluoroglutaric acid.

In one embodiment, the ligand is fumarate, succinate, glutarate, muconate, adipate, azelate, 2,5-thiophenedicarboxylate, terephthalate, 2,5-pyrazinedicarboxylate, naphthalene-2,6-dicarboxylate, biphenyl-4,4′-dicarboxylate, azobenzenedicarboxylate, benzene-1,2,4-tricarboxylate, benzene-1,3,5-tricarboxylate, benzene-1,3,5-tribenzoate, benzene-1,2,4,5-tetracarboxylate, naphthalene-2,3,6,7-tetracarboxylate, naphthalene-1,4,5,8-tetracarboxylate, biphenyl-3,5,3′,5′-tetracarboxylate, and modified analogs chosen from the group comprising 2-aminoterephthalate, 2-nitro-terephthalate, 2-methylterephthalate, 2-chloroterephthalate, 2-bromoterephthalate, 2,5-dihydroxoterephthalate, tetrafluoroterephthalate, tetramethylterephthalate, dimethyl-4,4′-biphenyldicarboxylate, tetramethyl-4,4′-biphenyldicarboxylate, dicarboxy-4,4′-biphenyldicarboxylate, 2,5-pyrazinedicarboxylate.

In one embodiment, the ligand is 2,5-diperfluoroterephthalate, azobenzene-4,4′-dicarboxylate, 3,3′-dichloroazobenzene-4,4′-dicarboxylate, 3,3′-dihydroxoazobenzene-4,4′-dicarboxylate, 3,3′-diperfluoroazobenzene-4,4′-dicarboxylate, 3,5,3′,5′-azobenzenetetracarboxylate, 2,5-dimethylterephthalate, perfluorosuccinate, perfluoromuconate, perfluoroglutarate, 3,5,3′,5′-perfluoro-4,4′-azobenzenedicarboxylate, 3,3′-diperfluoroazobenzene-4,4′-dicarboxylate.

In one embodiment, the ligand is a fluoro ligand; i.e. comprising at least one F substituent. For example, the ligand may be a tetrafluoroterephthalate, perfluorosuccinate, perfluoromuconate, perfluoroglutarate, 2,5-diperfluoroterephthalate, 3,6-perfluoro-1,2,4,5-benzenetetracarboxylate, 3,5,3′,5′-perfluoro-4,4′-azobenzenedicarboxylate or 3,3′-diperfluoroazobenzene-4,4′-dicarboxylate.

PCN-250 is the term used to refer to a series of metal organic frameworks consisting of 6-connected M₂XO clusters and rectangular tetratopic L22 ligands. cPCN-250 refers to the crystalline counterpart whilst aPCN-250 refers to the amorphous counterpart.

MIL-100 is the term used to refer to a series of metal organic frameworks consisting of M₂XO clusters and 1,3,5-benzenetricarboxylic acid ligands.

MIL-125 is the term used to refer to a series of metal organic frameworks consisting of M₂O₂ clusters and benzenedicarboxylate-based ligands, for example L1 or L2 ligands. For example, MIL-125 may be a metal organic framework of Ti and H2BDC. For example, MIL-125 NH2 be a metal organic framework of Ti and 2-amino-BDC.

All metal organic frameworks may additionally include capping, bridging or charge balancing ligands.

The MIL-125 cluster may additionally/alternatively be described as having the structure M₈O₈ or M₈O₈(OH)₄. For example, MIL-125 may be represented by M₈O₈(OH)₄(BDC)₆. For example MIL-125 NH2 may be represented by M₈O₈(OH)₄(2-amino-BDC)6.

Substrates

Substrates as described herein are porous materials. In one embodiment, the porous substrate

Activated alumina, Activated carbon, Activated carbon cloth, Activated carbon fibers, Active oxides, Aerogel, AlPO4-5, AlPO4-8, Alumina, Alumina fibers, Alumina hydrous, Aluminum hydroxides, Aluminum oxide-hydroxides, Aluminophosphate molecular sieve, Attapulgite, AX21, Barium sulfate, Bauxite, Bayerite, Bentonite, Boehmite, Buckytube, Buckyball, Calcite, Carbon black, Carbon cloth, Carbon nanotube, Carbons, Carbosieve, Charcoal cloth, Chromia gels, Chromium dioxide, Chromium oxyhydroxide, Clay, Coke, Corundum, Cristobalite, Crystalline silica, Degussa Aluminiumoxide, Dehydroxylated silica gels, Diaspore, Dolomite, Ferric oxide, Flame-hydrolysed alumnia, Fullerene, Gibbsite, Goethite, Graphite, Graphitized carbon, Graphitized Sterling, Graphitized thermal black, Graphon, Haematite, Hectorite, High-temperature alumina, Hydrargillite, Hydrogel, Hydrous oxide gels, H-ZSM5, Iron oxides, Kanemite, Kaolinite, Layer silicates, Magnesium hydroxide, Magnesium oxalate dehydrate, Magnesium oxide, MCM-41, Mesoporus silica gels, Molecular sieve, Montmorillonite, Nanocomposite materials, Nesquehonite, Nordstrandite, Palygorskite, Pentasil zeolites, Pillared clay, Pseudoboehmite, PX21, SAPO-5, Saponite, Saran charcoal, Sepiolite, Silica, Pyrogenic silica, Silica gels, Hydrated silica gels, Silica-coated rutile, Silicalite-I, Smecite, Sodalite, Spheron, Sterling, Superactive carbons, Tactoid, Thermal black, Titania gels, TK800, TK900, Ungraphitized carbon, Vermiculite, Vitreous silica, VPI-5, Vulcan, Xerogel, Zeolite, Zirconia gels, Zirconium dioxide, ZSM-1, or ZSM-5.

In one embodiment, the porous substrate is selected from the group consisting of activated carbons, zeolites, aluminium oxide, and silica and silica gel.

In one embodiment, the substrate may be any substrate described herein. In one embodiment, the substrate is macroporous, i.e. has a pore diameter greater than about 50 nm. In one embodiment, the substrate is mesoporous, i.e. has a pore diameter of between about 2 nm and about 50 nm. In one embodiment, the substrate is microporous, i.e. has a pore diameter of less than 2 nm.

In one embodiment, the substrate has an average pore diameter of between about 0.1 nm to about 20 nm. In one embodiment, the substrate has an average pore diameter of between about 1 nm and about 15 nm. In one embodiment, the substrate has an average pore diameter of between about 2.5 nm and about 10 nm. In one embodiment, the substrate has an average pore diameter of about 0.8 nm, 2.7 nm, 3.8 nm, 6.0 nm or 7.0 nm.

For example, the activated carbon may be an amorphous mesoporous activated carbon. For example, the activated carbon may be a crystalline mesoporous activated carbon.

The average pore diameter in the activated carbon may be between 2 and 50 nm, preferably between about 2 and about 25 nm, more preferably between about 2 and about 0 nm.

In particular, the activated carbon may have a pore diameter of about 2.7 nm.

For example, the zeolite may be a microporous crystalline zeolite. The average pore diameter in the zeolite may be between about 0 and about 2 nm, preferably between 0 and 1 nm, more preferably between about 0.3 and about 0.8 nm.

In particular, the zeolite may have a pore diameter of about 0.8 nm. For example, the zeolite may be zeolite 13X.

For example, the aluminium oxide may be an amorphous mesoporous aluminium oxide. For example, the aluminium oxide may be a crystalline mesoporous aluminium oxide.

The average pore diameter in the aluminium oxide may be between about 2 and about 50 nm, preferably between about 2 and about 25 nm, more preferably between about 2 and about 10 nm.

In particular, the aluminium oxide may have a pore diameter of about 3.8 nm.

For example, the silica may be an amorphous mesoporous silica. For example, the silica may be a crystalline mesoporous silica.

The average pore diameter in the silica may be between about 2 and about 50 nm, preferably between about 2 and about 25 nm, more preferably between about 2 and about 10 nm.

In particular, the silica may have a pore diameter of about 7.0 nm.

For example, the silica gel may be an amorphous mesoporous silica gel.

The average pore diameter in the silica gel may be between about 2 and about 50 nm, preferably between about 2 and about 25 nm, more preferably between about 2 and about 10 nm.

In particular, the silica gel may have a pore diameter of about 6.0 nm.

In one embodiment, the substrate has a BET surface area of at least about 150 m²g⁻¹, 200 m²g⁻¹, 250 m²g⁻¹, 300 m²g⁻¹, 350 m²g⁻¹, 400 m²g⁻¹, 450 m²g⁻¹, 500 m²g⁻¹, 550 m²g⁻¹, 600 m²g⁻¹, 650 m²g⁻¹, 700 m²g⁻¹, 750 m²g⁻¹, 800 m²g⁻¹, 850 m²g⁻, or 900 m²g⁻¹.

Amorphous, Polycrystalline and Monocrystalline Materials

A monocrystalline metal organic framework (or a single crystal metal organic framework) consists of a metal organic framework in which the crystal lattice of the entire solid is continuous, unbroken (with no grain boundaries) to its edges. As such, monocrystalline metal organic frameworks have both short range order and long range order.

Monocrystalline is opposed to amorphous material, in which the atomic order is limited to short range order predominantly. Amorphous metal organic frameworks have short range order due to the repeating nature of the polymer itself. However, the polymer is not arranged in such a way that results in definable medium or long range order. Amorphous metal organic frameworks are characterised in that they do not have a defined XRD spectrum due to the lack of repeating medium and long range order.

Polycrystalline materials lie between these two extremes; they are made up of small crystals. A small crystal may be said to have short and medium range order. A polycrystalline solid or polycrystal is comprised of many individual grains or crystallites. There is no relationship between the grains. Therefore, on a large enough length scale, there is no periodicity across a polycrystalline sample, i.e. they do not exhibit long range order. They are different from monocrystalline materials and amorphous materials.

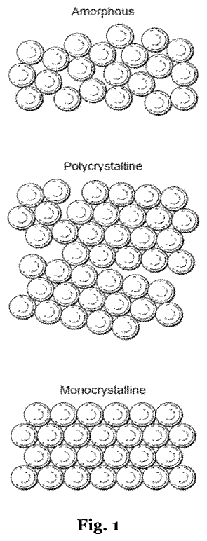

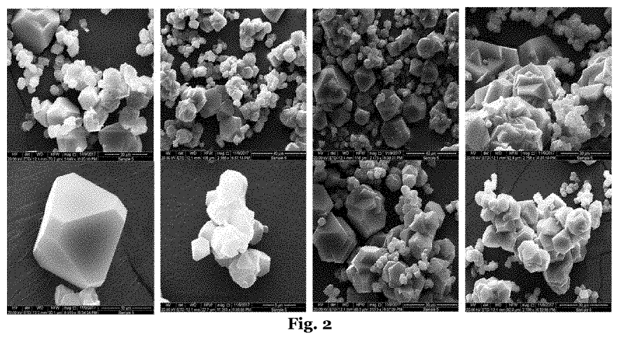

The differences between amorphous, polycrystalline and (mono) crystalline are illustrated in FIG. 1.

The symmetry exhibited by real single crystals is determined by the crystal structure of the material, normally by single-crystal X-Ray diffraction (SCRD) studies. SCRD is quite accessible in normal chemistry labs and become a routine way to obtain structures of single crystals. In contrast, a polycrystalline solid or polycrystal is comprised of many individual grains or crystallites. In polycrystalline solids, there is no relationship between neighbouring grains. Therefore, there is no periodicity across a polycrystalline sample. In the absence of single crystals, the structure of polycrystals can be determined by high-resolution powder X-Ray diffraction (PXRD), such as synchrotron resources. However, synchrotron resources are very limited all over the world.

To ascertain the presence of amorphous metal organic frameworks a similar technique can be utilised, i.e. X-Ray diffraction (XRD). However, in contrast to the SCRD and PXRD described above, XRD is performed to confirm the absence of peaks that would be characteristic of the monocrystalline or polycrystalline metal organic frameworks. As such, an XRD spectrum that is absent of crystalline peaks is indicative of an amorphous metal organic framework.

### Abbreviations

DMF: dimethylformamide

DEF: diethylformamide

NMP: N-methyl-2pyrrolidone

DMSO: Dimethyl sulfoxide

DMA: Dimethylacetamide

The disclosure will now be described further with reference to the following non-limiting examples and the accompanying Figures, in which:

FIG. 1 illustrates the differences between amorphous, polycrystalline, and monocrystalline materials.

FIG. 2. Visual examples of monocrystalline PCN-250Fe through SEM imaging.

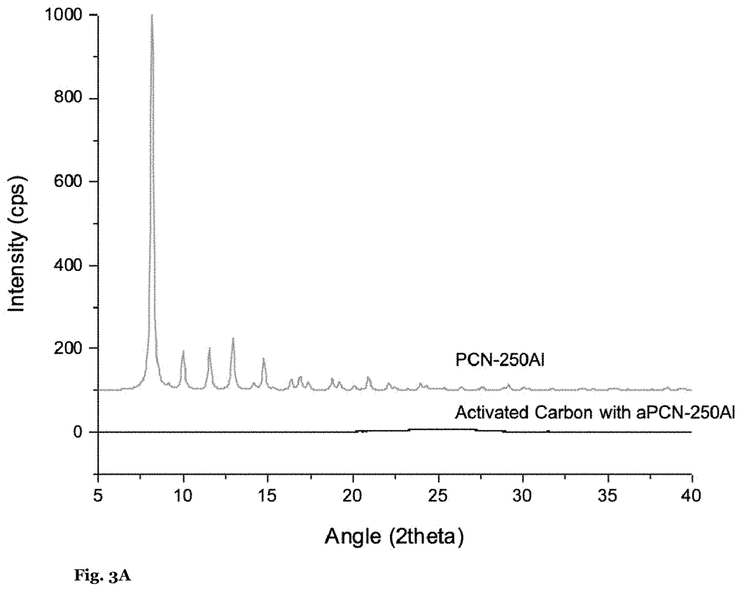

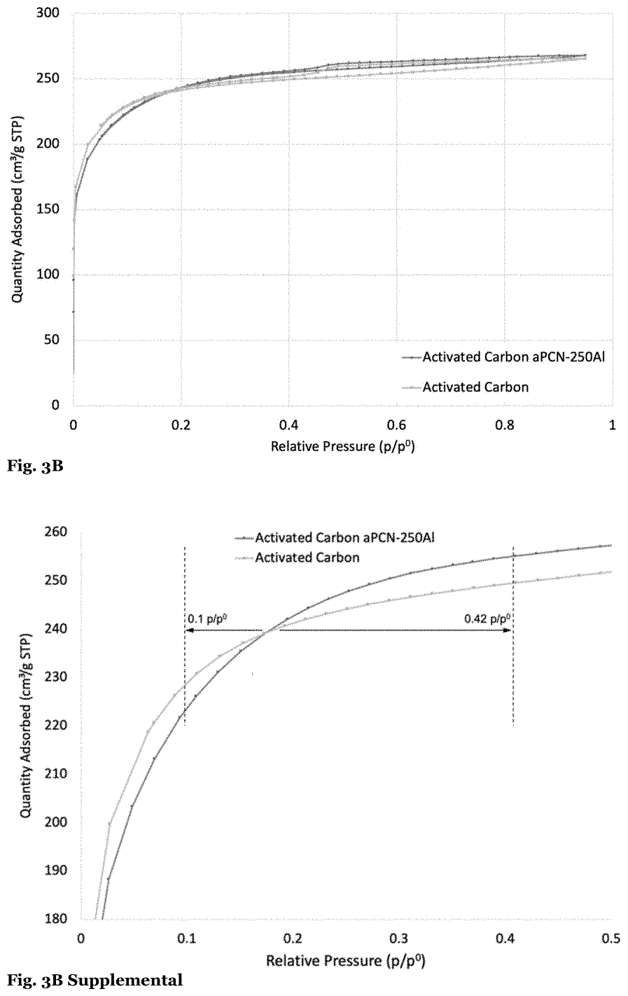

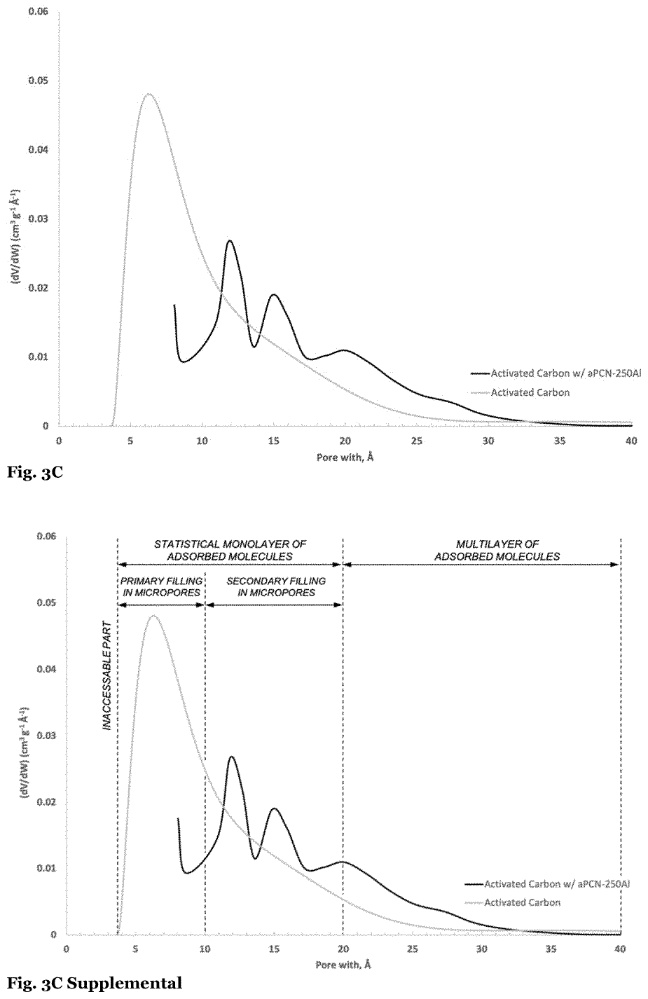

FIG. 3A. XRD comparing crystalline PCN-250Al against activated carbon with amorphous PCN-250Al (metal organic framework of Al and ABTC).

FIG. 3B. BET comparing activated carbon against activated carbon with amorphous PCN-250Al (metal organic framework of Al and ABTC).

FIG. 3B Supplemental. Expanded view of FIG. 3B.

FIG. 3C. Free volume hole size distribution comparing activated carbon (peak at approx. 7 \acute{Å}) against activated carbon with amorphous PCN-250Al (metal organic framework of Al and ABTC).

FIG. 3C Supplemental. Illustrated version of FIG. 3C.

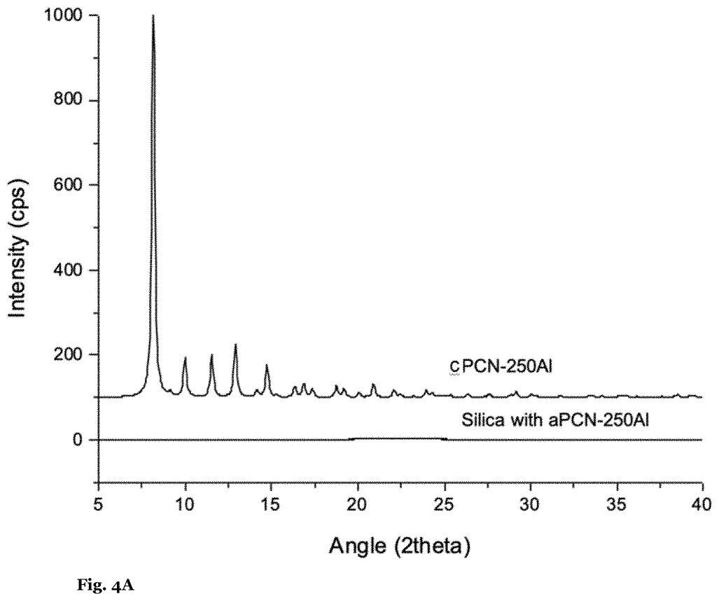

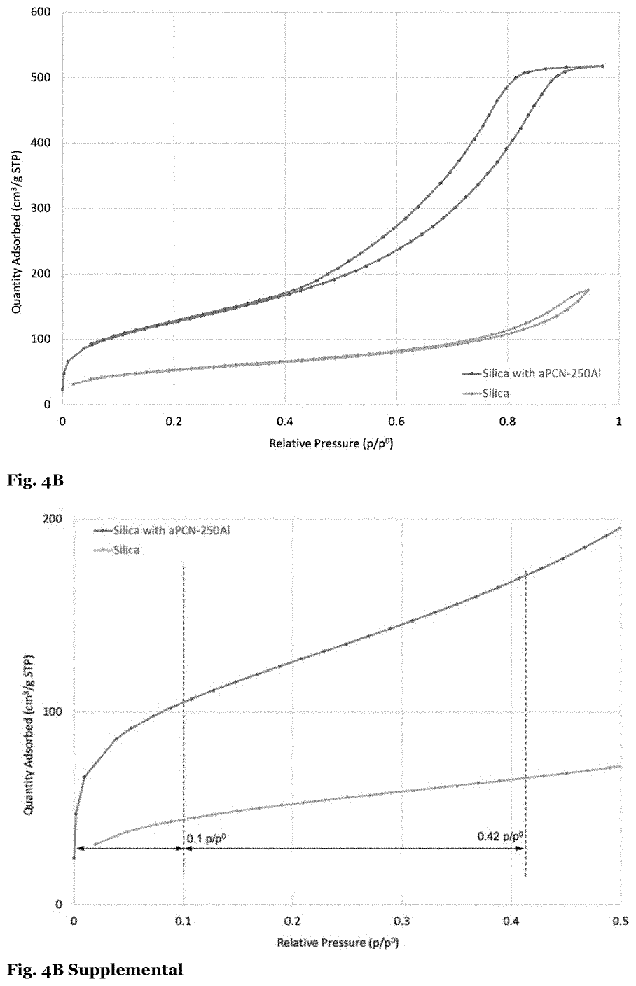

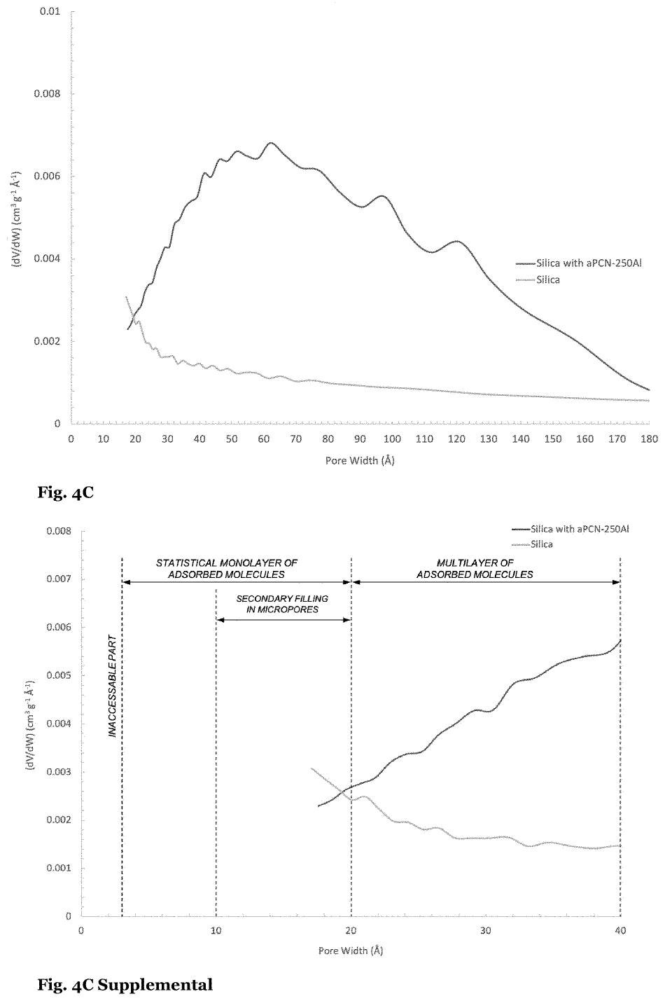

FIG. 4A. XRD comparing crystalline PCN-250Al against silica with amorphous PCN-250Al (metal organic framework of Al and ABTC).

FIG. 4B. BET comparing silica (bottom lines) against silica with amorphous PCN-250Al (metal organic framework of Al and ABTC).

FIG. 4B Supplemental. Expanded view of FIG. 4B.

FIG. 4C. Free volume hole size distribution comparing silica (top line) against silica with amorphous PCN-250Al (metal organic framework of Al and ABTC).

FIG. 4C Supplemental. Expanded view of FIG. 4C.

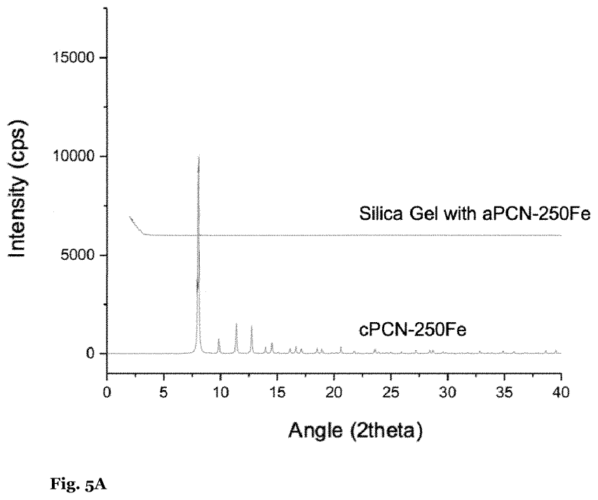

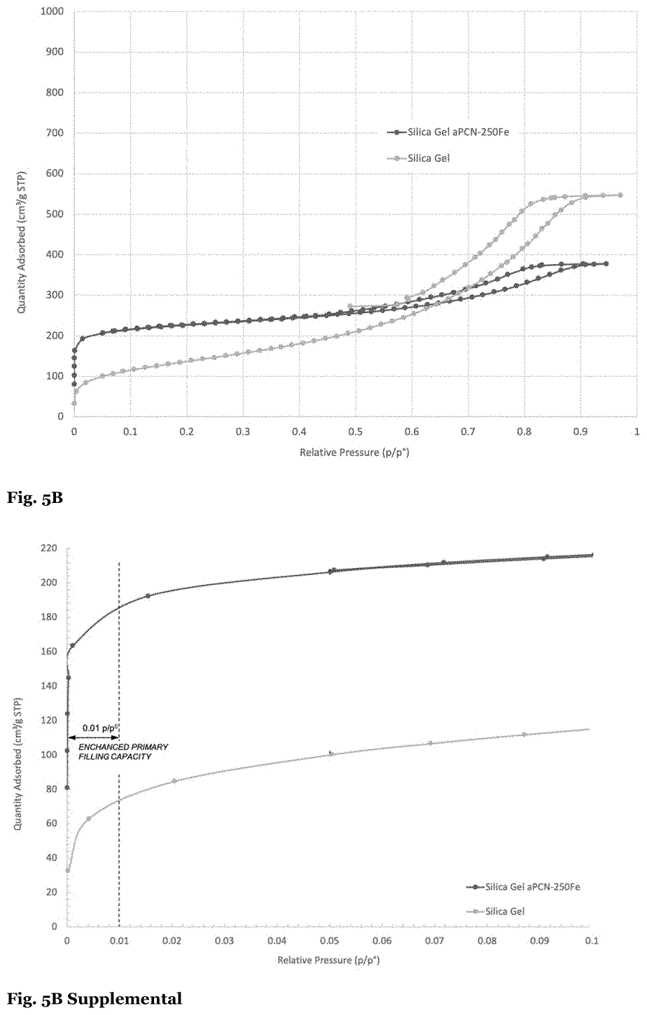

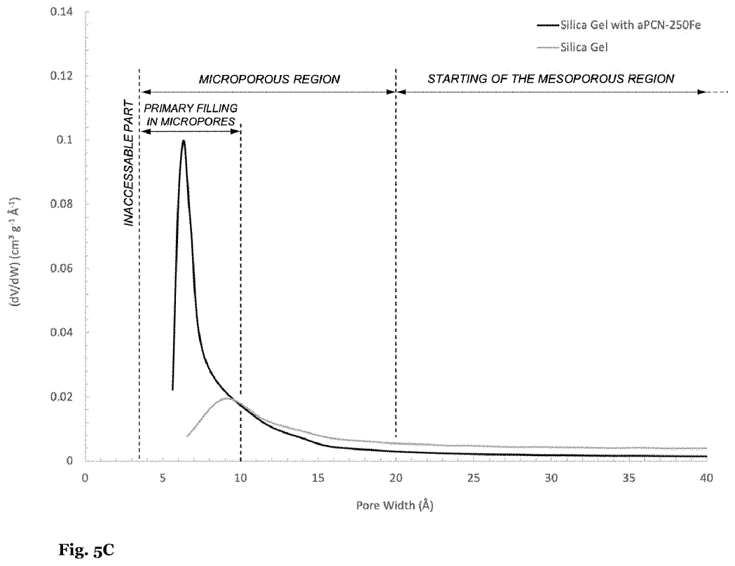

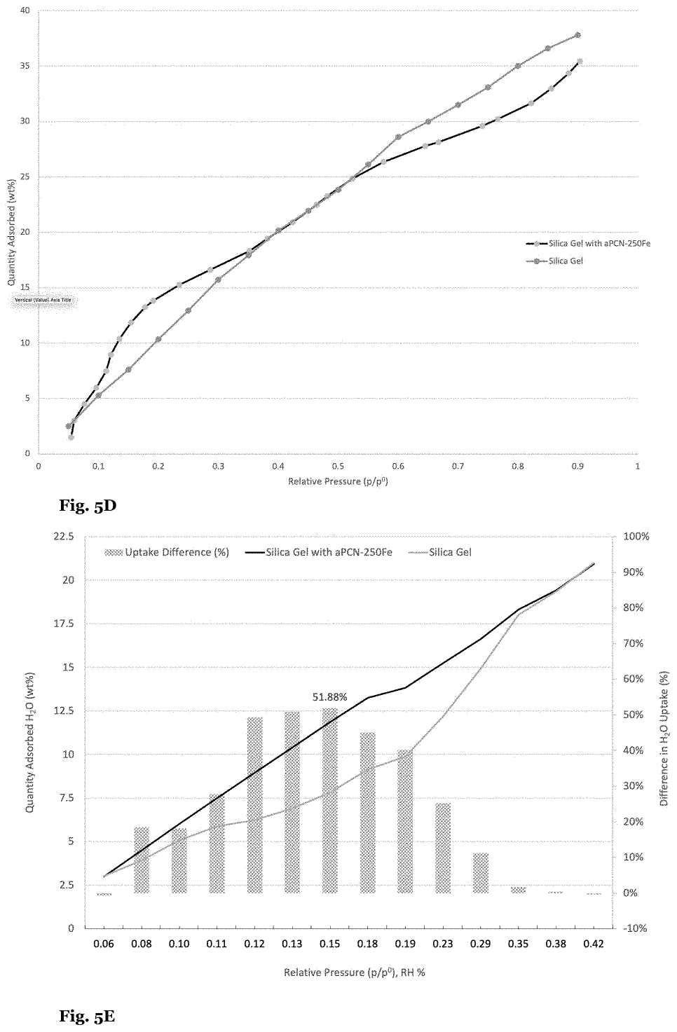

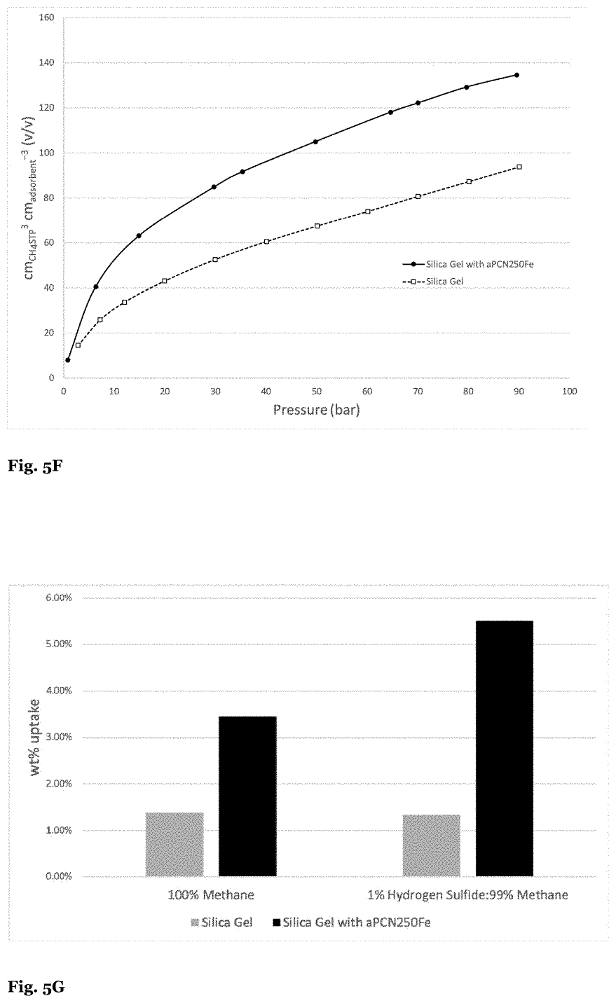

FIG. 5A. XRD comparing crystalline PCN-250Fe against silica gel with amorphous PCN-250Fe (metal organic framework of Fe and ABTC).

FIG. 5B. BET comparing silica gel against silica gel with amorphous metal organic framework of Fe and ABTC.

FIG. 5B Supplemental. Expanded view of FIG. 5B. The silica gel is the bottom line. Silica gel with amorphous PCN250Fe is the top line.

FIG. 5C. Free volume hole size distribution comparing silica gel (lower peak) against silica gel with amorphous PCN-250Fe (metal organic framework of Fe and ABTC).

FIG. 5D. Water adsorption graph comparing silica gel against silica gel with amorphous PCN250Fe (metal organic framework of Fe and ABTC).

FIG. 5E. Expanded view of FIG. 5D with different x-axis and overlay of uptake increase. The silica gel is the bottom line. The silica gel with amorphous PCN-250Fe is the top line.

FIG. 5F: Volumetric methane adsorption graph comparing silica gel (squares) against silica gel with amorphous PCN-250Fe (metal organic framework of Fe and ABTC) (circles).

FIG. 5G: Gravimetric comparison of methane adsorption and a mixture of 1 mol % hydrogen sulfide in methane, comparing silica gel with silica gel with amorphous PCN-250Fe (metal organic framework of Fe and ABTC).

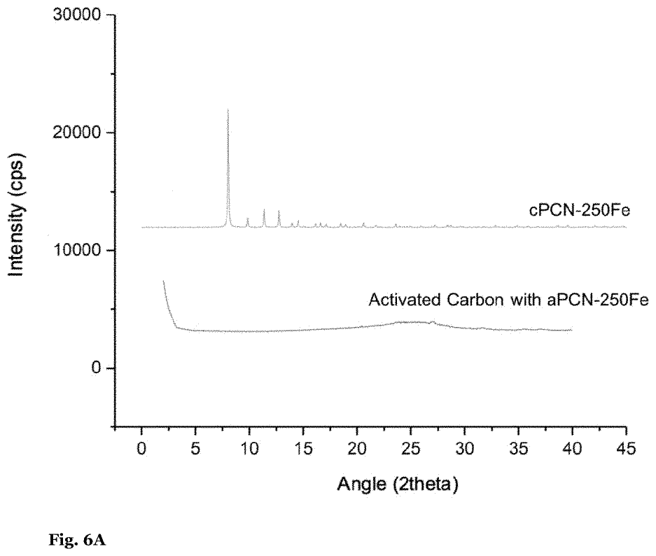

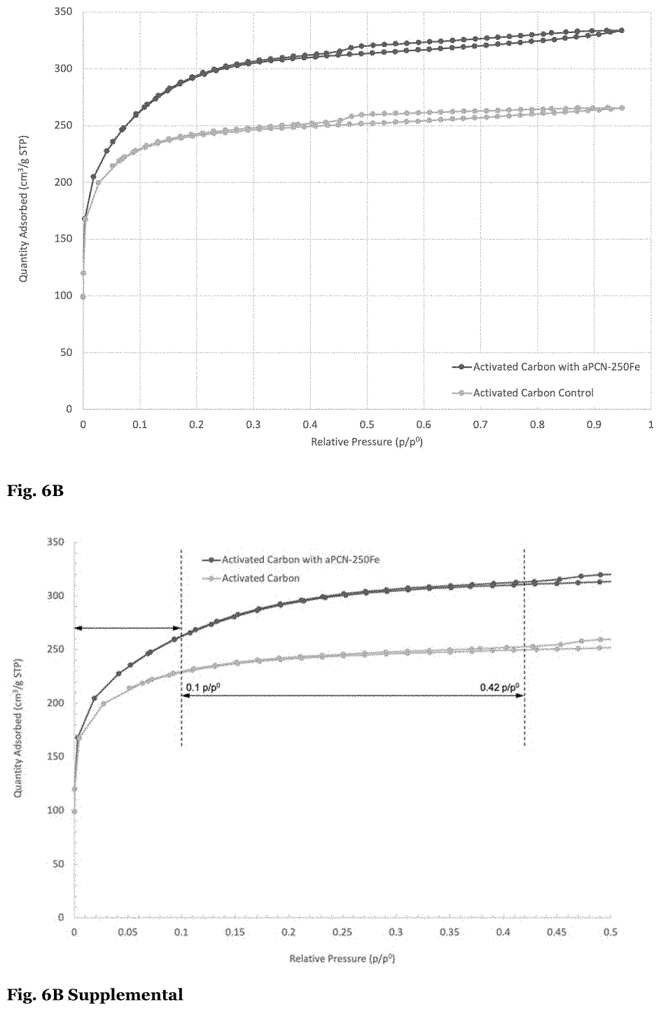

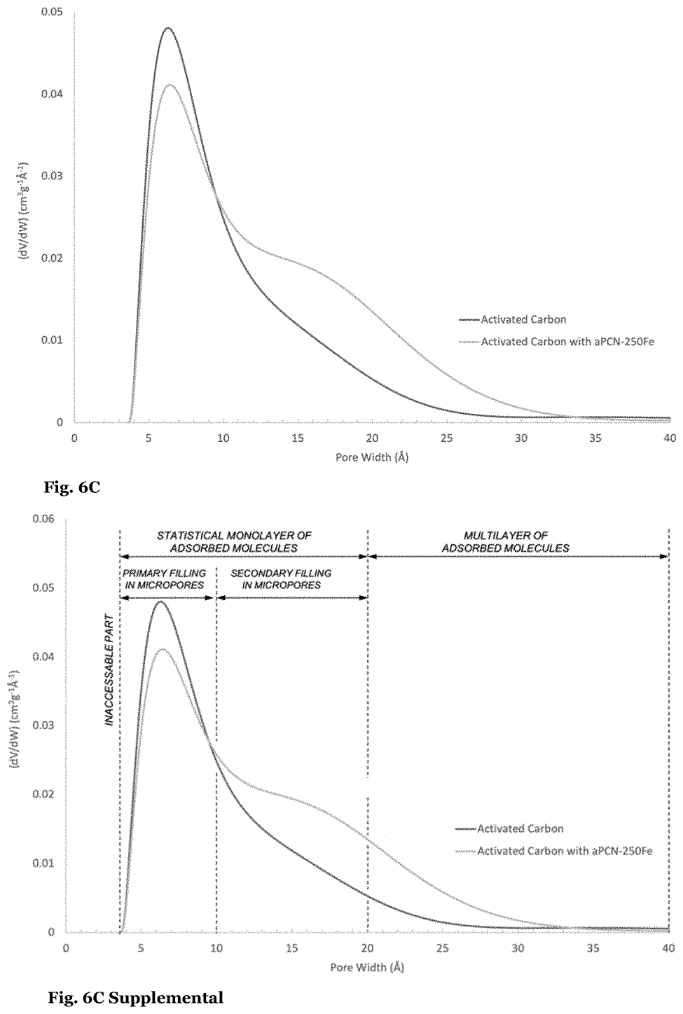

FIG. 6A. XRD comparing crystalline PCN-250Fe against activated carbon with amorphous PCN-250Fe (metal organic framework of Fe and ABTC).

FIG. 6B. BET comparing activated carbon (bottom lines) with activated carbon with amorphous PCN-250Fe (metal organic framework of Fe and ABTC).

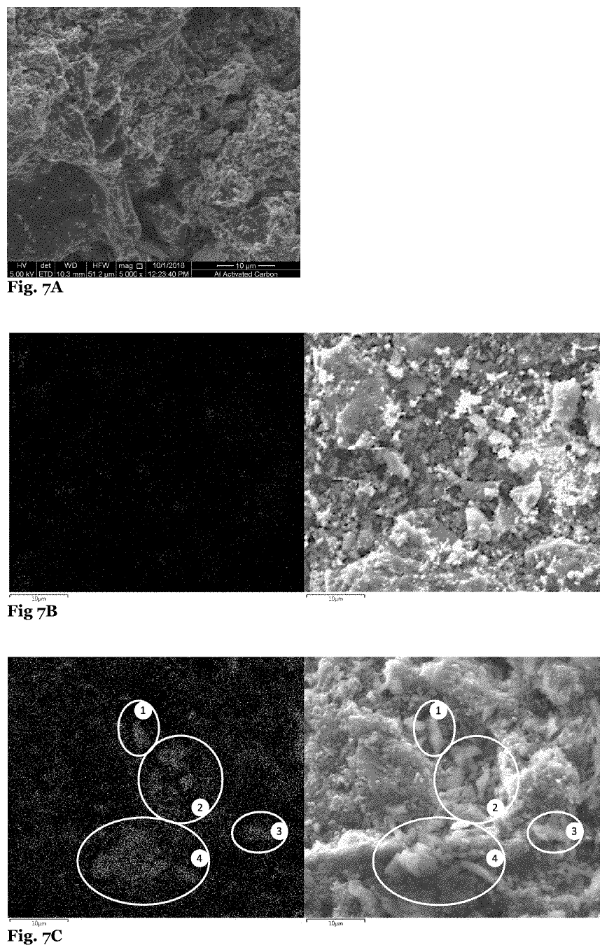

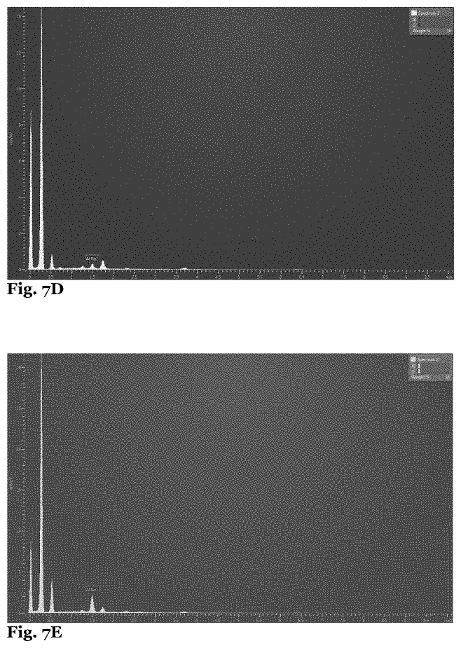

FIG. 6B Supplemental. Expanded view of FIG. 7B. Activated carbon is the bottom lines. Activated carbon with amorphous PCN-250Fe is the top lines.

FIG. 6C. Free volume hole size distribution of activated carbon (higher peak) and activated carbon with amorphous PCN-250Fe (metal organic framework of Fe and ABTC).

FIG. 6C Supplemental. Illustrated view of FIG. 6C.

FIG. 7A. SEM of activated carbon with amorphousPCN-250Al (metal organic framework of Al and ABTC).

FIG. 7B. EDX and SEI showing concentrations of aluminium in activated carbon (control).

FIG. 7C. EDX and SEI showing concentrations of aluminium in activated carbon with amorphous PCN-250Al (metal organic framework of Al and ABTC).

FIG. 7D. Elemental analysis for aluminium in activated carbon.

FIG. 7E. Elemental analysis for aluminium in activated carbon with amorphous PCN-250Al (metal organic framework of Al and ABTC).

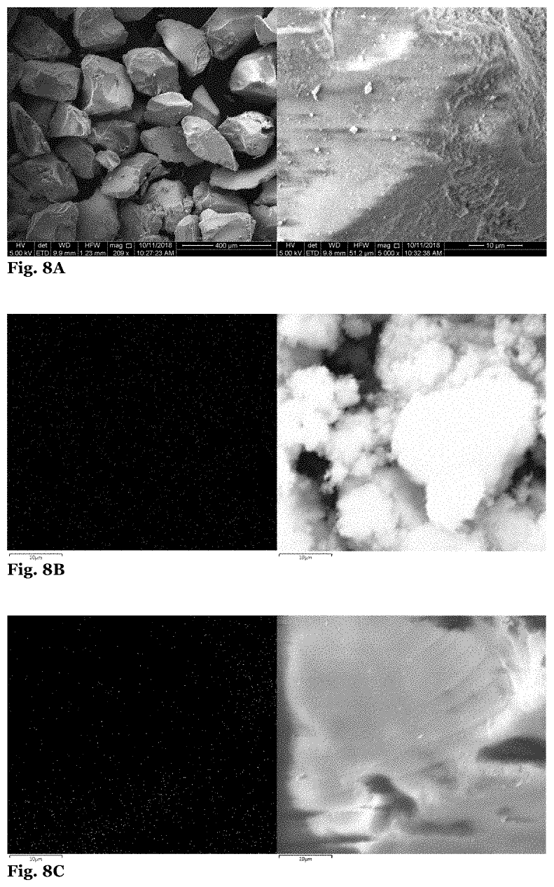

FIG. 8A. SEM of silica with amorphous PCN-250Al (metal organic framework of Al and ABTC).

FIG. 8B. EDX and SEI showing concentrations of aluminium in silica (control).

FIG. 8C. EDX and SEI showing concentrations of aluminium in silica with amorphous PCN-250Al (metal organic framework of Al and ABTC).

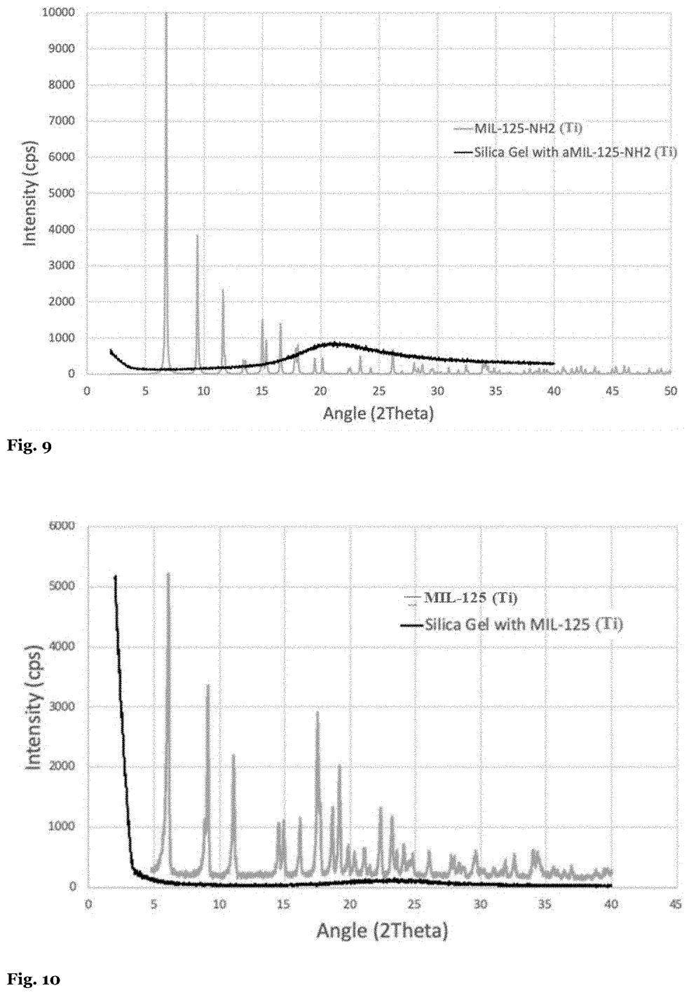

FIG. 9: XRD comparing crystalline metal organic framework of Ti and 2-amino-BDC (Ti₈O₈(OH)₄(2-amino-BDC)₆)-labelled MIL-125 NH2 (Ti) showing multiple peaks-against silica gel with amorphous metal organic framework of Ti and 2-amino-BDC (Ti₈O₈(OH)₄(2-amino-BDC)₆)-labelled Silica gel with aMIL-125-NH2(Ti) showing no peaks.

FIG. 10: XRD comparing crystalline metal organic framework of Ti and H2BDC (Ti₈O₈(OH)₄(BDC)₆)-labelled MIL-125 (Ti) showing multiple peaks-against silica gel with amorphous metal organic framework of Ti and H2BDC (Ti₈O₈(OH)₄(BDC)₆)-labelled Silica gel with MIL-125-NH2(Ti) showing no peaks.

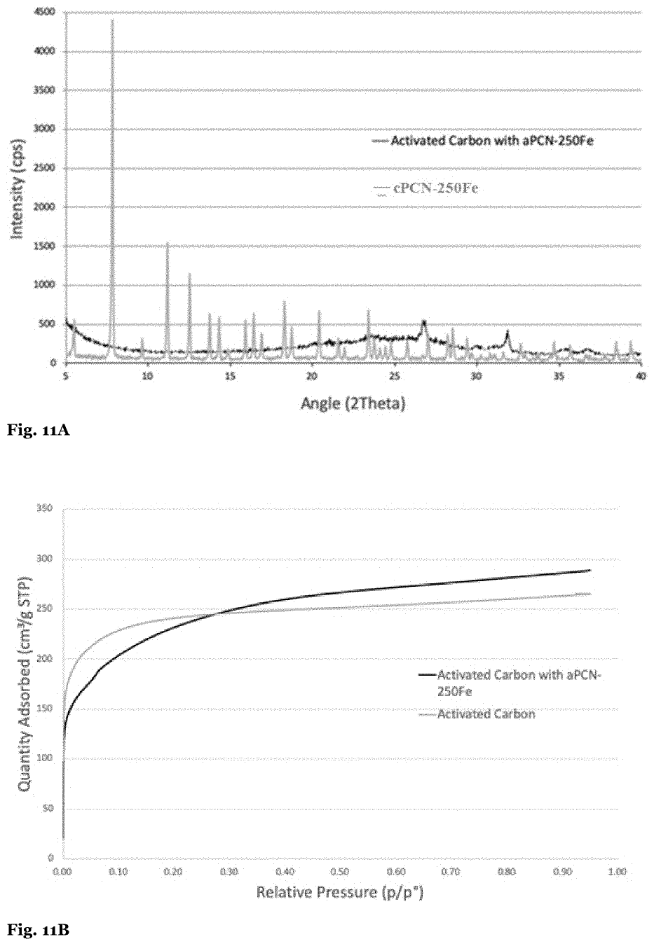

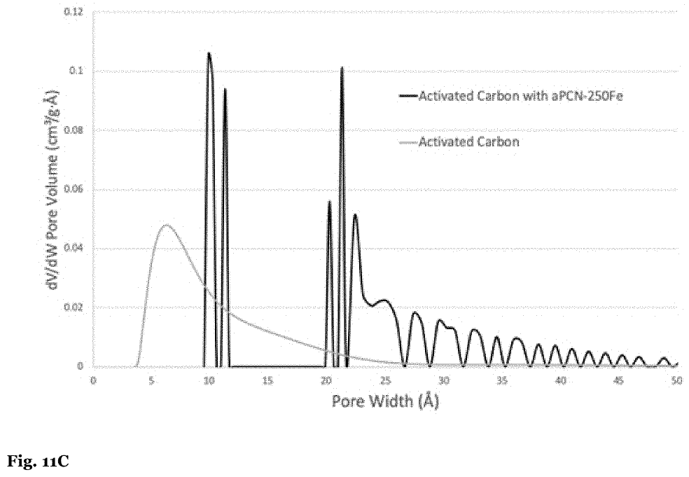

FIG. 11A: XRD comparing crystalline PCN-250Fe (showing multiple peaks) against activated carbon with amorphous PCN-250Fe (metal organic framework of Fe and ABTC) showing no peaks.

FIG. 11B: BET comparing activated carbon (showing greater adsorption above approx. 0.30) against activated carbon with amorphous PCN-250Fe (metal organic framework of Fe and ABTC).

FIG. 11C: Free volume hole size distribution of activated carbon (showing single peak) against activated carbon with amorphous PCN-250Fe (metal organic framework of Fe and ABTC).

### EXAMPLES

Testing

Adsorption/Desorption Measurements:

The amount of gas adsorbed, n^{a}, by the mass, m^{s}, of solid is dependent on the equilibrium pressure, p, the temperature, T, and the nature of the gas-solid system. Thus, we may write:

n^{a}/m^{s}=f(p,T,system) (equation 1)

For a given gas adsorbed on a particular solid at constant temperature we have

n^{a}/m^{s}=f(p)_{T} (equation 2)

and if the gas is below its critical temperature, it is possible to write

n^{a}/m^{s}=f(p/p^{o})_{T} (equation 3)

where here, the standard pressure p^{o} is equal to the saturation pressure of the adsorptive at T.

Equations (2) and (3) represent the adsorption isotherm which is the relationship between the amount adsorbed by unit mass of solid and the equilibrium pressure (or relative pressure), at a known temperature (Rouquerol, Franqoise. Adsorption by Powders and Porous Solids: Principles, Methodology and Applications. Elsevier, Academic Press, 2014).

The experimental adsorption isotherm is usually presented in graphical form. Here, for all samples, nitrogen gas (N₂) sorption measurements were conducted using a Micromeritics ASAP 2020 and 2420 system. The sample weights were measured using an analytical balance and loaded into the Micromeritics ASAP 2020 and 2420 system. At the end of the N₂ sorption measurements, the data of the amount adsorbed N₂ by unit mass of tested sample was generated by the measurement system. In addition, the ASAP 2020 AND 2420 system software was used to gather the required surface area and porosity information for reporting (ASAP 2020 Accelerated Surface Area and Porosimetry System Brochure, Micromeritics Instrument Corporation 4356 Communications Drive Norcross, Ga. 30093 USA http://www.micromeritics.com/Repository/Files/ASAP_2020_Brochure_3.pdf)
Single- and Multipoint BET (Brunauer, Emmett, and Teller) surface area
Langmuir surface area
Temkin and Freundlich isotherm analyses
Pore volume and pore area distributions in the mesopore and macropore ranges by the BJH (Barrett, Joyner, and Halenda) method using a variety of thickness equations
Pore volume and total pore volume in a user-defined pore size range
Micropore distribution by the MP method and total micropore volume by the t-Plot and as Plot methods
Pore width/diameter

The reported data which included N₂ sorption measurements, pore volume and pore area distributions (including micropore distribution), were graphed using the graphics module of the instrument software. Graphs with user-defined ranges (relative pressure and pore size) were generated using MS Excel based on the (N₂) sorption measurements.

The N₂ sorption measurements were conducted at 77 K.

The same equipment was used to obtain water adsorption measurements and so water adsorption isotherm graphs were plotted accordingly.

The water sorption measurements were conducted at 25° C.

Volumetric Uptake Tests:

Volumetric methane uptake tests were conducted by loading approximately 0.4 g of the of each adsorbent, silica gel and silica gel with aPCN-250 Fe, into a tared 2 mL stainless steel sample holder inside a glovebox under an Ar atmosphere. The sample holder was weighed to determine the sample mass prior to connecting to the VCR fittings of the complete high-pressure assembly while still inside the glovebox. The fully assembled sample holder was then transferred to an ASAP 2020 low-pressure adsorption instrument and evacuated using the original activation temperature for the material. The sample holder was then transferred to the High pressure volumetric analyzer (HPVA II) from Particulate Systems-Micromeritics, connected to the analysis port of the instrument via an OCR fitting, and evacuated at room temperature for at least 45 minutes. The sample holder was placed inside an aluminum Dewar. The sample volume is determined by subtracting the total free space of the filled sample holder from that of the empty sample holder. Excess gravimetric uptake data g/v (g/cm3) measured by the HPVA II is volumetrically calculated based on: A) the absorbent density, B) total pore volume of the absorbent, and C) the bulk gas density at each temperature and pressure.

Gravimetric Uptake Tests:

Gravimetric methane and hydrogen sulfide dosed methane tests were conducted by adding approximately 0.7 grams of silica gel or silica gel with aPCN-250 Fe to 1.45 mL Swagelok stainless steel tube testing cells. Each testing cell was placed in an oven at 150° C. for one hour for activation. Each testing cell was vacuum purged for 3 minutes and then nitrogen purged at 50 psig. 150 mL Swagelok sample cylinders were filled with each testing gas (methane or a mixture of 1 mol % hydrogen sulfide and 99% methane) at 100 psig from a Praxair pressurized gas cylinder. The testing gas was then directed from each sample cylinder to the respective testing cell for one hour. After exposure, gas uptake was measured by weighing the testing cell with silica gel or silica gel with aPCN-250 Fe relative to the testing cell with silica gel or silica gel with aPCN-250 Fe and the accumulated testing gas with a Mettler AE200 analytical balance.

Powder X-ray Diffraction:

Powder X-ray diffraction (PXRD) was carried out with a Bruker D8-Focus Bragg-Brentano X-ray Powder Diffractometer equipped with a Cu sealed tube (λ=1.54178 A°) at 40 kV and 40 mA.

SEM/SEI/EDS Imagery:

Scanning Electron Microscopy (SEM) measurements were carried out on JEOL JSM-7500F. JEOL JSM-7500F is an ultra-high-resolution field emission scanning electron microscope (FE-SEM) equipped with a high brightness conical FE gun and a low aberration conical objective lens. For EDS and SEI imagery, following accessories of the JSM-7500 were used: conventional in-chamber Everhart-Thornley and through-the-lens secondary detectors, low angle back-scattered electron detector (LABE), IR-CCD chamber camera, Oxford EDS system equipped with X-ray mapping and digital imaging.

### Example 1. Activated Carbon with Amorphous Metal Organic Framework of Al and ABTC

A mixture of DMF (120 mL) and acetic acid (60 mL) were combined with 1.8 g of ABTC (azobenzene-tetracarboxylic acid) as well as 3.2 g of aluminium chloride. The mixture was heated at 150° C. 1.8 g of activated carbon untreated was added to the mixture once uniform. The combined mixture was placed in a 150° C. oven for two hours. The solid cylindrical activated carbon was filtered and then washed using methanol. The resulting amorphous metal organic framework was placed in a vacuum oven for 1 hour for further drying.

XRD spectra of the crystalline metal organic framework PCN-250Al and activated carbon comprising the amorphous metal organic framework of example 1 were plotted.

N₂ adsorption/desorption isotherms and free volume hole size distribution graphs of activated carbon and activated carbon comprising the amorphous metal organic framework of example 1 were plotted.

As shown in FIG. 3A, the synthesis of example 4 results in the formation of amorphous metal organic framework of aluminium and ABTC. In FIG. 3A, the top line (labelled PCN-250Al) represents the XRD spectrum of the crystalline metal organic framework PCN-250Al. The Bragg's peaks that are characteristic of this crystalline metal organic framework are clearly visible. In FIG. 3A, the bottom line (labelled Activated Carbon with aPCN-250Al) represents the XRD spectrum of the product of example 1. This spectrum contains no Bragg's peaks and as such confirms the amorphous nature of the metal organic framework of example 1.

The BET surface area for activated carbon was calculated as 868.4 m²g⁻¹. The BET surface area for activated carbon comprising the amorphous metal organic framework of example 1 was calculated as 884.48 m²g⁻¹. The increase in surface area attributed to the formation of the amorphous metal organic framework of example 1 is therefore 16.08 m²g⁻¹ (an increase of 1.9%).

FIG. 3B shows the full N₂ absorption/desorption isotherms for activated carbon and activated carbon comprising the amorphous metal organic framework of example 1. It is clear that the total quantity of N₂ that is adsorbed by activated carbon comprising the amorphous metal organic framework of example 1 is significantly greater than the total quantity of N₂ adsorbed by activated carbon without the amorphous metal organic framework of example 1. The increase in N₂ adsorption is predominantly due to the increase in surface area provided by the amorphous metal organic frame work of example 1.

Not only does activated carbon comprising the amorphous metal organic framework of example 1 absorb a greater quantity of N₂, the increase in adsorption is in the most commercially relevant region, i.e. the low pressure region. In particular, activated carbon comprising the amorphous metal organic framework of example 1 begins to outperform clean activated carbon as low as approximately 0.17 p/p^{o}. There is a need to provide materials that adsorb fluids at low partial pressures as this leads to reduced industrial set-up and operating costs.

FIG. 3B supplemental is an expanded view of FIG. 3B wherein the relative pressure has been limited to the 0-0.5 p/p^{o} range. In FIG. 3B supplemental the absorption isotherms have been split into two sections: from 0-0.1 p/p^{o} (region A) and from 0.1-0.42 p/p^{o}(region B). In region A there is no increase in adsorption of activated carbon comprising the amorphous metal organic framework of example 1 relative to activated carbon. The increase in BET surface area and adsorption therefore originates in region B.

Region A is generally associated with the filling of micropores. The filling of micropores can be split into two groups: primary filling (the filling of micropores with a width of less than 10 Å), and secondary filling (the filling of micropores with a width of between 10 Å and 20 Å). Primary filling is affected by the formation of new micropores or the blocking of existing micropores. Secondary filling is affected by the formation of new micropores, the blocking of existing micropores and the modification of existing micropores (amorphous metal organic framework formation leading to surface irregularities on the internal surfaces of the pores).

FIG. 3C demonstrates that primary filling decreases and that secondary filling increases for activated carbon comprising the amorphous metal organic framework of example 1. Furthermore, there is an increase in adsorption in the mesoporous range attributable to enhanced multilayer formation (see FIG. 3C supplemental). The decrease in adsorption associated with primary filling is therefore compensated by the increase in secondary filling.

However, the increase in BET surface area is not entirely attributable to new micropore formation. There is also an increase in the adsorption in mesopores. This adsorption is demonstrated by the relative increase in adsorption in region B and is due to the formation of the amorphous metal organic framework of example 1 on the internal surfaces of the mesopores which leads to enhanced multilayer formation. Multilayer formation is the formation of multiple layers of adsorbate on the internal surfaces of the mesopores and is affected by the surface irregularities provided by the formation of the amorphous metal organic framework of example 1 on the internal surfaces of the mesopores.

Activated carbon comprising the amorphous metal organic framework of example 4 therefore exhibits increased low pressure adsorption, increased total adsorption and increased BET surface area relative to clean activated carbon. Importantly, the adsorption ability has been increased in pores with a width of 10-30 Å and at low pressures. This results in increased small molecule adsorption.

The SEM image in FIG. 7A shows activated carbon with amorphous metal organic framework of aluminium and ABTC. There are no crystalline regions observed.

The EDX image on the left hand side of FIG. 7B shows a low concertation aluminium (aluminium is represented by the white dots on the black background) in clean activated carbon. The right hand side of FIG. 7B is an SEI image of clean activated carbon and shows no crystalline regions.

In contrast to the EDX image on the left hand side of FIG. 7B, the EDX image on the left hand side of FIG. 7C shows a higher concertation aluminium (aluminium is represented by the white dots on the black background) in activated carbon comprising amorphous metal organic framework of aluminium and ABTC. The right hand side of FIG. 7C is an SEI image of activated carbon comprising amorphous metal organic framework of aluminium and ABTC and shows no crystalline regions. The areas circled (1, 2, 3, and 4) highlight where an increase of aluminium is in the activated carbon showing that the amorphous metal organic framework of aluminium and ABTC has formed in the pores of the activated carbon and further that these metal organic framework regions are amorphous.

The difference in aluminium peaks in FIG. 7D and FIG. 7E further confirms the increase in aluminium in the activated carbon comprising amorphous metal organic framework of aluminium and ABTC.

### Example 2. Silica with Amorphous Metal Organic Framework of Al and ABTC

A mixture of DMF (120 mL), and acetic acid (60 mL) were combined with 1.8 g of ABTC (azobenzene-tetracarboxylic acid) as well as 3.2 g of aluminium chloride. The mixture was heated at 150° C. 1.8 g of amorphous silica was added to the so mixture once uniform. The combined mixture was placed in a 150° C. oven for two hours to dissolve any powders. Every hour, the mixture was shaken to ensure no clumping of powders. The silica comprising amorphous metal organic framework of aluminium and ABTC was separated under centrifugation and washed twice using methanol, to remove any impurities. The resulting solid amorphous metal organic framework was placed in a vacuum oven for 1 hour for further drying.

XRD spectra of the crystalline metal organic framework PCN-250Al and silica comprising the amorphous metal organic framework of example 2 were plotted.

N₂ adsorption/desorption isotherms and free volume hole size distribution graphs of silica and silica comprising the amorphous metal organic framework of example 2 were plotted.

As shown in FIG. 4A, the synthesis of example 2 results in the formation of amorphous metal organic framework of aluminium and ABTC. In FIG. 4A, the top line (labelled cPCN-250Al) represents the XRD spectrum of the crystalline metal organic framework PCN-250Al. The Bragg's peaks that are characteristic of this crystalline metal organic framework are clearly visible. In FIG. 4A, the bottom line (labelled Silica with aPCN-250Al) represents the XRD spectrum of the product of example 2. This spectrum contains no Bragg's peaks and as such confirms the amorphous nature of the metal organic framework of example 2.

The BET surface area for silica was calculated as 191.66 m²g⁻¹. The BET surface area for silica comprising the amorphous metal organic framework of example 2 was calculated as 458.89 m²g⁻¹. The increase in surface area attributed to the formation of the amorphous metal organic framework of example 2 is therefore 267.23 m²g⁻¹ (an increase of 139.43%).

FIG. 4B shows the full N₂ absorption/desorption isotherms for silica and silica comprising the amorphous metal organic framework of example 2. It is clear that the total quantity of N₂ that is adsorbed by silica comprising the amorphous metal organic framework of example 2 is significantly greater than the total quantity of N₂ adsorbed by silica without the amorphous metal organic framework of example 2. The increase in N₂ adsorption is predominantly due to the increase in surface area provided by the amorphous metal organic frame work of example 2.

Not only does silica comprising the amorphous metal organic framework of example 2 absorb a greater quantity of N₂, the increase in adsorption is in the most commercially relevant region, i.e. the low pressure region. There is a need to provide materials that adsorb fluids at low partial pressures as this leads to reduced industrial set-up and operating costs.

FIG. 4B supplemental is an expanded view of FIG. 4B wherein the relative pressure has been limited to the 0-0.5 p/p^{o} range. In Figure B supplemental the absorption isotherms have been split into two sections: from 0-0.1 p/p^{o} (region A) and from 0.1-0.42 p/p^{o}(region B). In region A the increase in adsorption of silica comprising the amorphous metal organic framework of example 2 relative to silica is attributable to the filling of micropores provided by the amorphous metal organic framework of example 2. Importantly, the addition of the amorphous metal organic framework of example 2 provides additional functionality that was not present in clean silica. In particular, adsorption at pressures lower than approximately 0.02 p/p^{o}.

The steeper gradient of the curve in region A of the isotherm of activated carbon comprising the amorphous metal organic framework of example 2 indicates that the increase in BET surface area observed is primarily due to an increase in surface area provided by the new micropores (as well as modification of the existing micropores of activated carbon).

However, the increase in BET surface area is not entirely attributable to new micropore formation. There is also an increase in the adsorption in mesopores. This adsorption is demonstrated by the relative increase in adsorption in region B and is due to the formation of the amorphous metal organic framework of example 2 on the internal surfaces of the mesopores which leads to enhanced multilayer formation. Multilayer formation is the formation of multiple layers of adsorbate on the internal surfaces of the mesopores and is affected by the surface irregularities provided by the formation of the amorphous metal organic framework of example 2 on the internal surfaces of the mesopores.

The filling of micropores can be split into two groups: primary filling (the filling of micropores with a width of less than 10 Å), and secondary filling (the filling of micropores with a width of between 10 Å and 20 Å). Primary filling is affected by the formation of new micropores or the blocking of existing micropores. Secondary filling is affected by the formation of new micropores, the blocking of existing micropores and the modification of existing micropores (amorphous metal organic framework formation leading to surface irregularities on the internal surfaces of the pores).

FIG. 4C demonstrates that there is a significant increase in adsorption in the mesopores. This is attributed to enhanced multilayer formation (see FIG. 4C supplemental). FIG. 4C supplemental demonstrates that secondary pore filling is enhanced above approximately 19 Å.

Silica comprising the amorphous metal organic framework of example 2 therefore exhibits increased low pressure adsorption, increased total adsorption and increased BET surface area relative to clean silica. Importantly, the adsorption ability has been increased in pores with a width of 19-25 Å, at low pressures and greatly over the entire available mesoporous range.

The SEM image in FIG. 8A shows silica with amorphous metal organic framework of Al and ABTC. There are no crystalline regions observed.

The EDX image on the left hand side of FIG. 8B shows a low concertation aluminium (aluminium is represented by the white dots on the black background) in clean silica.

The right hand side of FIG. 8B is an SEI image of clean silica and shows no crystalline regions.

In contrast to the EDX image on the left hand side of FIG. 8B, the EDX image on the left hand side of FIG. 8C shows a higher concertation aluminium (aluminium is represented by the white dots on the black background) in silica comprising amorphous metal organic framework of Al and ABTC. The right hand side of FIG. 8C is an SEI image of silica comprising amorphous metal organic framework of Al and ABTC and shows no crystalline regions. These images highlight where an increase of aluminium is in the silica showing that the amorphous metal organic framework of Al and ABTC has formed in the pores of the silica and further that these metal organic framework regions are amorphous.

### Example 3. Silica Gel with Amorphous Metal Organic Framework of Fe and ABTC

A mixture of DMF (120 mL), and acetic acid (60 mL) were combined with 1.8 g of ABTC (azobenzene-tetracarboxylic acid) as well as 5.4 g of iron nitrate. The mixture was heated at 150° C. 1.8 g of mesoporous silica gel was added to the mixture once uniform. The combined mixture was placed in a 150° C. oven for two hours. The silica gel comprising amorphous metal organic framework of iron and ABTC was separated under centrifugation and washed using methanol, to remove any impurities. The methanol was discarded and the solid amorphous metal organic framework was collected. The amorphous metal organic framework created was then placed in a vacuum oven for 1 hour for further drying.

XRD spectra of the crystalline metal organic framework PCN-250Fe and silica gel comprising the amorphous metal organic framework of example 3 were plotted.

N₂ adsorption/desorption isotherms and free volume hole size distribution graphs of silica gel and silica gel comprising the amorphous metal organic framework of example 3 were plotted.

As shown in FIG. 5A, the synthesis of example 3 results in the formation of amorphous metal organic framework of iron and ABTC. In FIG. 5A, the bottom line (labelled cPCN-250Fe) represents the XRD spectrum of the crystalline metal organic framework PCN-250Fe. The Bragg's peaks that are characteristic of this crystalline metal organic framework are clearly visible. In FIG. 5A, the top line (labelled Silica Gel with aPCN-250Fe) represents the XRD spectrum of the product of example 3. This spectrum contains no Bragg's peaks and as such confirms the amorphous nature of the metal organic framework of example 2.

The BET surface area for silica gel was calculated as 496.5969 m²g⁻¹. The BET surface area for silica gel comprising the amorphous metal organic framework of example 3 was calculated as 805.5031 m²g⁻¹. The increase in surface area attributed to the formation of the amorphous metal organic framework of example 3 is therefore 308.9062 m²g⁻¹ (an increase of 62.20%).

FIG. 5B shows the full N₂ absorption/desorption isotherms for silica gel and silica gel comprising the amorphous metal organic framework of example 3. The increase in N₂ adsorption in the low pressure region (0-0.5 p/p^{o}) is predominantly due to the increase in surface area provided by the amorphous metal organic frame work of example 3. This adsorption is in the most commercially relevant region, i.e. the low pressure region. There is a need to provide materials that adsorb fluids at low partial pressures as this leads to reduced industrial set-up and operating costs.

In FIG. 5B, the desorption line for silica gel was corrupted below 0.6 p/p^{o}. As such, the desorption characteristics of silica gel has not been discussed.

FIG. 5B supplemental is an expanded view of FIG. 5B wherein the relative pressure has been limited to the 0-0.1 p/p^{o} range. In FIG. 5B supplemental the absorption isotherms have been split into two sections: from 0-0.01 p/p^{o} (region A) and from 0.01-0.1 p/p^{o}(region B). In region A the increase in adsorption of silica gel comprising the amorphous metal organic framework of example 3 relative to silica gel is attributable to the filling of micropores provided by the amorphous metal organic framework of example 3. The steeper gradient of the curve in region A of the isotherm of activated carbon comprising the amorphous metal organic framework of example 3 indicates that the increase in BET surface area observed is primarily due to an increase in surface area provided by the new micropores (as well as modification of the existing micropores of activated carbon).

The filling of micropores can be split into two groups: primary filling (the filling of micropores with a width of less than 10 Å), and secondary filling (the filling of micropores with a width of between 10 Å and 20 Å). Primary filling is affected by the formation of new micropores or the blocking of existing micropores. Secondary filling is affected by the formation of new micropores, the blocking of existing micropores and the modification of existing micropores (amorphous metal organic framework formation leading to surface irregularities on the internal surfaces of the pores).

FIG. 5C demonstrates that primary filling increases significantly and that secondary filling decreases for silica gel comprising the amorphous metal organic framework of example 3.

Silica gel comprising the amorphous metal organic framework of example 3 therefore exhibits increased low pressure adsorption, increased total adsorption and increased BET surface area relative to clean silica gel. Importantly, the adsorption ability has been increased in pores with a width of 5-10 Å and at low pressures. This results in increased small molecule adsorption.

FIG. 5D shows the full water absorption graph for silica gel and silica gel comprising the amorphous metal organic framework of example 3. The increase in water adsorption in the low pressure region (0-0.4 p/p^{o}) is predominantly due to the increase in surface area provided by the amorphous metal organic frame work of example 3.

FIG. 5E is an expanded view of FIG. 5D wherein the relative pressure has been limited to the 0-0.42 p/p^{o} range. The x-axis in FIG. 5E is different to that of 5D as each x-axis number is separated equally. In contrast the x-axis of FIG. 5D is linear. FIG. 5E demonstrates significant increase in water adsorption in the lower pressure region attributable to the amorphous metal organic framework of example 3 (see the difference in water uptake chart overlay).

FIG. 5F shows the volumetric methane uptake for silica gel and silica gel comprising the amorphous metal organic framework of example 3.

It is clear that the uptake volume of methane per volume of silica gel comprising the amorphous metal organic framework of example 3 is significantly greater than the uptake volume of methane per volume of silica gel without the amorphous metal organic framework of example 3 at all pressures. The increase in methane uptake is predominantly due to the change in porosity and possibly due to open metal sites provided by the amorphous metal organic frame work of example 3.

FIG. 5G shows the gravimetric uptake of methane and methane dosed with 1 mol % hydrogen sulfide. It is clear that the uptake of methane in silica gel comprising the amorphous metal organic framework of example 3 is significantly greater than the uptake of methane in silica gel without the amorphous metal organic framework of example 3. It is clear that the uptake of methane dosed with 1 mol % hydrogen sulfide in silica gel comprising the amorphous metal organic framework of example 3 is significantly greater than the uptake of methane dosed with 1 mol % hydrogen sulfide in silica gel without the amorphous metal organic framework of example 3.

When tested for gravimetric gas adsorption of methane, silica gel comprising the amorphous metal organic framework of example 3 adsorbed 42.7% less gas than crystalline PCN-250 Fe. When tested for gravimetric gas adsorption of a mixture of 1 mol % hydrogen sulfide in methane, the silica gel comprising the amorphous metal organic framework of example 3 adsorbed 11.3% less gas than crystalline PCN-250 Fe.

### Example 4. Activated Carbon with Amorphous Metal Organic Framework of Fe and ABTC

A mother liquor was prepared for the synthesis of crystalline PCN-250Fe. Once the crystalline PCN-250Fe had been synthesised in the mother liquor the solid PCN-250Fe was removed from the mother liquor by filtration. The remaining mother liquor was then used in the synthesis of an amorphous metal organic framework of Fe and ABTC. The mother liquor may, for example, be obtained from a scaled up method of producing crystalline PCN-250Fe such as one of the methods described in U.S. provisional application 62/662,220. The mother liquor may be the waste slurry described U.S. provisional application 62/662,220.

Activated carbon was soaked in the mother liquor for 15 minutes. The activated carbon was separated from the mother liquor by filtration. The activated carbon was dried using a vacuum oven at 150° C. for 16 hours before being soaked in the mother liquor for 15 minutes. The activated carbon was separated from the mother liquor by filtration. The activated carbon was then dried using a vacuum oven at 150° C. 16 hours to provide the amorphous metal organic framework of Fe and ABTC.

XRD spectra of the crystalline metal organic framework PCN-250Fe and activated carbon comprising the amorphous metal organic framework of example 4 were plotted.

N₂ adsorption/desorption isotherms and free volume hole size distribution graphs of activated carbon and activated carbon comprising the amorphous metal organic framework of example 4 were plotted.

As shown in FIG. 6A, the synthesis of example 4 results in the formation of amorphous metal organic framework of iron and ABTC. In FIG. 6A, the top line (labelled cPCN-250Fe) represents the XRD spectrum of the crystalline metal organic framework PCN-250Fe. The Bragg's peaks that are characteristic of this crystalline metal organic framework are clearly visible. In FIG. 6A, the bottom line (labelled Activated Carbon with aPCN-250Fe) represents the XRD spectrum of the product of example 4. This spectrum contains no Bragg's peaks and as such confirms the amorphous nature of the metal organic framework of example 4.

The BET surface area for activated carbon was calculated as 868.4 m²g⁻¹. The BET surface area for activated carbon comprising the amorphous metal organic framework of example 4 was calculated as 1077.9 m²g⁻¹. The increase in surface area attributed to the formation of the amorphous metal organic framework of example 4 is therefore 209.5 m²g⁻¹ (an increase of 24.12%).

FIG. 6B shows the full N₂ absorption/desorption isotherms for activated carbon and activated carbon comprising the amorphous metal organic framework of example 4. It is clear that the total quantity of N₂ that is adsorbed by activated carbon comprising the amorphous metal organic framework of example 4 is significantly greater than the total quantity of N₂ adsorbed by activated carbon without the amorphous metal organic framework of example 4. The increase in N₂ adsorption is predominantly due to the increase in surface area provided by the amorphous metal organic frame work of example 4.

Not only does activated carbon comprising the amorphous metal organic framework of example 4 absorb a greater quantity of N₂, the increase in adsorption is in the most commercially relevant region, i.e. the low pressure so region. There is a need to provide materials that adsorb fluids at low partial pressures as this leads to reduced industrial set-up and operating costs.

FIG. 6B supplemental is an expanded view of FIG. 6B wherein the relative pressure has been limited to the 0-0.5 p/p^{o} range. In FIG. 6B the absorption isotherms have been split into two sections: from 0-0.1 p/p^{o} (region A) and from 0.1-0.42 p/p^{o}(region B). In region A the increase in adsorption of activated carbon comprising the amorphous metal organic framework of example 4 relative to activated carbon is attributable to the filling of micropores provided by the amorphous metal organic framework of example 4. The steeper gradient of the curve in region A of the isotherm of activated carbon comprising the amorphous metal organic framework of example 4 indicates that the increase in BET surface area observed is primarily due to an increase in surface area provided by the new micropores (as well as modification of the existing micropores of activated carbon).

However, the increase in BET surface area is not entirely attributable to new micropore formation. There is also an increase in the adsorption in mesopores. This adsorption is demonstrated by the relative increase in adsorption in region B and is due to the formation of the amorphous metal organic framework of example 4 on the internal surfaces of the mesopores which leads to enhanced multilayer formation. Multilayer formation is the formation of multiple layers of adsorbate on the internal surfaces of the mesopores and is affected by the surface irregularities provided by the formation of the amorphous metal organic framework of example 4 on the internal surfaces of the mesopores.

The filling of micropores can be split into two groups: primary filling (the filling of micropores with a width of less than 10 Å), and secondary filling (the filling of micropores with a width of between 10 Å and 20 Å). Primary filling is affected by the formation of new micropores or the blocking of existing micropores. Secondary filling is affected by the formation of new micropores, the blocking of existing micropores and the modification of existing micropores (amorphous metal organic framework formation leading to surface irregularities on the internal surfaces of the pores).

FIG. 6C demonstrates that primary filling decreases and that secondary filling increases for activated carbon comprising the amorphous metal organic framework of example 4. Furthermore, there is an increase in adsorption in the mesoporous range attributable to enhanced multilayer formation (see FIG. 6C supplemental).

Activated carbon comprising the amorphous metal organic framework of example 4 therefore exhibits increased low pressure adsorption, increased total adsorption and increased BET surface area relative to clean activated carbon. Importantly, the adsorption ability has been increased in pores with a width of 10-25 Å and at low pressures. This results in increased small molecule adsorption.

### Example 5. Silica Gel with Amorphous Metal Organic Framework of Al and ABTC

A mixture of DMF (120 mL), and acetic acid (60 mL) were combined with 1.8 g of ABTC (azobenzene-tetracarboxylic acid) as well as 3.2 g of aluminium chloride. The mixture was heated at 150° C. 1.8 g of mesoporous silica gel was added to the mixture once uniform. The combined mixture was placed in a 150° C. oven for two hours to dissolve any powders. Every hour, the mixture was shaken to ensure no clumping of powders. The silica gel comprising amorphous metal organic framework of Al and ABTC was separated under centrifugation and washed twice using methanol, to remove any impurities. The solid amorphous metal organic framework was collected and placed in a vacuum oven for further drying.

The BET surface area was calculated as 516.5 m²g⁻¹.

### Example 6. Silica Gel with Amorphous Metal Organic Framework of Ti and 2-amino-BDC (L2)

A mixture of 4.46 g of 2-amino-BDC (L2), and 50 mL of DMF were combined with 13.3 mL of methanol and 20 mL of DMF. The mixture was stirred until the ligand was dissolved. Then, another mixture of 2.22 mL of Ti(IV)-isopropoxide and 50 mL of DMF was prepared. Once the mixture was uniform, the two mixtures were combined and stirred until uniform. In order to produce the amorphous metal organic framework, 4.46 g of macroporous silica gel was added to the mixture. The combined mixture was placed in a 150° C. warm oven for 48 hours to dissolve any powders. Using centrifugations, the aMOF silica was washed three times using DMF and then once using methanol, to remove any impurities. The now solid amorphous metal organic framework was placed in a vacuum oven for further drying, where after the XRD spectra (FIG. 9) was obtained.

### Example 7. Silica Gel with Amorphous Metal Organic Framework of Ti and H2BDC

A mixture of DMF (6.5 mL), and methanol (6.5 mL) were combined with 0.456 g of H2BDC (benzene-1,4-dicarboxylic acid). Then, 1.4 mL of acetic acid was added where after 0.22 mL of Ti(IV)-isopropoxide was added. In order to produce the amorphous metal organic framework, 0.456 g of macroporous silica gel was added to the mixture. The combined mixture was placed in a 110° C. warm oven for 24 hours to dissolve any powders. Using centrifugations, the aMOF silica was washed three times using DMF and then once using methanol, to remove any impurities. The now solid amorphous coordination polymer was collected, placed in a vacuum oven for further drying, where after the PXRD spectra (FIG. 10) was obtained.

### Example 8. Activated Carbon with Amorphous Metal Organic Framework of Fe and ABTC

To create the amorphous metal organic framework, a mixture of distilled water (10 mL) and NaOH (5.03 g) were combined with propan-2-ol (100 mL) and H4-TazBz (18.3 g), after the NaOH was completely dissolved. The mixture was stirred at room temperature until uniform. A mixture of FeCl3(6H2O) (28 g) and propan-2-ol (80 mL) was prepared and then added to the uniform solution. In order to produce the amorphous metal organic framework, 18.3 g of activated carbon was added to the mixture. The resulting mixture was stirred under reflux for 24 hours. Using centrifugations, the aMOF activated carbon was washed three times using distilled water and then three times using ethanol, to remove any impurities. The new solid amorphous coordination polymer collected, was placed in a vacuum oven for further drying, where after BET (FIG. 11B) and PXRD (FIG. 11A) spectra were obtained.

The BET surface area was calculated as 856 m²g⁻¹.

1. (canceled)

2. An amorphous metal organic framework, comprising:
(i) a metal cluster; and (ii) one or more ligands having two or more carboxylate groups; wherein the metal cluster comprises iron.

3. (canceled)

4. An amorphous metal organic framework according to claim 2, wherein the metal cluster has the formula Fe₂XO, and X is metal selected from Group 2 through Group 16; optionally wherein X is selected from Al, Fe, Co, Mn, Zn, Ni, Mg, Cu, and Ca.

5. (canceled)

6. An amorphous metal organic framework according to claim 2, wherein the metal cluster has the formula Fe₃O.

7. (canceled)

8. (canceled)

9. (canceled)

10. An amorphous metal organic framework according to claim 2, wherein the one or more ligands is derived from ABTC:

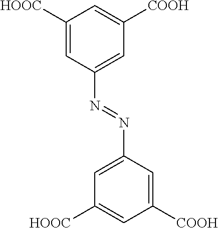 [SMILES: O=C(O)c1cc(/N=N/c2cc(C(=O)O)cc(C(=O)O)c2)cc(C(=O)O)c1]

11. An absorbent material comprising a porous substrate impregnated with a metal organic framework; wherein the metal organic framework is an amorphous iron, aluminium, or titanium metal organic framework.

12. (canceled)

13. (canceled)

14. An absorbent material according to claim 11, comprising (i) a metal cluster; and (ii) one or more ligands having two or more carboxylate groups; or comprising (i) a metal node; and (ii) one or more ligands having two or more carboxylate groups.

15. (canceled)

16. An absorbent material according to claim 14; wherein the metal cluster/node comprises a metal selected from iron, aluminium, titanium, chromium and zirconium; optionally wherein the metal cluster/node has the formula Fe₃O; Al₃O; TiO, Ti₈O₈ or Ti₁₆O₁₆.

17. (canceled)

18. (canceled)

19. (canceled)

20. An absorbent material according to claim 14, wherein the ligand is derived from ABTC:

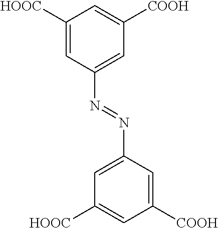 [SMILES: O=C(O)c1cc(/N=N/c2cc(C(=O)O)cc(C(=O)O)c2)cc(C(=O)O)c1]

21. An absorbent material according to claim 11, wherein the absorbent material has BET surface area between about 100 and about 1200 m²g⁻¹, or about 200 and about 1100 m²g⁻¹, or about 200 and about 900 m²g⁻¹, or about 200 and about 800 m²g⁻¹, or about 300 and about 800 m²g⁻¹, or about 400 and about 800 m²g⁻¹.

22. An absorbent material according to claim 11, wherein the porous substrate comprises pores having a pore diameter of from about 2.0 nm to about 50 nm; and/or wherein the porous substrate is microporous or mesoporous; and/or wherein the porous substrate is selected from activated carbon, silica, and silica gel; and/or wherein the porous substrate does not contain crystalline metal organic framework.

23. (canceled)

24. (canceled)

25. (canceled)

26. An absorbent material according to claim 11, wherein at least a portion of the amorphous metal organic framework is impregnated in the porous substrate; optionally further comprising crystalline or polycrystalline metal organic framework, the metal organic framework being at least 75% amorphous.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A process of preparing an amorphous metal organic framework as defined in claim 2, comprising the steps of contacting a reaction mixture comprising a metal source, a ligand precursor, a solvent and optionally an acid with a porous substrate; and subsequently removing the liquid component from the substrate.

40. (canceled)

41. A process according to claim 39, wherein the acid is selected from trifluoroacetic acid, benzoic acid, formic acid, propionic acid, sodium acetate, and acetic acid.

42. A process according to claim 39, wherein the reaction mixture further comprises dissolved metal organic framework.

43. A process according to claim 39, wherein the reaction mixture further comprises acetic acid and/or methanol.

44. A process according to claim 39, wherein the reaction mixture is virgin synthesis fluid or is recovered fluid from a process of preparing crystalline metal organic framework.

45. A process according to claim 39, wherein the substrate is soaked in the reaction mixture, wherein the substrate is soaked for a sufficient time to allow for the reaction mixture to permeate the substrate.

46. A process according to claim 39, wherein the liquid component is removed from the substrate after adequate soaking such that amorphous metal organic framework is formed during the soaking process and/or through the removal process.

47. A process according to claim 46, wherein removing the liquid component is carried out by extracting the fluid component using heat, pressure/vacuum or a combination of heat and pressure/vacuum.

48. A process according to claim 47, wherein the extraction of the liquid component is controlled by regulating the heat and/or pressure/vacuum to deliberately remove the individual components of the liquid component, to deliberately remove the liquid component in bulk, or to deliberately remove groups of components together.

49. (canceled)

50. (canceled)

53. (canceled)

54. (canceled)
